(19) United States
(12) Patent Application Publication
(10) Pub. No.: US 2017/0061074 A1
(43) Pub. Date: Mar. 2, 2017

(54) TELEMEDICINE SYSTEM AND METHOD

(71) Applicant: KINSA, INC., San Francisco, CA (US)

(72) Inventors: Inder Singh, New York, NY (US); Edo Segal, New York, NY (US)

(21) Appl. No.: 15/069,535

(22) Filed: Mar. 14, 2016

Related U.S. Application Data
(60) Provisional application No. 62/212,416, filed on Aug. 31, 2015.
(60) Provisional application No. 62/239,749, filed on Oct. 9, 2015.
(60) Provisional application No. 62/242,129, filed on Oct. 15, 2015.

(51) Int. Cl. G06F 19/00

(52) U.S. Cl. CPC G06F 19/322; G06F 19/3418

(57) ABSTRACT

In one or more implementations, a system and method for monitoring and tracking health is provided that comprises temperature sensing devices communicatively connectable to at least one computing device and configured to calculate temperature information. When executed by a processor, the computing device is configured to: access at least one data repository that stores health-related information and provider information; receive health-related information in response to an event; generate and transmit at least one prompt for regarding the health-related information; receive a response to the at least one prompt; match the provider information with the response to the prompt and/or the received health-related information; and provide, in response to the step of matching, at least one option for: scheduling a meeting with a provider; communicating with a provider; and sending information associated with the received health-related information.

### CROSS-REFERENCE TO RELATED PATENT APPLICATIONS

The present application relates to U.S. Provisional Patent Application No. 62/212,416, filed Aug. 31, 2015, U.S. Provisional Patent Application No. 62/239,749, filed Oct. 9, 2015 and U.S. Provisional Patent Application No. 62/242,129, filed Oct. 15, 2015, which are hereby incorporated by reference in their respective entireties as if expressly set forth herein.

The present application incorporates by reference the following commonly owned US patents and patent applications, which are hereby incorporated by reference in their respective entireties as if expressly set forth herein:
U.S. Pat. No. 8,974,115, entitled “TEMPERATURE MEASUREMENT SYSTEM AND METHOD”, issued on Mar. 10, 2015;
U.S. Design Pat. No. D724,450, entitled “THERMOMETER PROBE”, issued Mar. 17, 2015;
U.S. Design Pat. No. D743,817, entitled “THERMOMETER PROBE”, issued Nov. 24, 2015;
U.S. Patent Application No. 61/639,399, entitled “SYSTEM, METHOD AND APPARATUS FOR TEMPERATURE MEASUREMENT”, filed Apr. 27, 2012;
U.S. patent application Ser. No. 14/610,361, entitled “TEMPERATURE MEASUREMENT SYSTEM AND METHOD”, filed Jan. 30, 2015;
U.S. Patent Application No. 61/732,066, entitled “MOBILE-ENABLED BIOSURVEILLANCE”, filed Nov. 30, 2012;
U.S. Patent Application No. 61/728,143, entitled “TEMPERATURE MEASUREMENT SYSTEM”, filed Nov. 19, 2012;
U.S. Patent Application No. 61/816,452, entitled “TEMPERATURE MEASUREMENT SYSTEM”, filed Apr. 26, 2013;
U.S. Patent Application No. 61/798,251, entitled “TEMPERATURE MEASUREMENT SYSTEM”, filed Mar. 15, 2013;
U.S. Patent Application No. 61/812,648, entitled “MOBILE-ENABLED HEALTH SYSTEM”, filed Apr. 16, 2013;
U.S. patent application Ser. No. 14/648,573, entitled “MOBILE-ENABLED HEALTH SYSTEM”, filed May 29, 2015;
U.S. patent application Ser. No. 14/093,442, entitled “MOBILE-ENABLED HEALTH SYSTEM”, filed Nov. 30, 2013; and
U.S. patent application Ser. No. 14/869,680, entitled “MOBILE-ENABLED HEALTH SYSTEM”, filed Sep. 29, 2015.

### FIELD OF THE INVENTION

Generally, the invention relates to health care. More specifically, embodiments of the invention relate to the collection of health care data via one or more mobile computing devices, which is aggregated and analyzed for further action, including for use in the context of providing telemedicine services. Embodiments of the invention further relate to a mobile-enabled health system for tracking and monitoring the spread of febrile and related illnesses.

### BACKGROUND OF THE INVENTION

A person's body temperature is one of several “vital signs” used to measure and determine a person's health state. Normal body temperature for a healthy adult often ranges from 97.8 degrees F. (e.g., 36.5 degrees C.) to 99 degrees F. (37.2 degrees C.). Deviations from this range, even in small increments depending on the individual, may represent a significant health issue.

Over time, thermometers have been developed to take a person's body temperature, often orally (e.g., by mouth). Temperature may also be taken rectally, axillary (under the arm), by ear or other area, e.g., forehead. Classic glass thermometers have been recently replaced by digital thermometers. Despite advancements in thermometers to measure a person's body temperature, significant limitations still exist.

With the continued proliferation of mobile computing devices (e.g., smartphones, PDAs, etc.), many individuals have become increasingly reliant on such devices in order to perform routine activities. For example, many mobile device users perform multiple communication tasks (phone calls, emails, text messaging, etc.), shopping tasks (price comparisons, ecommerce transactions, etc.) and entertainment tasks (media watching/listening) with their mobile devices.

Various peripherals and accessories exist that connect to or otherwise interface with a mobile device in order to provide such devices with additional functionality. Such accessories are often fairly expensive, however, owing to (a) the considerable engineering efforts required in order to develop them, (b) the considerable cost of their materials/manufacture, and (c) licensing fees that certain mobile device manufacturers demand in order to certify such peripherals as being compatible with a particular mobile device.

It is with respect to these and other considerations that the disclosure made herein is presented.

### SUMMARY OF THE INVENTION

Embodiments of the invention are directed towards systems, methods and computer program products for providing health monitoring and tracking. A system in accordance with one embodiment of the present invention comprises one or more temperature sensing devices, a given one of the temperature sensing devices communicatively connectable to at least one of a plurality of respective computing devices and configured to calculate temperature information independently of or in connection with at least one of the respective computing devices. Embodiments cover various deployments of the components of the system including, but not limited to, deployments in which the temperature sensing device physically housed within the computing device, where the temperature sensing device houses the computing device, where the computing device is part of a user mobile device, where the temperature sensing device is in communication with the computing device as part of a software as a service that is accessed over a network, as well as other physical and logical deployments that are understood by those of skill in the art.

Continuing with the present embodiment, the system further comprises at least one data repository that stores health-related information received from at least one respective computing device. The health-related information represents at least calculated temperature information associated with at least one of the temperature sensing devices. The health-related information further comprises information representing at least one of: at least one medical condition, at least one disease, at least one health-related symptom, geographic location associated with at least one respective computing device and/or user of the thermometer, at least one date, identification of at least one individual user, and identification of at least one of the plurality of respective computing devices. The health-related information can comprise any information that provides insights representing at least one of contagiousness, an illness that is circulating, and at least one symptom that is circulating. In addition to health-related information, at least one data repository also stores provider information representing at least one party that is enabled to target products and interventions associated with at least some of the health-related information. According to various embodiments the provider is a pharmacy, a healthcare provider (e.g., a doctor, nurse or telemedicine provider group, etc.) or a provider of a related, complementary service or product related to cold or flu-like illness, fever symptoms, or hygiene products (e.g., a pharmaceutical company providing a fever-reducing medicine, or a company providing products like hand sanitizer, or tissue paper).

The system of the present embodiment further comprises at least one processor that is configured to execute instructions stored on non-transitory processor readable media. When executed by the at least one processor, the instructions configure the at least one processor to receive at least some of health-related information in response to an event that is triggered following completion of a user action in the respective computing device, as well as generate and transmit to the respective computing device, based on the received at least some of the health-related information, at least one prompt for: a symptom; an indication whether a medical professional has been seen; a request to contact a provider; and/or a diagnosis. The processor is operative to receive, from the respective computing device, a response to the prompt and match the response to the prompt and/or the received at least some of the health-related information with at least some of the provider information. The match provides at least one option for scheduling a meeting with a provider; communicating with a provider; and/or receiving information associated with the received at least some of the health-related information.

In accordance with certain embodiments, the at least one processor is further configured to execute instructions stored on non-transitory processor readable media, which configure the at least one processor to receive a response to the at least one option; schedule the meeting; establish a communication with the provider; and/or send the information associated with the received at least some of the health-related information to the provider. According to further embodiments, the instructions configure the at least one processor to perform analytics associated with the health-related information and the provider information, which can include forecasting. Furthermore, the at least one processor can be configured to process at least some of the stored health-related information and the received health-related information to determine at least one of: i) an estimated length of time that symptoms associated with the received health-related information will last; ii) an estimated length of time when a person having the symptoms will feel better; and iii) an estimated length of contagiousness.

A system in accordance with another embodiment of the present invention is directed towards a health monitoring and tracking system that comprises one or more of temperature sensing devices, a given one of the temperature sensing devices communicatively connectable to at least one of a plurality of respective computing devices and configured to calculate temperature information independently of or in connection with at least one of the respective computing devices, and at least one data repository. The at least one data repository is configured to maintain health-related information received from at least one respective computing device, wherein the health-related information represents at least i) calculated temperature information associated with at least one of the temperature sensing devices and ii) information representing at least one of: at least one medical condition, at least one disease, at least one health-related symptom, geographic location associated with at least one respective computing device, at least one date, identification of at least one individual user, and identification of at least one of the plurality of respective computing devices. The at least one data repository is further configured to maintain provider information representing each of a plurality of providers.

The system in accordance with the present embodiment further comprises at least one processor that is configured to execute instructions stored on non-transitory processor readable media which, when executed by the at least one processor, configure the at least one processor to receive health-related information from a computing device associated with a user and in response to an event, process the received health-related information and at least some of the health-related information stored in the at least one data repository to identify information regarding a medical condition and/or a corresponding degree of urgency associated with the medical condition or symptom profile, and generate and transmit to the computing device associated with the user, at least one prompt. According to various embodiments, the prompt represents at least one of a forecast as to the progression of the medical condition, the corresponding degree of urgency and a recommendation to contact at least one of the providers (or take other actions including, but not limited to, taking a fever reducing medicine). In one embodiment, the at least one processor is further configured to schedule a meeting for the user with a provider.

Embodiments of the present invention are further directed towards a method for health monitoring and tracking. The method according to one embodiment comprises accessing, by at least one processor, at least one data repository that stores health-related information received from at least one respective computing device. The health-related information represents at least calculated temperature information associated with at least one temperature sensing device communicatively connectable to at least one respective computing devices and configured to calculate temperature information independently of or in connection with at least one of the respective computing devices. Health-related information further represents information representing at least one of: at least one medical condition, at least one disease, at least one health-related symptom, geographic location associated with at least one respective computing device, at least one date, identification of at least one individual user, and identification of at least one of the plurality of respective computing devices. The at least one data repository is also operative to maintain provider information representing at least one party that is enabled to target products and interventions associated with at least some of the health-related information. The provider can be a pharmacy, a healthcare provider (e.g., a doctor, nurse or telemedicine provider group, etc.) or a provider of a related, complementary service or product related to cold or flu-like illness, fever symptoms, or hygiene products (e.g., a pharmaceutical company providing a fever-reducing medicine, or a company providing products like hand sanitizer, or tissue paper).

The method according to the present embodiment continues by receiving, by at least one processor that is configured to execute instructions stored on non-transitory processor readable media, at least some health-related information in response to an event that is triggered following completion of a user action in the respective computing device and generating, by the at least one processor, based on the received at least some of the health-related information, at least one prompt for: a symptom, an indication whether a medical professional has been seen, a request to contact a provider; and/or a diagnosis. The at least one processor transmits the at least one prompt, receives a response to the prompt and matches at least some of the provider information with the response to the at least one prompt and/or the received at least some of the health-related information.

Additionally, the method comprises providing, by the at least one processor in response to the step of matching, at least one option for scheduling a meeting with a provider, communicating with a provider; and/or sending, by the at least one processor, information associated with the received at least some of the health-related information. The method may continue by receiving, by the at least one processor, a response to the at least one option can be received by the processor and the method continuing by implementing at least one or scheduling, the meeting, establishing a communication session with the provider and sending the information associated with the received at least some of the health-related information, each of which can be accomplished by the processor.

The method may further comprise configuring the processor to perform analytics associated with the health-related information and the provider information as well as conduct forecasting for at least one illness associated with the received health-related information. Similarly, the method may comprise configuring the processor for determining at least one of i) an estimated length of time that symptoms associated with the received health-related information will last and ii) an estimated length of time when a person having the symptoms will feel better.

In accordance with one or more implementations, embodiments of the invention provide systems, methods and computer program products for monitoring and tracking health that comprise a plurality of temperature sensing devices, each of which are communicatively connectable to at least one of a plurality of respective computing devices and configured to calculate temperature information independently of or in connection with at least one of the respective computing devices. The at least one computing device is configured to access at least one data repository that stores: a) health-related information received from at least one respective computing device; and b) provider information representing at least one party that is enabled to target products and interventions associated with at least some of the health-related information. In at least one implementation, the provider information can represent a pharmacy, healthcare provider (e.g., a doctor, nurse or telemedicine provider group, etc.) or a provider of a related, complementary service or product related to cold or flu-like illness, fever symptoms, or hygiene products (e.g., a pharmaceutical company providing a fever-reducing medicine, or a company providing products like hand sanitizer, or tissue paper). In one or more implementations, the health-related information represents at least: (i) calculated temperature information associated with at least one of the temperature sensing devices; and ii) information representing at least one of: at least one medical condition, at least one disease, at least one health-related symptom, geographic location associated with at least one respective computing device, at least one date, identification of at least one individual user, and identification of at least one of the plurality of respective computing devices.

Continuing with the present implementation of the invention, the at least one computing device is further configured to receive at least some health-related information in response to an event that is triggered following completion of a user action in the respective computing device. The at least one computing device is further configured to generate and transmit at least one prompt for: a symptom, an indication whether a medical professional has been seen, a request to contact a healthcare provider, and/or a diagnosis. The at least one computing device may be further configured to receive a response to the at least one prompt.

In accordance with one or more implementations of the invention, the at least one computing device is configured to match at least some of the provider information with the response to the at least one prompt and/or the received health-related information. The at least one computing device is further configured to provide, in response to the step of matching, at least one option for: scheduling a meeting with a provider; communicating with a provider; and sending information associated with the received health-related information. In one or more implementations, the provider is a healthcare provider.

In accordance with one or more implementations of the invention, the at least one computing device can be further configured to (i) receive a response to the at least one option and (ii) at least one of: schedule the meeting, establish a communication session with the provider; and send the information associated with the received health-related information. In at least one implementation, the information associated with at least some of the received health-related information includes insights that represent at least one of contagiousness, an illness that is circulating, and at least one symptom that is circulating.

In accordance with one or more implementations of the invention, a computing device, which may be the at least one computing device, can be configured to perform analytics associated with the health-related information, which may take the provider information into account. The at least one computing device can be further configured to forecast at least one illness associated with the received health-related information, which may comprise health-related information collected by a communicatively connected health-device, health-related information provided by the user or patient, or combinations thereof. In at least one implementation, the at least one computing device is configured to determine at least one of: i) an estimated length of time that symptoms associated with the received health-related information will last; and ii) an estimated length of time when a person having the symptoms will feel better.

These and other aspects, features, and advantages can be appreciated from the accompanying description of certain embodiments of the invention, the accompanying drawing figures and claims.

### DESCRIPTION OF THE DRAWING FIGURES

FIG. 1 is a block diagram illustrating an example configuration of a computing device in accordance with one or more embodiments;

FIG. 2 is a block diagram illustrating several components of the health monitoring and tracking system in accordance with one or more embodiments;

FIG. 3 is a system diagram illustrating various aspects of the health monitoring and tracking system in accordance with one or more embodiments;

FIG. 4 is a flow diagram showing a routine that illustrates a broad aspect of a health monitoring and tracking method in accordance with one or more embodiments;

FIG. 5 is a flow diagram showing specific aspects of the routine illustrated at FIG. 4 in accordance with one or more embodiments;

FIG. 6 is a flow diagram showing a continuation of the routine of FIG. 4 that illustrates a broad aspect of a health monitoring and tracking method in accordance with one or more embodiments;

FIG. 7 is a flow diagram showing specific aspects of the routine shown at FIG. 6 as it relates to the health monitoring and tracking method in accordance with one or more embodiments;

FIG. 8 is a flow diagram showing a routine that illustrates a broad aspect of a method for initiating telemedicine in accordance with one or more embodiments;

FIG. 9 is a flow diagram showing a continuation of the routine of FIG. 8 that illustrates a broad aspect of a method for initiating telemedicine in accordance with one or more embodiments;

FIGS. 10 through 13 are a series of screenshots illustrating medial guidance interfaces that a telemedicine application presents to allow the user to initiate a telemedicine session with a physician;

FIG. 14 is a screenshot illustrating a user interface for the provision of specific medical guidance according to one embodiment;

FIG. 15 is a screenshot illustrating a user interface for the provision of specific medical guidance according to another embodiment;

FIG. 16 is a flow diagram illustrating a method for recommending tactics for managing an illness according to one embodiment;

FIGS. 17A through E show an example implementation of the routine of FIGS. 8-9, illustrating a method for initiating telemedicine in accordance with one or more embodiments;

FIGS. 18A through E show another example implementation of the routine of FIGS. 8-9, illustrating a method for initiating telemedicine in accordance with one or more embodiments;

FIGS. 19A through B are screenshots of the “Diagnosis” screens of the telemedicine application in accordance with one or more embodiments;

FIG. 20 is a screenshot of the “Past Health-Related Information” screen of the telemedicine application in accordance with one or more embodiments;

FIG. 21 is a screenshot of the “Illness Forecast” screen of the telemedicine application in accordance with one or more embodiments;

FIG. 22 is a screenshot of the “Find Care” screen of the telemedicine application in accordance with one or more embodiments;

FIG. 23 is a screenshot of the “Coupon” screen of the telemedicine application in accordance with one or more embodiments;

FIG. 24 is a flow diagram showing a routine that illustrates a broad aspect of a method for calling a healthcare provider via the telemedicine application in accordance with one or more embodiments;

FIGS. 25A through C are screenshots of the “Select Payment” screens of the telemedicine application in accordance with one or more embodiments;

FIGS. 26A through B are screenshots of the “Complete Payment” screens of the telemedicine application in accordance with one or more embodiments;

FIG. 27 is a screenshot of the “Select Patient Profile” screen of the telemedicine application in accordance with one or more embodiments;

FIG. 28 is a screenshot of the “Provide Feedback” screen of the telemedicine application in accordance with one or more embodiments;

FIG. 29 is a screenshot of the “Additional Information About ‘Call a Provider’” screen of the telemedicine application in accordance with one or more embodiments;

FIG. 30A is a high-level diagram illustrating an example configuration of a temperature measurement subsystem in accordance with one or more embodiments;

FIG. 30B is an illustration of an input cavity/jack of a computing device of the temperature measurement subsystem in accordance with one or more embodiments;

FIG. 31 is a schematic diagram showing a detailed internal view of a temperature-sensing probe in accordance with one or more embodiments;

FIG. 32 is a flow diagram showing a routine that illustrates a broad aspect of a method for measuring temperature in accordance with one or more embodiments;

FIG. 33 is a flow diagram showing a routine that illustrates a broad aspect of a method for calibrating a temperature measurement subsystem in accordance with one or more embodiments;

FIGS. 34 through 35 depict further aspects of the systems and methods described herein in accordance with one or more embodiments;

FIG. 36 is a block diagram of the architecture of a temperature measurement system in accordance with one or more embodiments;

FIG. 37 is a flow diagram illustrating a method for sharing notifications regarding health conditions observed by one or more connected health devices according to one embodiment;

FIG. 38A is a flow diagram illustrating a method for creating an illness forecast data set according to one embodiment;

FIG. 38B is a flow diagram illustrating a method for providing individual illness forecasting according to one embodiment; and

FIG. 39 is a flow diagram illustrating a method for multi-user access according to one embodiment.

### DETAILED DESCRIPTION OF CERTAIN EMBODIMENTS OF THE INVENTION

By way of overview and introduction, various systems, methods, and apparatuses are described herein that facilitate and enable a mobile health monitoring and tracking system with telemedicine functionality. It can appreciated by those of skill in the art that despite the vast amount of health-related information available to a patient via various websites, a patient may still need assistance in determining whether he or she should seek medical assistance in relation to an illness or suspected illness. Further, with the rising costs of healthcare, and in particular the rising costs of visits to a physician or an emergency room, patients may be reluctant to seek advice if their symptoms are likely to resolve spontaneously or with over the counter medication.

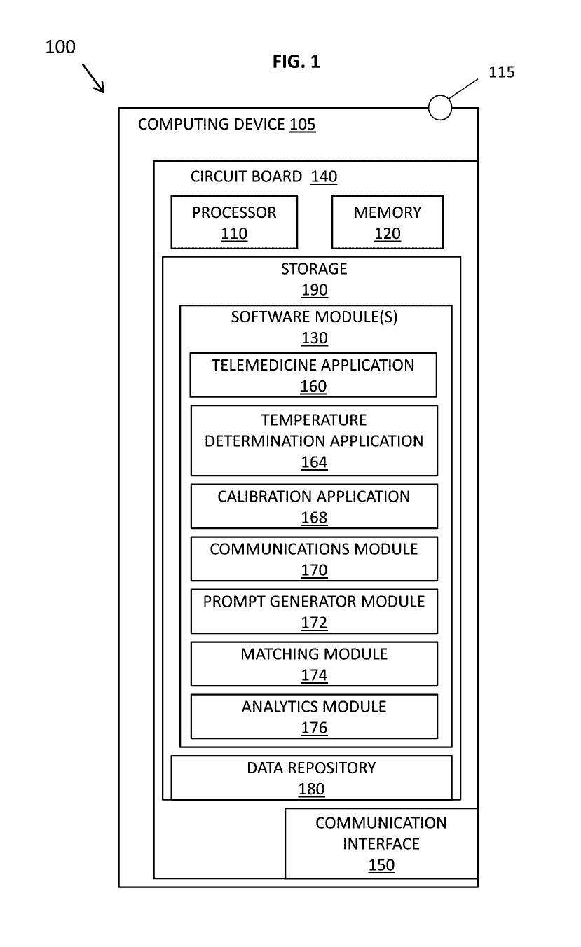

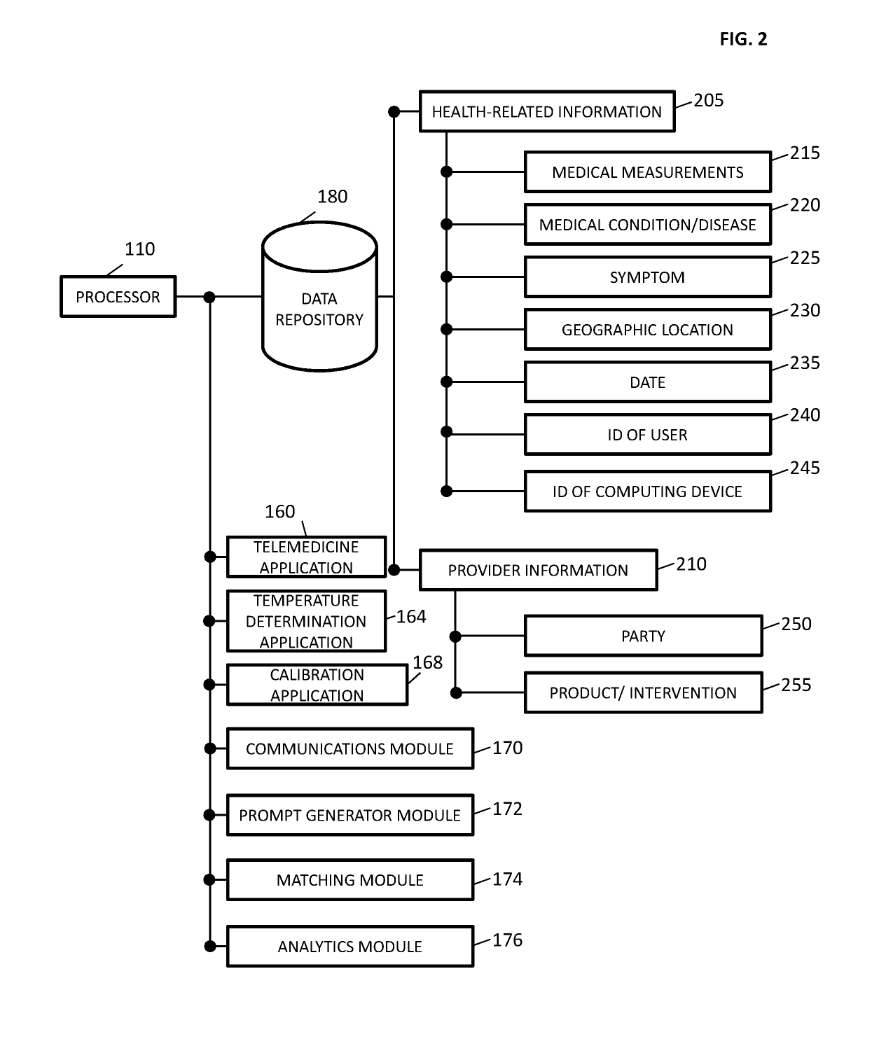

An example configuration of a computing device for a health monitoring and tracking system in accordance with various embodiments of the present invention is shown by the high-level diagram of FIG. 1; other components of the health monitoring and tracking system in conjunction with the computing device are shown at the high-level diagram of FIG. 2. In accordance with arrangement of FIG. 1, the computing device 105 of the health monitoring and tracking system can be a personal computer or server. In other implementations, the computing device 105 can be a mobile computing device/smartphone, tablet computer, laptop computer, or a digital media player or set top box including but not limited to, Apple TV, Amazon Fire TV, Amazon Fire Stick, Google Nexus Player, Google Chromecast, a PlayStation console, Roku stick, Roku streaming player, an Xbox console, and a Smart/Connected TV. However, it should be practically understood that computing device 105 can be any computing device and/or data processing apparatus capable of embodying the systems and/or methods described herein.

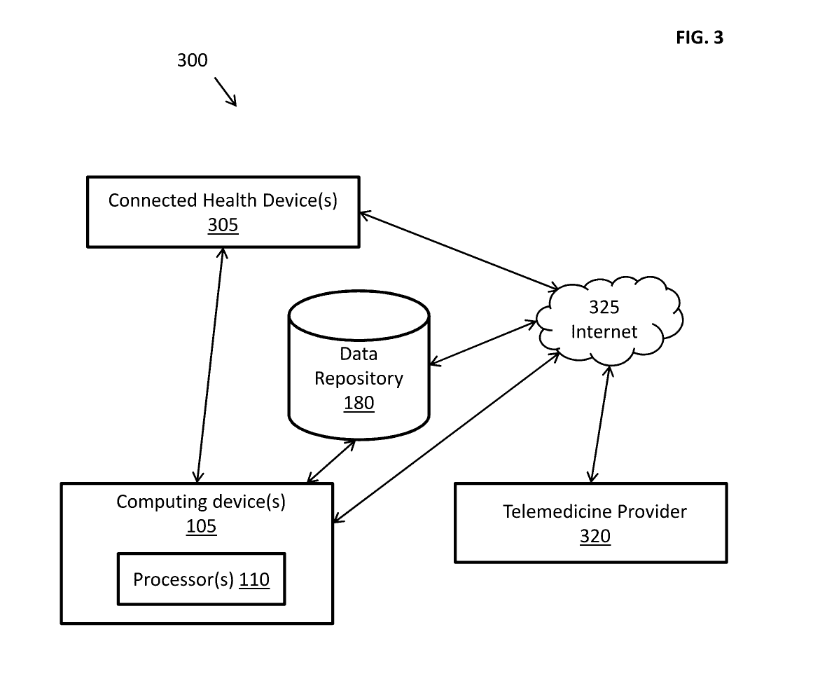

An example configuration of the health monitoring and tracking system 300 is shown in the high-level block diagram of FIG. 3. The health monitoring and tracking system 300 comprises one or more computing devices 105, which comprise one or more processor(s) 110, embodiments of which are described herein in connection with FIG. 1. The computing device(s) 105 can be operatively connected (directly or indirectly via internet 325) to one or more connected health devices 305, such as a temperature sensing device (e.g., temperature probe/thermometer), heart rate monitors, blood pressure monitors, glucometers, scales, respiratory monitors. The connected health device(s) 305 can be configured to calculate various medical measurements depending on the type of connected health device, such as temperature, blood pressure, heart rate, blood glucose, weight, and breathing measurements.

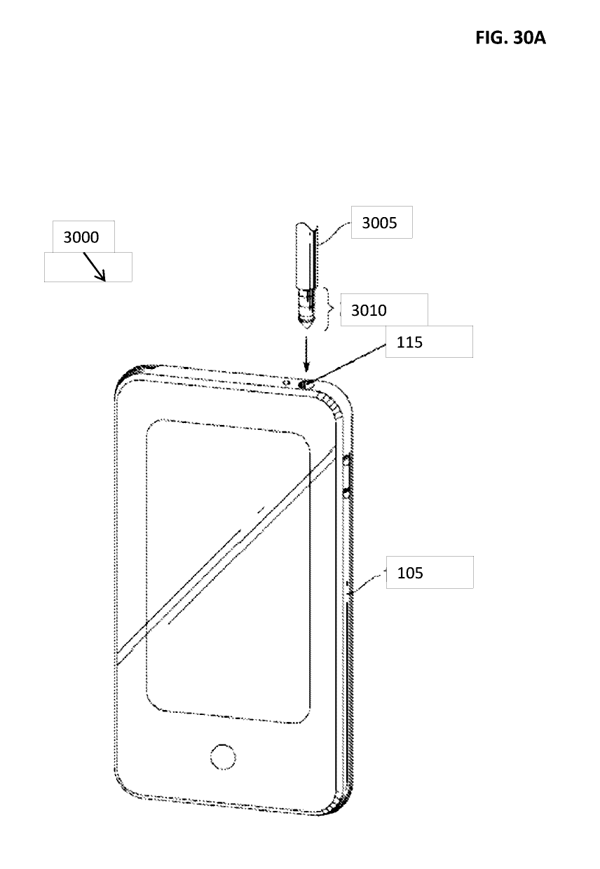

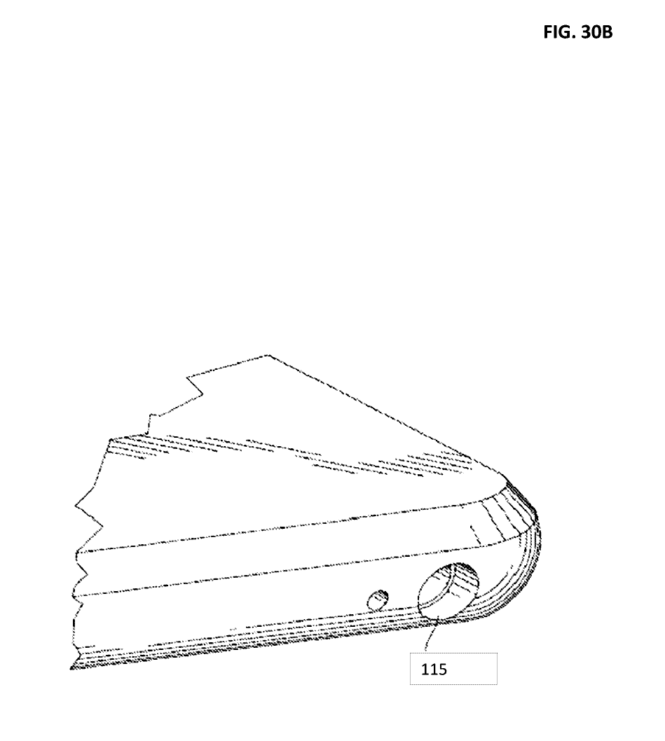

In accordance with one embodiment, the connected health device 305 is a temperature sensing device (temperature probe), the operation of which is discussed in greater detail below in regards to FIGS. 30-36. The connected health devices 305 can be in communication and operatively connected (directly or indirectly via a network, e.g., Internet 325) to one or more computing devices of a telemedicine provider (telemedicine provider 320). In one or more implementations, the connected health devices 305 can be configured to calculate or determine the respective medical measurements independently of the computing device(s) 105. In at least one implementation, the connected health devices 305 can be configured to calculate or determine the respective medical measurements in connection with the computing device(s) 105. The connected health devices 305 can also be operatively connected (directly or indirectly via internet 325) to one or more data repositories 180. One or more connected health devices 305 can also be integrated into the computing device 105, as well as operatively connected to the computing device 105, such as wireless (e.g., Bluetooth or Wi-Fi connections) or wired (e.g., TRS or Lightning plug) connections there between.

The health monitoring and tracking systems (e.g., system 300), methods and computer program products described herein assist patients with heath assessment and monitoring by enabling patients to provide information related to their health via an application on a computing device in response to health-related prompts generated by the application, which then enable the patient to determine whether he or she should seek medical attention. If, based on the health information data points that the patient provides (or if in response to a patient request), it is determined that a patient is in need of medical attention, he or she can be matched with a healthcare provider, schedule an appointment with the healthcare provider and/or establish communication with the healthcare provider, for example, via video conferencing or other synchronous communication technologies. Asynchronous communication systems are also contemplated as falling within the scope of various embodiments of the present invention, for example, through the use of SMS or other asynchronous text based communication methodologies to provide lines of communication between doctor and patient in which discrete messages are passed there between, as opposed to a steady communication stream.

In accordance with at least one embodiment of the present application, a patient takes his or her temperature using a connected health device, such as a temperature sensing device (e.g., temperature probe described by the present application) and the subsequent temperature reading is sent to a computing device. On the basis of the user's temperature reading, an application program executing on a processor that is part of the computing device generates and transmits one or more prompts to the user regarding the symptoms and other health-related information via the display on the computing device. The user responds to the one or more health-related prompts from the application via input controls on the computing device, e.g., touch, clicking an icon with a mouse, etc. If it is determined that the user is in need of further attention regarding his or her health condition based on the user's responses to the health-related prompts, the computing device initiates telemedicine services by matching the user's responses with a healthcare provider (telemedicine provider). Alternatively, or in conjunction with the foregoing, the user may initiate telemedicine services regardless of specific responses to health-related prompts.

The application program provides the user with several options (e.g., via an application-generated prompt) for following up with the matched healthcare provider regarding the user's medical status, such as scheduling a meeting with the provider, communicating with the provider (e.g., video conferencing, telephone, email, etc.), and/or receiving information regarding the user's medical status. The user can select at least one of the options for follow-up with the matched provider (via a response on the application UI that computing device is operative to display), and the application can initiate the selected follow-up option(s), such as initiating a video conference between the user and the matched healthcare provider. After follow-up with the matched provider, the computing device can analyze the user's health-related information and information from the healthcare provider to forecast at least one illness associated with the user and determine how long the user's illness or symptoms associated with the illness will last.

In the following detailed description of certain embodiments of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention. The systems, methods, and apparatuses of the present application are not limited in any way to the illustrated embodiments and/or implementations, as the illustrated embodiments and/or implementations described below are merely example of the systems, methods, and apparatuses, which can be embodied in various forms, as appreciated by one skilled in the art. Therefore, it is to be understood that any structural and functional details disclosed herein are not to be interpreted as limiting the systems, methods, and apparatuses, but rather are provided as a representative embodiment and/or implementation for teaching one skilled in the art one or more ways to implement the systems, methods, and apparatuses. Accordingly, aspects of the present systems, methods, and apparatuses can take the form of a hardware embodiment, a software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Turning back to FIG. 1 (which shows an example configuration of computing device 105), computing device 105 includes a circuit board 140, such as a motherboard, which is operatively connected to various hardware and software components that serve to enable operation of the health monitoring and tracking system. The circuit board 140 forms a substrate upon which a processor 110 and a memory 120 are operatively connected. Processor 110 serves to execute instructions for software and other application programs that are loaded into memory 120. Processor 110 may comprise be a number of discrete processors, a multi-core processor, or other type of processor, depending on the particular implementation. Further, processor 110 can be implemented using a number of heterogeneous processor systems in which a main processor is present with secondary processors on a single chip, e.g., a “system-on-a-chip” or SOC. As another illustrative example, processor 110 can be a symmetric multi-processor system containing multiple processors of the same type.

Memory 120 and/or storage 190 are accessible by processor 110, thereby enabling processor 110 to receive and execute instructions stored in memory 120 and/or storage 190. Memory 120 can be, for example, a random access memory (RAM) or any other suitable volatile or non-volatile computer readable storage medium, e.g., an EEPROM. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable.

One or more software modules 130 are encoded in storage 190 and/or in memory 120. The software modules 130 can comprise one or more software programs or applications comprising computer program code or a set of instructions for execution by the processor 110. Such computer program code or instructions for carrying out operations in accordance aspects of the systems, methods and computer program products disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 105, partly on computing device 105, partly on computing device 105 and partly on a remote computer/device, or entirely on the remote computer/device or server computer. In the latter scenario, the remote computer can be connected to computing device 105 through any type of network, including a local area network (LAN) or a wide area network (WAN), or the connection can be made to an external computer (for example, through the Internet using an Internet Service Provider).

One or more software modules 130, including program code/instructions, are located in a functional form on one or more computer readable storage devices (such as memory 120 and/or storage 190) and are selectively removable. The software modules 130 can be loaded onto or transferred to computing device 105 for execution by processor 110. Those of skill in the art recognize that the software modules 130 and one or more computer readable storage devices (such as memory 120 and/or storage 190) form a computer program product that can be manufactured and/or distributed in accordance with embodiments of the present invention.

In accordance with some embodiments, it should be understood that one or more of software modules 130 can be downloaded over a network from another device or system via communication interface 150 to storage 190 for use within the temperature measurement subsystem 100. For instance, program code stored in a computer readable storage device in a server computer (not pictured) can be downloaded over a network from the server computer to temperature measurement subsystem 100. According to the present embodiment, included among the software modules 130 are program code for a telemedicine application 160 (also referred to in the drawings as the “Kinsa app” or “Kinsa application”), a temperature determination application 164, a calibration application 168, a communications module 170, a prompt generator module 172, a matching module 174, and/or an analytics module 176, a given one of which can be executed by processor 110.

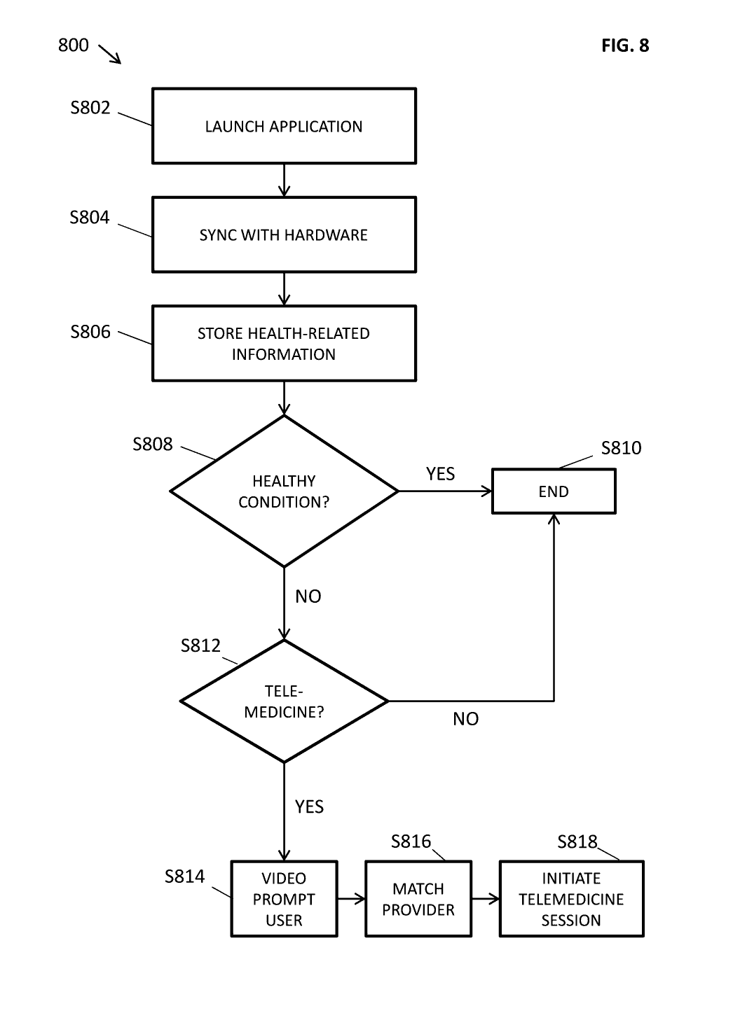

In particular, the telemedicine application 160 provides users with the ability (via computing device 105) to schedule an appointment and communicate with one or more healthcare providers (telemedicine providers), such as physicians, nurses, or other care providers directly through the application. Information associated with third parties can be leveraged to provide such services. Users can be connected with medical professionals directly through the application, such as via phone, SMS or other messaging platform, video conference or by offering scheduling for an in-person consultation. In certain, embodiments, the telemedicine application 160 allows a user to navigate through several different screens on his or her computing device 105 in response to user actions (e.g., use of a connected health device 305, responding to a prompt generated by the application), actions by computing device 105 (e.g., generation of a prompt) and/or actions by the computing device of a telemedicine provider (e.g., syncing of provider information). Through this service, users can be provided with healthcare services, and healthcare providers (telemedicine providers) can receive information such as a user's symptoms, chief complaints, and diagnosis, which can be simultaneously collected and/or aggregated. The telemedicine application 160 is described in greater detail below with regard to example implementations of FIGS. 8-18.

During execution of the software modules 130, and specifically, the telemedicine application 160, the temperature determination application 164, the calibration application 168, the communications module 170, the prompt generator module 172, the matching module 174, and/or the analytics module 176, the processor 110 configures the circuit board 140 to perform various operations relating to communication, prompt generation, matching, and analytics, respectively, as is described in greater detail below. It should be understood that while software modules 130, 160, 164, 168, 170, 172, 174, and/or 176 (“the software modules”) can be embodied in any number of computer executable formats, in certain implementations the software modules comprise one or more software application programs that are configured to be executed at computing device 105 in conjunction with one or more applications executing at remote devices, and/or one or more viewers, such as internet browsers and/or proprietary applications. Furthermore, in certain implementations, the software modules can be configured to execute at the request or selection of another computing device, a user of another computing device, e.g. telemedicine provider 320 (or any other such user or computing device having the ability to execute a program in relation to computing device 105, such as a network administrator), while in other implementations computing device 105 can be configured to automatically execute the software modules without requiring an affirmative request to execute.

It should also be noted that while FIG. 1 depicts memory 120 oriented on the circuit board 140, in an alternate implementation, memory 120 can be operatively connected to the circuit board 140. In addition, it should be noted that other information and/or data relevant to the operation of the present systems and methods (such as data repository 180) can also be stored on storage 190, as is described in greater detail below.

A data repository or other data store 180 may also be stored as part of storage 190. In certain implementations, data repository 180 contains and/or maintains various data items and elements that are utilized throughout the various operations of temperature measurement subsystem 100. It should be noted that although data repository 180 is depicted as being configured locally to computing device 105, in certain implementations data repository 180 and/or various data elements stored therein can be located remotely (such as on a remote device or server computer, not shown) and connected to computing device 105 through a network, in a manner known to those of ordinary skill in the art.

Communication interface 150 is also operatively connected to circuit board 140. Communication interface 150 can be any interface that enables communication between the computing device 105 and external devices, machines and/or elements. Communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or other such interfaces for connecting computing device 105 to other computing devices and/or communication networks such as private networks and the Internet. Such connections can include a wired connection or a wireless connection (e.g. using the 802.11 standard), although it should be understood by those of skill in the art that communication interface 150 can comprise any interface that enables communication to/from the circuit board 140. Additionally, in accordance with at least one implementation, computing device 105 can optionally include an input cavity 115 (e.g., headphone jack) for wired connection with one or more connected health devices.

At various points during the operation of the health monitoring and tracking system, computing device 105 can communicate with one or more external computing devices, such as those controlled and/or maintained by one or more individuals or entities. Such computing devices transmit and/or receive data to/from computing device 105, thereby preferably initiating maintaining, and/or enhancing the operation of the health monitoring and tracking system 100. It should be understood by those of ordinary skill in the art that such computing devices can be in direct communication with computing device 105, indirect communication with computing device 105, and/or can be communicatively coordinated with computing device 105.

As mentioned above, in accordance with one or more implementations, additional components of the health monitoring and tracking system are shown in a high-level block diagram of FIG. 2. As stated above in reference to FIG. 1, in one arrangement, the processor 110 of computing device 105 can have a number of hardware units and a number of processors that are configured to execute software modules 130, which can comprise a telemedicine application 160, a temperature determination application 164, a calibration application 168, a communications module 170, a prompt generator module 172, a matching module 174, and an analytics module 176. Further, as stated above, processor 110 can access one or more data repositories 180, which can contain and/or maintain various data items and elements that are utilized throughout the various operations of the systems of the present application. In accordance with one or more configurations, the data repository 180 can also store health-related information 205 and/or provider information 210.

In particular, health-related information 205 can include, but is not limited to, one or more medical measurements 215 of a patient (e.g., temperature, blood pressure, heart rate, blood glucose, weight, and breathing measurements), information regarding one or more medical conditions and/or diseases 220, at least one health-related symptom 225, one or more geographic locations 230 associated with at least one computing device 105, one or more dates 235 associated with at least one medical measurement, a user identifier 240, and/or the identification 245 of one or more computing devices 105. In one or more embodiments, the health-related information also includes insights regarding: (i) contagiousness of illnesses, (ii) an illness that is circulating or common in a particular geographical area, and/or (iii) one or more symptoms that are circulating or common in a particular area.

Provider information 210 can include, but is not limited to, information regarding at least one party 250 (e.g., healthcare provider), where the party is enabled or otherwise operative to target products and/or interventions associated with at least some of the health-related information. Provider information 210 can also comprise information regarding products and/or interventions 255 associated with the at least some of the health-related information, for example, recommended medicines or treatment interventions to be implemented with a patient in response to the patient's medical measurement(s) 215, medical condition(s)/disease(s) 220, and/or symptom(s) 225. In at least one implementation, provider information comprises information related to one or more pharmacies.

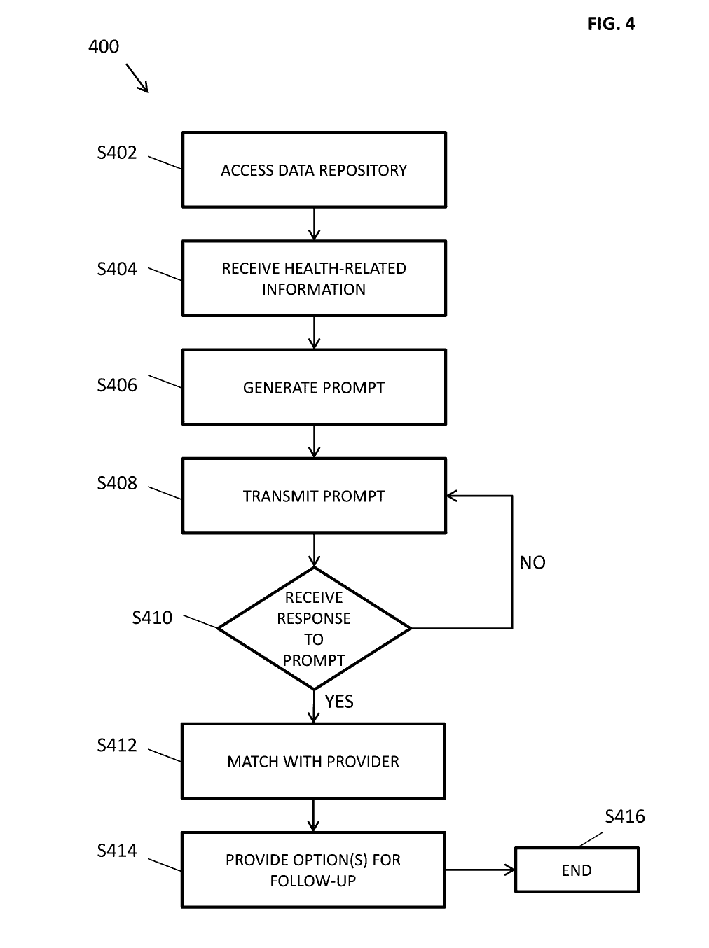

The operation of the health monitoring and tracking system and the various elements and components described above are further appreciated with reference to the health monitoring and tracking methods described below in conjunction with FIGS. 4-9. FIG. 4 presents a flow diagram illustrating a routine 400 that describes high-level functionality of a health monitoring and tracking method in accordance with various embodiments of the present invention. It should be appreciated that several of the logical operations described herein are implemented as a sequence of computer implemented acts or program modules executing on computing devices that are deployed as part of the health monitoring and tracking system. The implementation is a matter of choice dependent on the requirements of the computing device (e.g., size, energy, consumption, performance, etc.). Accordingly, the logical operations described herein are referred to as operations, steps, structural devices, acts, or modules. As referenced above, several of these operations, steps, structural devices, acts, and modules can be implemented in software, firmware, special purpose digital logic, and any combination thereof. It should also be appreciated that more or fewer operations can be performed than shown in the figures and described herein. These operations can also be performed in a different order than those described herein.

Continuing with reference to FIG. 4, the process begins at step S402 with the processor 110, executing one or more software modules 130, configures computing device 105 to access one or more data repositories 180. In particular, the computing device 105 can access the health-related information 205 stored on the one or more data repositories 180. For example, computing device 105 can access medical measurements 215, symptoms 225, and/or medical conditions/diseases 220 associated with a particular user, which may also comprise access to medical history information for a patient, such as vaccination history, prior medical issues or conditions, etc., as well as information obtained from other users in the patients geographic area or personal (social) networks, which may include aggregated data. In one or more implementations, the health-related information 205 can be received from the data repositories 180 by one or more computing devices 105. Certain health-related information 205 (e.g., symptoms 225) can first be provided by the user to the computing devices 105 via user input, while other health-related information 205 can be provided to the computing devices 105 in other ways. For example, medical measurements 215, as discussed above in reference to FIGS. 2 and 3, can be associated with one or more connected health devices 305, with each of the connected health devices 305 being communicatively connectable to one or more computing devices 105. As such, the medical measurements 215 can be received by the computing devices 105 and then transmitted by the computing devices 105 to the data repository 180. In an alternative embodiment, the medical measurements 215 can be received by the data repository 180 directly from the connected health devices 305. After receipt of the medical measurement 215 from the data repository 180, the computing device 105 (via processor 110 executing one or more software modules 130) can then access the medical measurements 215 stored on the data repository 180.

In an example implementation of step S402, the data repository 180 receives a temperature measurement (medical measurement 215) from a computing device 105. The temperature measurement can be determined by a temperature sensing device (connected health device 305) for transmission to the computing device 105 prior to being received by the data repository 180. As such, after receipt of the temperature measurement by the data repository 180, the computing device 105 (via processor 110 executing one or more software modules 130) can access the temperature measurement.

In accordance with step S402, the computing device 105 can also access the provider information 210 stored on the one or more data repositories 180. The provider information 210 comprises at least one party 250 (e.g., healthcare provider) that is enabled or otherwise authorized to target products and/or interventions associated with at least some of the health-related information 205. The provider information 210 can also comprise information regarding products and/or interventions 255 associated with the at least some of the health-related information 205. In one or more implementations, the provider information 210 can be associated with one or more particular users.

At step S404, the processor 110 executing one or more software modules 130 configures the computing device 105 to receive health-related information in response to an event that is triggered following completion of a user action (e.g., a “triggering event”) on the computing device 105. In one or more implementations, the computing device 105 receives the health-related information 205 from the one or more data repositories 180, which the computing device 105 has accessed in step S402. In at least one implementation, the computing device 105 can receive the health-related information 205 directly from computing device 105. Further, with regards to step S404, a “triggering event” can include, but is not limited to, events such as a user completing a medical measurement 215 via a connected health device 305 (after which, the medical measurement can be transmitted by the connected health device to the data repository 180 independently or via the computing device 105), a user inputting one or more symptoms to his or her profile in the telemedicine application 160, a user indicating whether he or she has seen a doctor, a user answering diagnosis-specific questions, a user joining a group, and a user creating a group.

In accordance with an example implementation of step S404, the triggering event is a temperature measurement of a user, where the calculated temperature measurement is transmitted by the connected health device (e.g., temperature sensing probe) to the data repository 180. In response to this triggering event, the computing device 105 (via processor 110 executing one or more software modules 130) receives the calculated temperature measurement (health-related information) from the data repository 180. Alternatively, in at least one implementation, the computing device 105 receives the calculated temperature measurement directly from temperature sensing probe.

At step S406, the processor 110 executing one or more software modules 130 (in particular, prompt generator module 172), configures computing device 105 to generate at least one prompt based at least in part upon some set or sub-set of the health-related information received at step S404. The prompt(s) that the software modules instruct the processor to generate can be regarding the user's health status based on the received health-related information (e.g., medical measurements, symptoms, etc.). The one or more prompts, which in accordance with one embodiment are used in the provision of medical guidance, can utilize (as well as be triggered by) a variety of input data including, but not limited to symptomatic data, symptomatic data in conjunction with demographic data (e.g., age), diagnosis data, diagnosis data in conjunction with demographic data (e.g., age), or vital sign data or vital sign data in conjunction with demographic data, as well as various combinations of the foregoing.

The one or more generated prompts can enquire or issue statements directed to the user regarding his or her health status. These prompts can be in regard to the present conditions and experiences of the user (e.g., the user's symptoms, whether the user has seen a medical professional recently), as well as future considerations the user should think about in regard to his or her health condition (e.g., whether the user should contact a healthcare provider soon, what type of health condition does the user like have). For example, in response to a received temperature measurement (e.g., an above normal temperature), the computing device 105 can generate one or more prompts asking, “How long have you had a fever?”, “Have you taken fever reducing medication”, “Are you experiencing any of these common symptoms?”, “What symptoms are you experiencing?”, “Are you experiencing any additional symptoms?”, and/or “Have you seen a healthcare provider regarding your fever?”. In this example, the computing device 105 can also generate prompt(s) stating (to the user): “You should contact your healthcare provider,” and/or “Your fever indicates that you may have an infection.”

Following the generation of one or more prompts at step S406, at step S408 the processor 110 executing one or more software modules 130 (particularly, communications module 170), configures computing device 105 to transmit the one or more prompts. The one or more prompts are transmitted to the user via the computing device(s) 105, for instance via the telemedicine application 160. Again, the telemedicine application 160 provides users with the ability (via computing device 105) to schedule with and communicate with healthcare providers (telemedicine provider), such as physicians, nurses, or other care providers directly through the application. The telemedicine application 160 is described in greater detail below with regard to FIGS. 8-11.

At step S410, the processor 110, executing one or more software modules 130, configures computing device 105 to receive a response to the at least one prompt. The response to the at least one prompt can be provided to the computing device 105 by the user via user input. In one or more implementations, the response to the prompt can be one of several predetermined options provided with the prompt. For example, in a prompt to the user that asks “Have you seen a healthcare provider regarding your fever?”, the prompt can include predetermined responses of “YES” and “NO”, from which the user can choose one or the other. Similarly, in a prompt to the user that asks “Are you experiencing any of these common symptoms?”, the prompt can include several “common symptoms” from which the user can choose one or more. As such, in this example, the user can instruct application to transmit the response to the computing device by clicking on one (or more) of the predetermined responses provided with the prompt. In at least one implementation, the user can provider a response to a prompt using their own words, such as via typing using the computing device 105 and/or the application, or voice to text diction services known to those of skill in the art. If the computing device 105 does not receive a response to the one or more prompts within a predetermined period of time, the one or more prompts can be re-transmitted by computing device 105 at step S408 to the user.

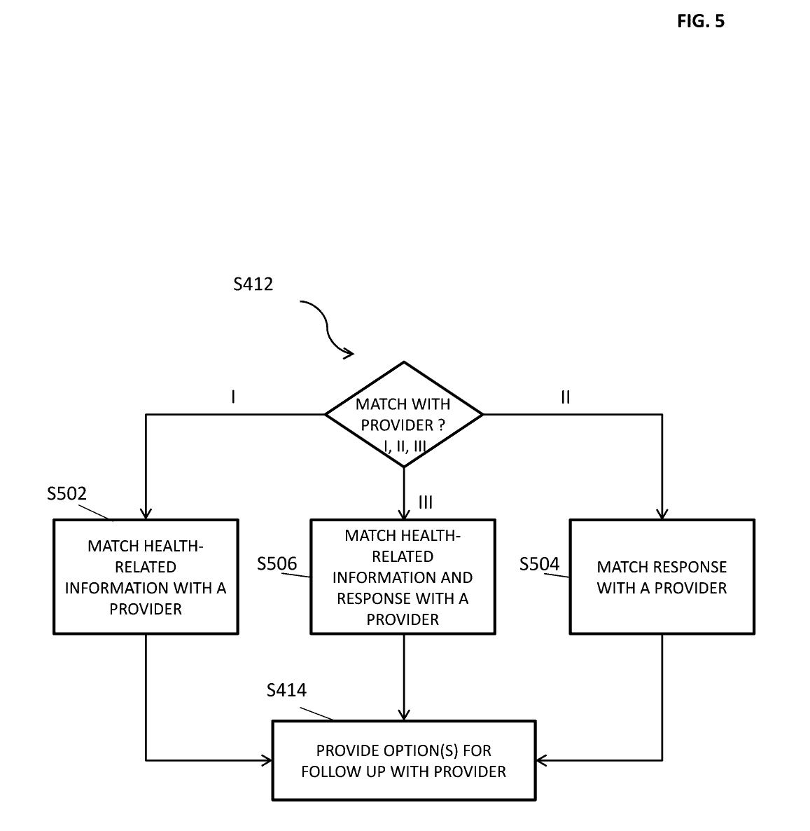

With continued reference to FIG. 4 and with reference to FIG. 5, after receiving a response to the at least one prompt, at step S412 the processor 110, executing one or more software modules 130 (in particular, matching module 174), configures computing device 105 to match at least some of the provider information with at least one of the prompt and/or the received health-related information. More specifically, as shown at FIG. 5, at step S412, the computing device is configured to match at least some of the provider information with (I) the received health-related information (S502), (II) the response to the (at least one) prompt (S504), or (III) both the received health-related information and the response to the (at least one) prompt (S506). In one or more implementations, the provider information that is matched comprises information identifying a healthcare provider (telemedicine provider 320, e.g., nurse, nurse practitioner, physician, physician's assistant) who is enabled, authorized or otherwise qualified to target products and/or interventions associated with at least some of the health-related information 205.

For instance, in an example implementation of step S412, after receiving health-related information in the form of a temperature measurement showing that the user has a low-grade fever of 100° F. and a response to a prompt (“Are you experiencing any other symptoms?”), where the response states that the user also has symptoms including nasal congestion, a sore throat, and a cough, the computing device 105 can be configured to match the health-related information and the response with provider information for a primary care physician as the symptoms are fairly mild and coincide with common illnesses such as a cold or the flu. Similarly, if the health-related information and/or the response to the prompt indicate that the patient may have a less common illness or medical condition, the computing device 105 can be configured to match the health-related information and/or response of the user with a specialty healthcare provider (e.g., specialist physician) whose specialty best fits the health-related information and/or the response to the prompt. In one or more implementations, if the health-related information and/or the response to one or more prompts does not result in a match with any specialty healthcare provider, the matching module 174 is configured to provide a default match to provider information for a primary care physician. In one or more implementations, the user can be matched with a healthcare provider that the user already utilizes based on provider information already associated with that particular user. It should be understood however, that matching a user with a healthcare provider for the provision of telemedicine services can be user-initiated at any time, and is not dependent upon the recordation, presence or occurrence of any specific symptoms, diagnosis or demographic data.

Returning to FIG. 4, at step S414 the processor 110, executing one or more software modules 130, configures computing device 105 to provide one or more options for following up on the user's health condition based on the match of step S412. These options can include, but are not limited to, scheduling a meeting with the matched provider (e.g., in-office appointment with a healthcare provider), communicating with the matched provider (e.g., via telephone, video conferencing, etc.), and/or sending information associated with the received health-related information to the matched provider. In at least one implementation, at step S416 the process can terminate. For example, the user can follow up with the matched provider outside of the systems of the present application.

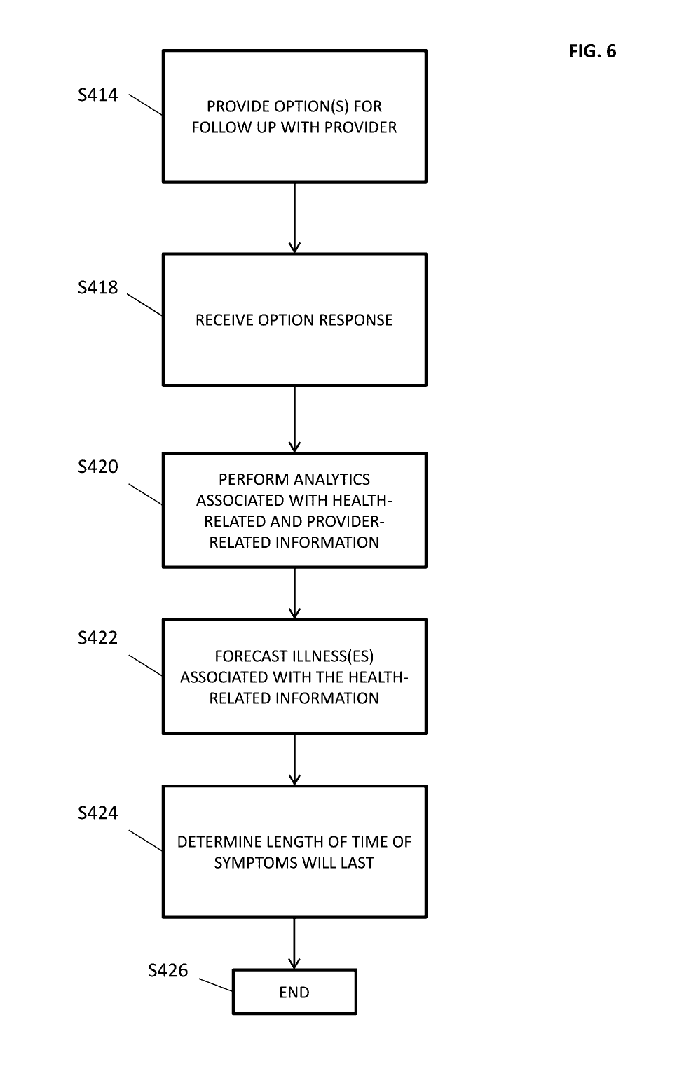

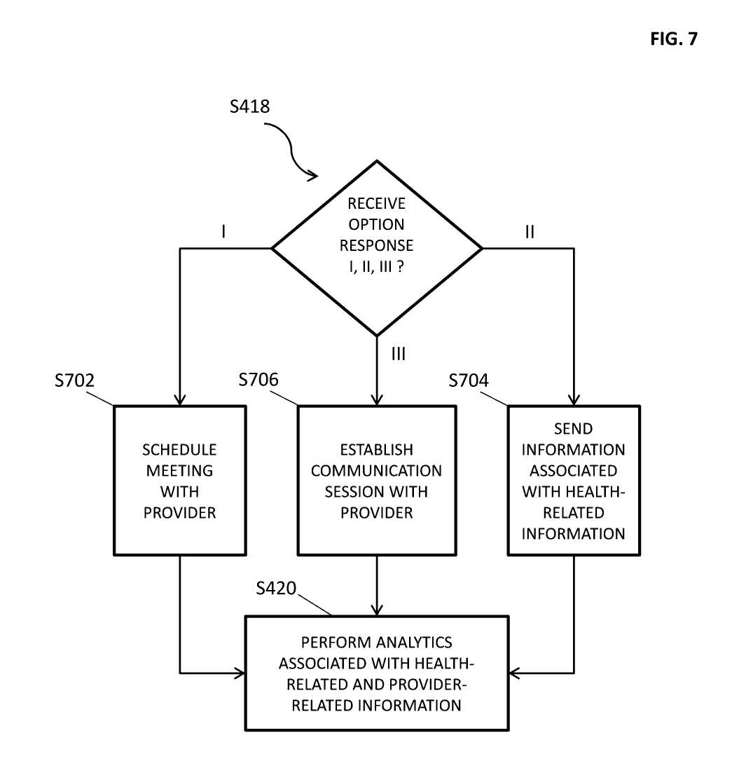

The process 400 of FIGS. 4 and 5 continues at step S418 as shown in FIG. 6 and FIG. 7. With reference to FIG. 6, at step S418 the processor 110, executing one or more software modules 130, configures computing device 105 to receive a response to the at least one follow-up option of step S414, and to initiate at least one of the follow-up options of step S414. In particular, in accordance with one or more implementations and as shown in FIG. 7, the software modules 130 configure the computing device 105 to initiate at least one of three follow-up options: (I) scheduling the meeting with the matched provider (telemedicine provider 320) [S702], (II) sending the information associated with the received health-related information to the matched provider (telemedicine provider 320) [S704], and (III) establishing a communication session with the matched provider (telemedicine provider 320) [S706]. In one or more embodiments, any additional health-related information provided by the user and/or any additional provider information provided by matched provider, is synchronized for storage in the data repository 180, where the information is accessible by the computing device 105. It should be also be noted that, in at least one implementation of the method of routine 400, any user action that results in the generation or collection of health-related information includes the transmission of any such health-related information via the telemedicine application 160 (e.g., responding to a prompt, participating in follow-up with a provider) for storage in the data repository 180, where the health-related information is accessible by the computing device 105.

With continued reference to FIG. 6, at step S420 the processor 110, executing one or more software modules 130 (in particular, analytics module 176), configures computing device 105 to perform analytics associated with health-related information and provider information. More specifically, at step S422 the computing device 105 is configured analyze health-related information and provider information, which may comprise additional health-related information and provider information gathered and stored in data repository 180 at step S418. At step S420 the processor 110, executing one or more software modules 130 (such as, analytics module 176), configures computing device 105 to forecast at least one illness associated with the received health-related information. Finally, at step S424, the processor 110, executing one or more software modules 130 (such as, analytics module 176), configures computing device 105 to determine an estimated length of time that symptoms associated with the received health-related information will last and/or an estimated length of time when a person having the symptoms will feel better. Such estimated illness forecast can utilize information generated by various combinations of the user, telemedicine provider, other users and illness patters determined from the medical literature. This information may include guidance on how long symptoms will last, when a user will begin feeling better and how long the user will remain contagious

In one or more implementations, steps S420 through S424 can be consolidated into one step. For example, the processor 110, executing one or more software modules 130 (in particular, analytics module 176), configures computing device 105 to analyze the health-related information and provider information to forecast an illness associated with the health-related information, and determine an estimated length of time that symptoms associated with that illness will last and/or when the user will feel better. Additionally, in one or more implementations, at steps S420 through S424, the computing device 105 can be configured to generate and transmit to the user at least one prompt representing the forecasted illness or medical condition; a corresponding degree of urgency regarding implementing treatment of the illness or medical condition, and/or a recommendation to contact at least one healthcare provider. At step S426 the process can terminate.

In accordance with a further aspect of the present application, a method for initiating telemedicine is described below. In one or more implementations, the method for initiating telemedicine is performed using the telemedicine application 160 of computing device 105.

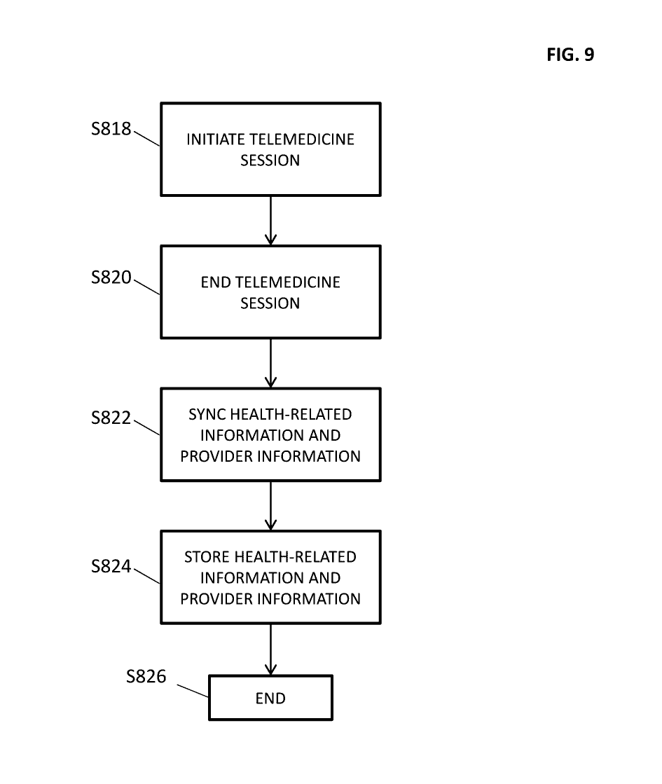

FIGS. 8 and 9 present flow diagrams illustrating a routine 800 that describes one aspect of initiating a telemedicine method. In one or more implementations, routine 800 can be performed in conjunction with routine 400 using computing device 105, for example with routine 800 beginning at step S706 (“establishing a communication session with a provider” [S418]) of routine 400. With reference to FIG. 8, the process for initiating telemedicine (routine 800) begins at step S802 where processor 110, executing one or more software modules 130, configures computing device 105 to launch the telemedicine application 160.

At step S804, processor 110, executing one or more software modules 130 (in particular, telemedicine application 160), configures computing device 105 to sync health-related information 205 (e.g., medical measurements 215) from the one or more connected health devices 305 to the telemedicine application 160. For example, one or more temperature measurements of the user from a temperature sensing device (temperature probe) can be synced to the telemedicine application 160 of computing device 105. In one or more implementations, the health-related information from the connected health devices 305 can be synced to the telemedicine application 160 of computing device 105 via one or more wireless connections, including but not limited to Bluetooth/BLE, Wi-Fi, cellular data, NFC, satellite, and infrared. The connected health devices 305 can also be synced to the telemedicine application 160 via wired connections, such as via an audio connector (e.g., TRS/TRRS), USB (including mini, micro, C, etc.), or any other wired connector as is known in the art.

At step S806, the processor 110, executing one or more software modules 130 (in particular, telemedicine application 160), configures computing device 105 to store the synced health-related information 205 to the data repository 180. In one or more implementations, the data repository 180 is accessible by the computing device 105. As an optional feature of one or more embodiments of the present invention, the data repository 180 is operative to save and preserve in the could the health history and other information of the user including, but not limited to, photos, notes, symptoms inputs, information from other or related inputs, e.g., telemedicine visit, chief complaint, treatment, diagnosis) such that the user can access such information from any computing device in communication with the data repository over the network. Using the data repository in such a manner and in communication with remote and/or mobile devices, allows for the formation of anywhere accessible electronic medical records that remain regularly updates through the collection of health related information in and during acute medical situations.

At step S808, the processor 110, executing one or more software modules 130 (in particular, telemedicine application 160), configures computing device 105 to analyze the synced health-related information 205 to determine whether the health-related information indicates that the user is healthy or not. If the synced health-related information 205 indicates that the user is healthy, then the process can end at step S810. Optionally, at step S810 the processor 110, executing one or more software modules 130 (in particular, telemedicine application 160), can configures computing device 105 to generate a prompt which provides positive reinforcement to the user for having a healthy habits and/or displays the user's health-related information. If the synced health-related information 205, however, indicates that the user is unhealthy, then the process continues at step S812. According to one or more alternative program flows, processing may continue from step S808 to step S812 where the check that the software performs at step S808 evaluates to YES, thereby bypassing step S810 and allowing a healthy user to access the telemedicine services described and disclosed herein.

In particular, at step S812, the processor 110, executing one or more software modules 130 (in particular, telemedicine application 160), configures computing device 105 to generate a prompt asking the user whether he or she wants to initiate a telemedicine feature via telemedicine application 160. In one or more implementations, user can provide a response to the prompt by selecting one of several predetermined responses provided in the prompt (e.g., “YES” or “NO”). If the user declines to initiate the telemedicine feature, then the process ends and program flow reverts to step S810. Optionally, if the user declines to initiate the telemedicine feature, the telemedicine application 160 can be configured to display an illness history profile comprising at least some of the user's health-related information.

If the user initiates the telemedicine feature then, at step S814 the processor 110, executing one or more software modules 130 (in particular, telemedicine application 160), configures computing device 105 to generate a video prompt introducing the telemedicine feature. In one or more implementations the video prompt comprises an automated video of an animated person speaking to the user. In at least one implementation, the video prompt can also ask the user for additional health-related information, for example asking the user whether he or she is experiencing any symptoms. It should be understood by those of skill in the art that the inclusion of a video prompt is example and that other prompt modalities, such as audio or textual prompts, are considered as falling within the scope of embodiments the invention as described herein.

At step S816 the processor 110, executing one or more software modules 130 (in particular, telemedicine application 160), configures computing device 105 to match the user with a healthcare provider (telemedicine provider 320, e.g., physician) based on the synced health-related information 205. For example, if the health-related information—in this case heart rate and blood pressure readings-indicate that user may have a heart condition, the user can be matched with a cardiologist. In an alternative embodiment, the computing device 105 can be configured to connect to the computing device of a third party provider in order to match the user with a healthcare provider. In at least one implementation, at step S816, the computing device 105 can optionally be configured to send the user's health-related information (e.g., temperature measurements, symptoms) to the matched healthcare provider (telemedicine provider 320).

At step S818, the processor 110, executing one or more software modules 130 (in particular, telemedicine application 160), configures computing device 105 to initiate a telemedicine session with the matched healthcare provider (telemedicine provider 320). In one or more implementations, the telemedicine session comprises audio and/or video conferencing between the computing device 105 and a computing device of the telemedicine provider 320, although other implementations may utilize SMS, MMS, email or other asynchronous communication techniques. It should be understood that the computing device 105 and the computing device of the matched healthcare provider (telemedicine provider 320) can be any computing device configured for audio and/or video conferencing. In one or more embodiments, the healthcare provider (telemedicine provider 320) can perform a virtual, remote exam on the user during the telemedicine session (in this case a video conference), whereby the healthcare provider can see if the user is exhibiting any visible symptoms and can ask the user one or more questions regarding his or her past and/or current health. Further, in one or more embodiments, the telemedicine provider 320 can view the patient's health-related information prior to initiation of the telemedicine session. In still further embodiments, the healthcare provider's computing device can be configured to initiate the telemedicine session.

The computing device 105 can be configured to navigate to another screen within the telemedicine application 160 during the telemedicine session with telemedicine provider 320, such as the user's illness history profile, a local geographic health situation, health status of the patient's social networks, or various combinations thereof, so that the user can view their health-related information while remaining connected to the telemedicine session. For example, if the telemedicine provider 320 asked the user during the session what the user's temperature was two days ago and the user did not recall, the user could navigate to their illness history profile to view his or her past temperature measurements while remaining connected to the telemedicine session. In this implementation, the computing device 105 can be configured to prompt the user to return from the illness history profile back to the screen of the telemedicine session. Further, in one or more implementations, the computing device 105 can be configured to record the telemedicine session for future syncing and storing on data repository 180 (and/or data repository 180).

Now turning to FIG. 9, routine 800 continues with step S820. At step S820, the processor 110, executing one or more software modules 130 (in particular, telemedicine application 160), configures computing device 105 to end the telemedicine session. Optionally, at the end of the telemedicine session, the computing device 105 can be configured to display the user's illness history profile comprising at least some of the user's health-related information. Additionally, the healthcare provider (telemedicine provider 320) may transmit to computing device 105 (via the provider's computing device) information related to the user's health, including but not limited to any doctor's notes, one or more diagnoses, recommended treatment, third party information about the diagnosis, and/or information regarding any prescriptions.

At step S822, the processor 110, executing one or more software modules 130 (in particular, telemedicine application 160), configures computing device 105 to sync health-related information and provider information from the telemedicine session (e.g., information from computing device 105 and/or the provider computing device) to the telemedicine application 160. In one or more embodiments, the health-related information can include the recording of the telemedicine session, as well as any additional information (case file information) transmitted by the user as a result of the telemedicine session (e.g., symptoms). In one or more implementations, the provider information can include information relating to the identification of the healthcare provider, as well as any information transmitted as a result of the telemedicine session, such as the health provider's notes, one or more diagnoses, or recommended treatment, third party information about the diagnosis, and/or information regarding any prescriptions. The computing device 105 and the provider computing device can be synced to the telemedicine application 160 via wireless connections and/or wired connections.

At step S824, the processor 110, executing one or more software modules 130 (in particular, telemedicine application 160), configures computing device 105 to store the health-related information and provider information from the telemedicine session to the data repository 180. In one or more implementations, the data repository 180 is accessible by the computing device 105. In at least one implementation, the data repository 180 is the same as the data repository 180, or operatively is connected to data repository 180.

At step S826, routine 800 ends. Optionally at step S826, the processor 110, executing one or more software modules 130 (in particular, telemedicine application 160), configures computing device 105 to update the illness history profile of the user based on the synced health-related information and provider information. Further, in one or more implementations, at step S826, the computing device 105 can be configured to navigate the user back to the home page of the telemedicine application 160 and/or to the user's illness history profile.

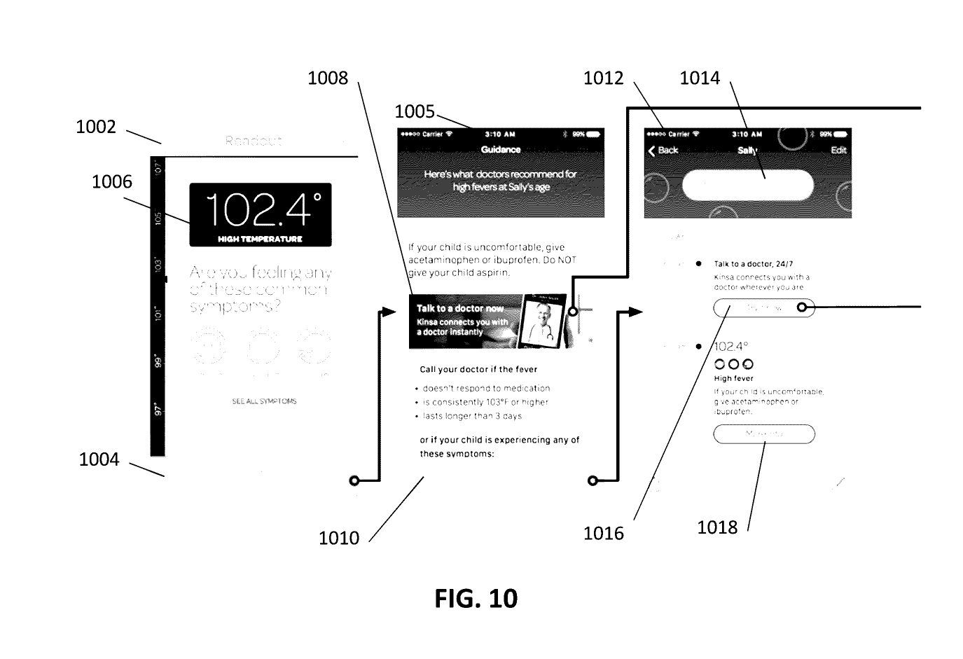

FIGS. 10 through 15 illustrate example user interfaces that may be presented by a programmable processor of a mobile device executing program code, such as the telemedicine application 160, to initiate and provide telemedicine services. Starting with FIG. 10, the display screen 1002 of the mobile device displays a readout indicating the current temperature 1006 of a user as captured by a temperature probe in communication with the mobile device. As dictated by symptoms, which in the present example indicates a fever, the user initiates illness forecasting and medical guidance features by selecting a control 1004 to cycle to the next interface. Selecting the “next” control 1004 initiates presentation of the guidance screen 1005, which provides the user with details regarding a potential illness on the basis of data captured or that the user otherwise provides, as well as the option 1008 to initiate telemedicine services via direct consultation with a medical professional.

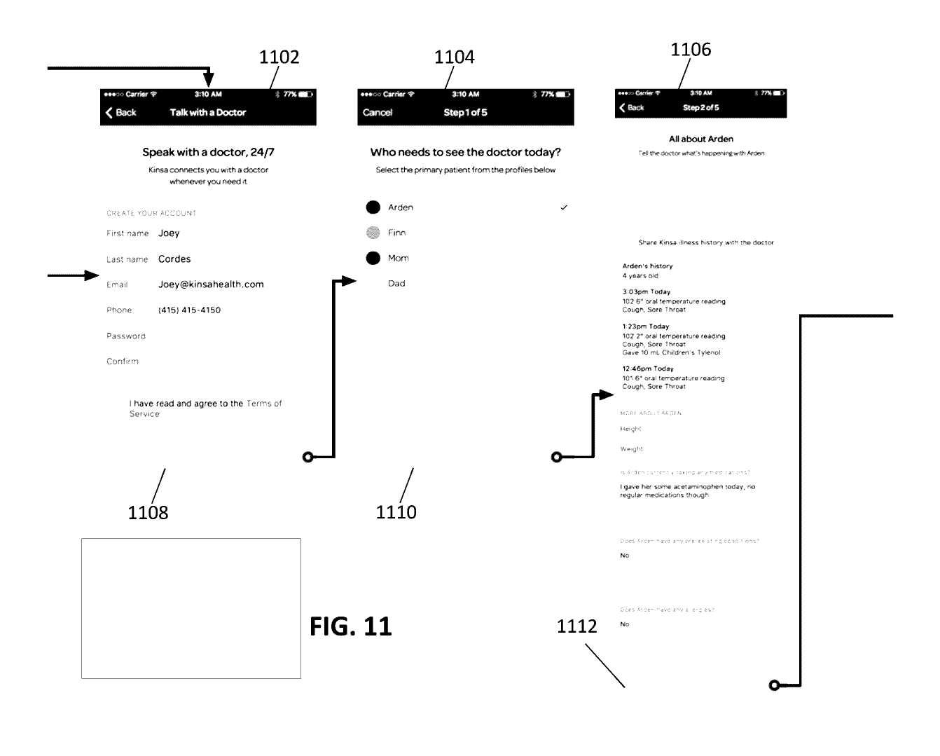

If telemedicine services are not initiated, the user may select a control 1010 to present information 1012 with regard to the possible progression of the illness, as well as suggestions for next steps for the user to take in response thereto. The interface 1012 allows the user to take subsequent temperature measurements (1014), which may return the user to the initial interface 1002. Along with illness progression or forecast information, the user may obtain additional information with regarding to specific illness milestones 1016, as well as more detailed suggestions 1018 for next steps to take in response thereto. Where the user requires telemedicine services, however, user interface flow progresses to FIG. 11.

Turning to FIG. 11, initiation of a telemedicine session begins with the user providing contact information 1102, to the extent that the application has not previously received such information. After the user supplies or retrieves such information, the user submits the data to the application though selection of a “sign up” control 1108. Selection of the sign up control 1108 brings the user to the first step in securing telemedicine services 1104, which is the identification of the specific family member (if not the user himself or herself) that requires medical assistance or intervention. One the user identifies the family member requiring telemedicine services the user selects a control 1110 to cycle to the subsequent interface in the process 1106, which provides an overview of details information in the system with regard to the patient that the user selects, and specifically comprises a display of information that has been collected by the connected health device, e.g., temperature history for the potential patient. Input is complete once the user verifies or corrects the detailed patient information and selects a control 1112 to cycle to the next screen.

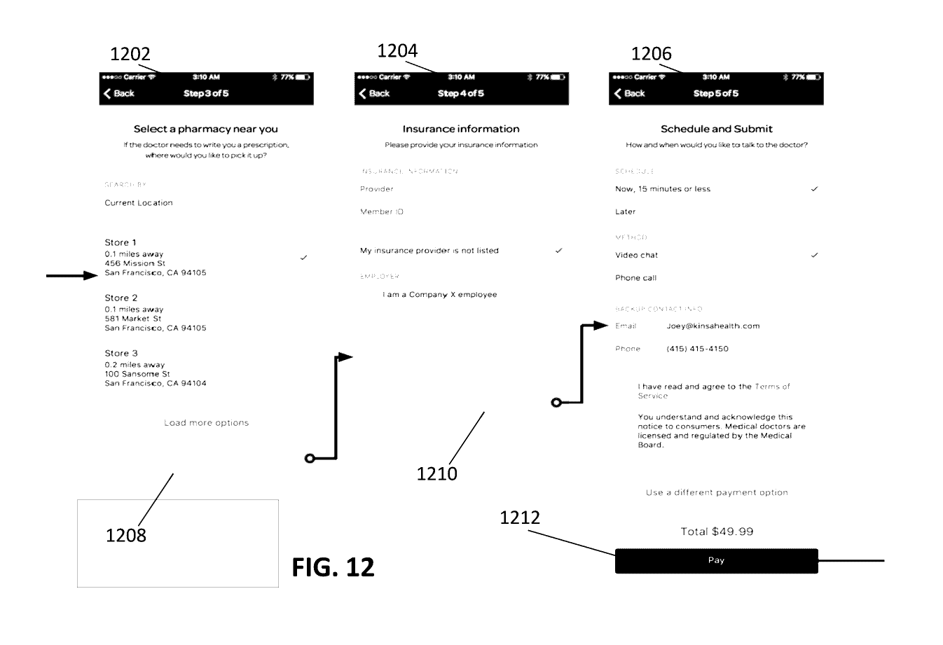

Turning to FIG. 12, after providing the software with details regarding the patient, the user supplies pharmacy information 1202 (submitted at 1208), so that such details are available in the event that the physician providing telemedicine requires the patient to obtain prescription medication. Using information regarding the location of the user, the software cross-references such information with information regarding the location of various pharmacies to provide the user with a set of geographically local pharmacies from which he or she may select a preferred pharmacy. In addition to pharmacy information, the user is further prompted to provide insurance information 1204 for the patient and, in response to submitting such information 1210, receives an interface 1206 to provide scheduling information and to determine the manner in which the user and/or patient is to interface with the physician, e.g., phone call, video chat, text messaging, etc. Additionally, the interface provides a payment control 1212 that allows the telemedicine application to accept payment for the provision of telemedicine services by the physician, which according to some embodiments comprises the telemedicine application interfacing with the billing system of a given physician to effect payment for service.

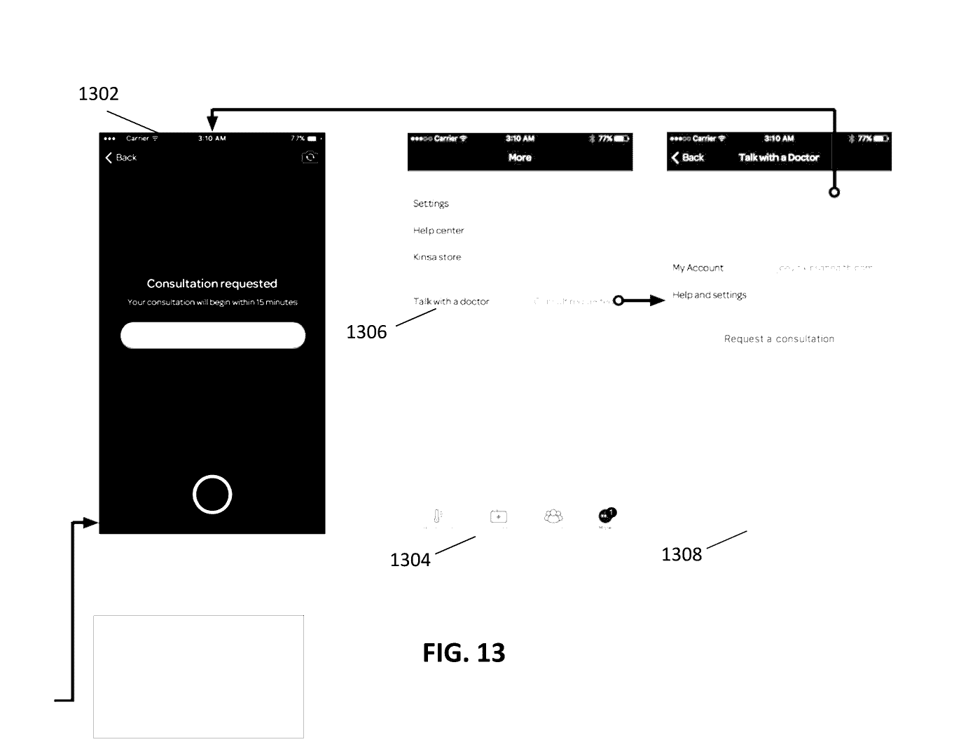

In FIG. 13, the interface transitions 1302 to begin a telemedicine session. In accordance with the example embodiment of FIG. 13, the user is attempting to initiate a video chat with a physician at a specific time, causing the telemedicine application to launch a two-way video communication with the physician. In addition, the telemedicine application provides an interface 1304 to set general settings for the application, which also comprises a control to initiate a telemedicine session 1306, which loads an interface 1308 that allows the user to connect to a physician 1302.

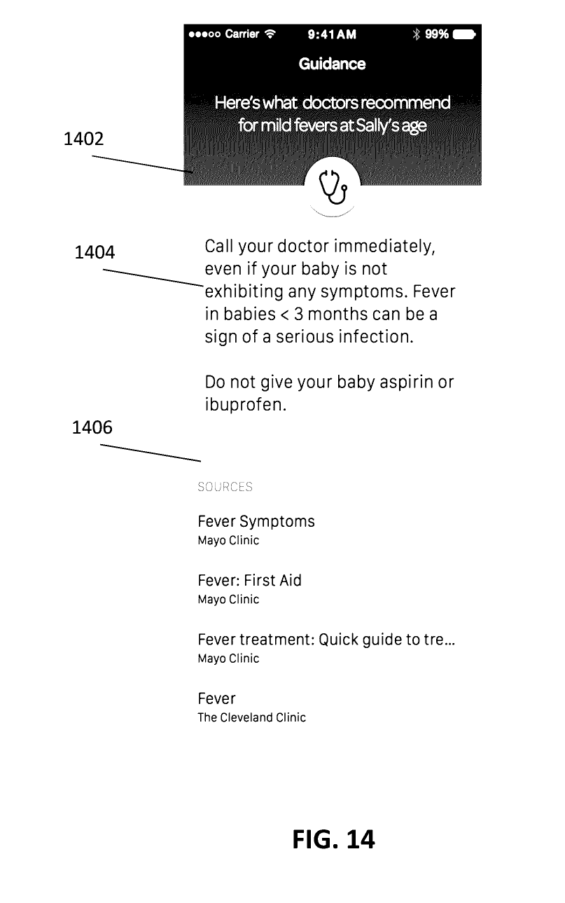

As FIG. 10 illustrates, a programmable processor of a mobile device executing program code, such as the telemedicine application 160, may be operable to provide specific medical guidance 1005, which may occur with or without accessing or otherwise initiating communication with a physician. FIG. 14 illustrates one embodiment of an example user interface and corresponding guidance that a programmable processor, when executing the telemedicine application 160 program code, may present to the user.

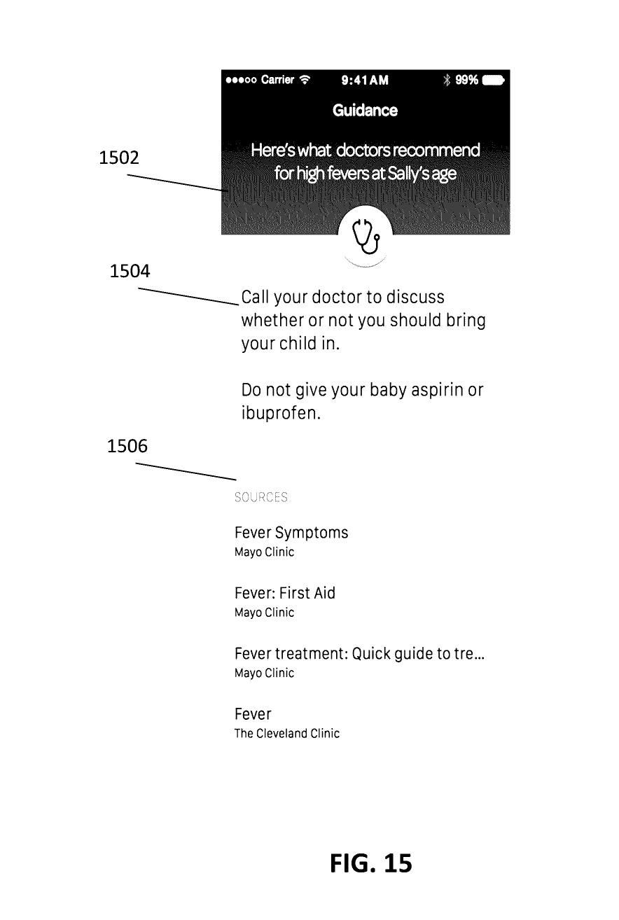

In accordance with the embodiment of FIG. 14, the telemedicine application presents a user interface 1402 that recommends tactics for managing an illness, in the present example a mild fever, which the telemedicine application calculates on the basis of a person's age, fever level, mode of temperature acquisition (e.g., oral), symptoms and other factors. The telemedicine application uses these data as search keys, aggregating the results from one or more widely accepted medical sources 1406 (e.g., Mayo Clinic, Cleveland Clinic, American Academy of Pediatrics, etc.) and the user with appropriate guidance 1404. Such guidance may further take into account addition information that the user provides with regard to the patient, which may be a different individual from the user. FIG. 15 illustrates a similar interface 1502 with tactics for managing an illness, but in the present example presents tactics 1504 for a high fever, as well as the sources 1506 from which the application derives or otherwise determines the tactic.

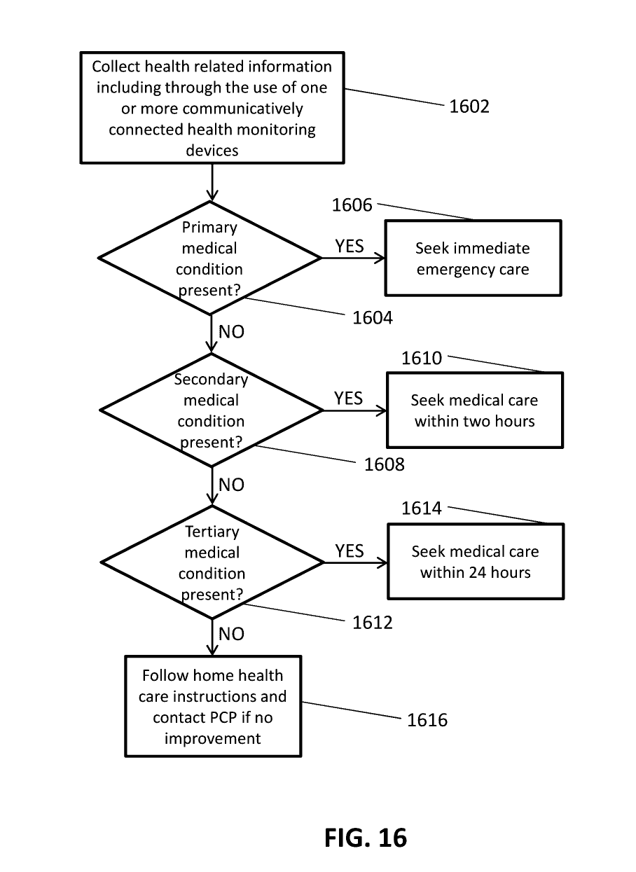

FIG. 16 illustrates one embodiment of a process for recommending tactics for managing an illness. In accordance with the flow diagram of FIG. 16, a connected heath device, which may be communicatively coupled to one or more computing devices, collects one or more items of health related information, step 1602. A telemedicine application, which may be executed by a programmable processor that is part of the computing device, receives the one or more items of health related information and, on the basis thereof, determines if the item(s) of health related information indicate the presence of a primary medical condition, step 1604. A primary medical condition includes, but is not limited to, difficulty breathing, skin or lips turning blue, new onset drooling, inability to swallow, purple or blood-colored spots on the skin, and new seizures in the absence of any history. In the event that a primary medical condition is present, the telemedicine application instructs the user that emergency medical attention should be sought for the patient, step 1606.

Where the telemedicine application does not detect health related information that indicates the presence of a primary medical condition, step 1604, the telemedicine application determines if the item(s) of health related information indicate the presence of a secondary medical condition, step 1608. A secondary medical condition includes, but is not limited to, appearing extremely ill, lethargic or irritable, neck pain with head bending forward, severe head or abdominal pain, difficult or rapid breathing or wheezing, fever less than 48-hours post immunization, fever over 105 F in infants 2 to 6 months of age, fever over 104 that is not responding to reduction measures, seizure, signs of dehydration, and a solid red rash that is tender to the touch. In the event that a secondary medical condition is present, the telemedicine application instructs the user to seek medical attention for the patient within a two hour window, step 1610.

Where the telemedicine application does not detect health related information that indicates the presence of primary or secondary medical conditions, steps 1604 and 1608, the telemedicine application determines if the item(s) of health related information indicate the presence of a tertiary medical condition, step 1612. A tertiary medical condition includes, but is not limited to, fever lasting longer than 24 hours in those older than two and without any other symptoms, fever lasting longer than 72 hours and not responding to reduction measures, yellow phlegm lasting longer than 72 hours, history of diabetes, asthma or seizures, frequent or painful urination, vaginal bleeding, pain or discharge, vomiting, diarrhea or abdominal pain, ear ache or swollen glands, rash, fever lasting more than two or three days in a 7-14 day window subsequent to receiving the MMR vaccine. In the event that a tertiary medical condition is present, the telemedicine application instructs the user to seek medical attention for the patient within twenty four hours, step 1614. Where the telemedicine application does not detect health related information that indicates the presence of primary, secondary or tertiary medical conditions, steps 1604, 1608 and 1612, the telemedicine application instructs the patient to follow a set of home health care instructions and to contact his or her primary care physician (“PCP”) in the event the patient does not exhibit any improvement, step 1616.

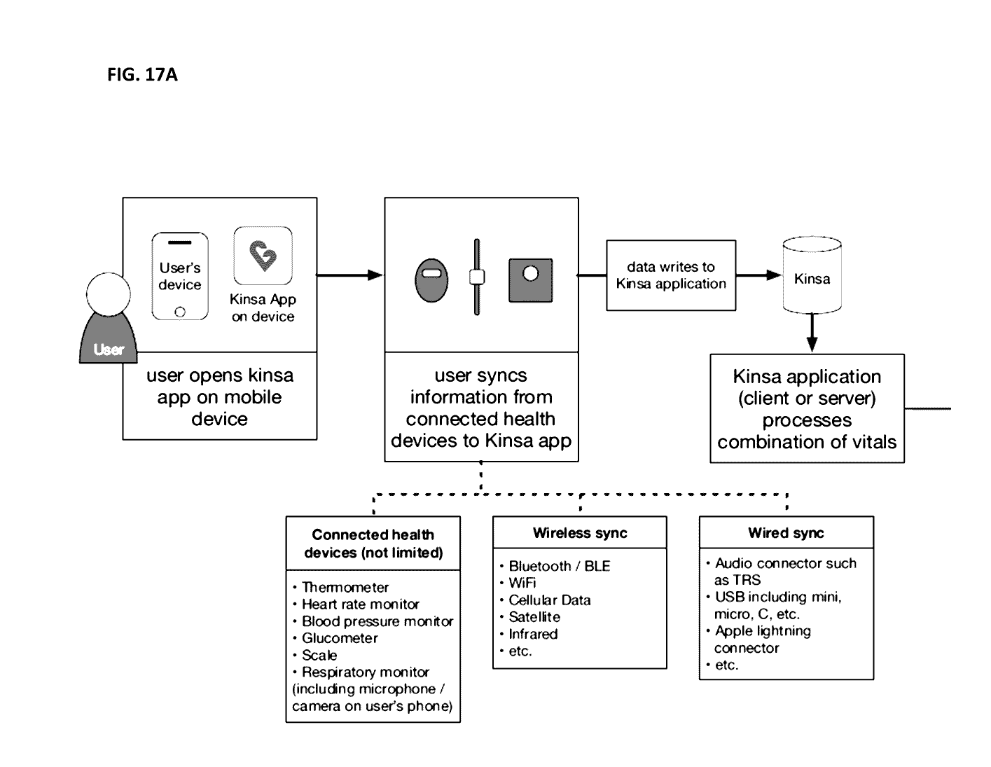

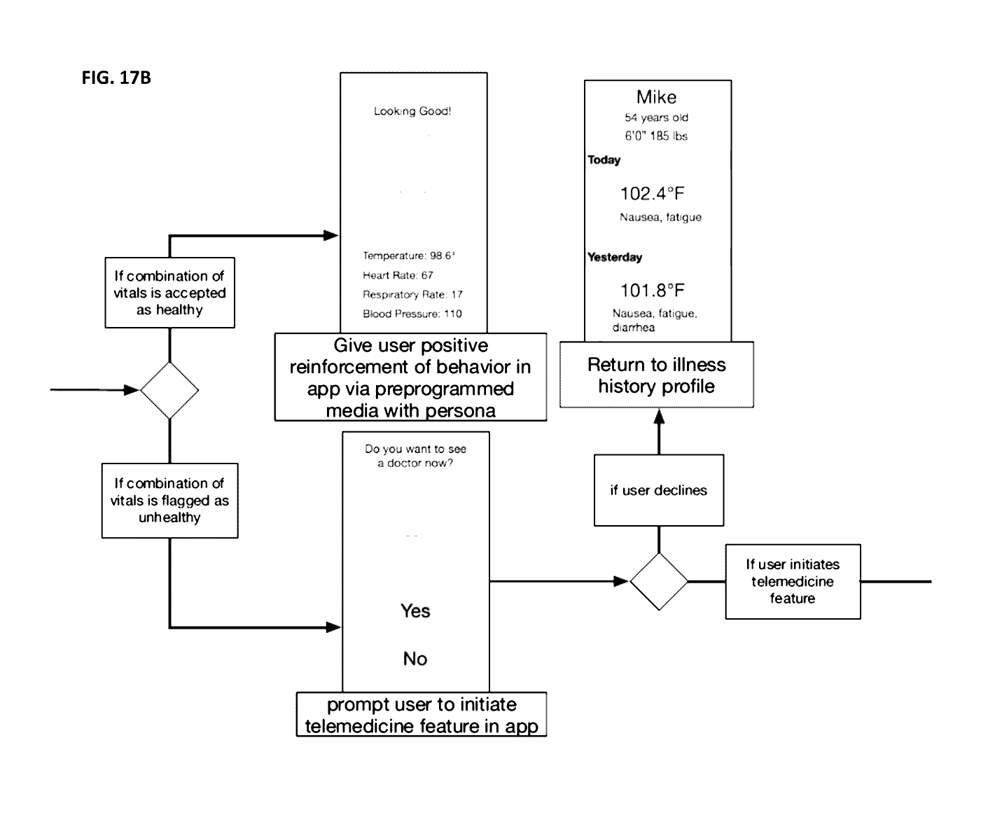

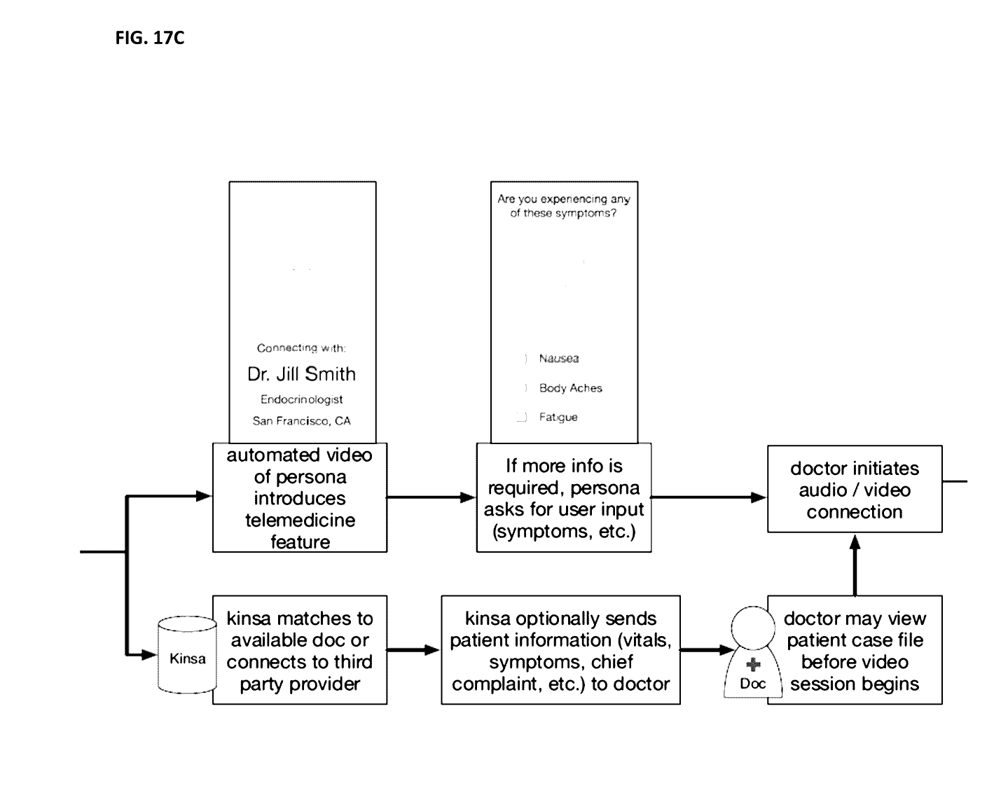

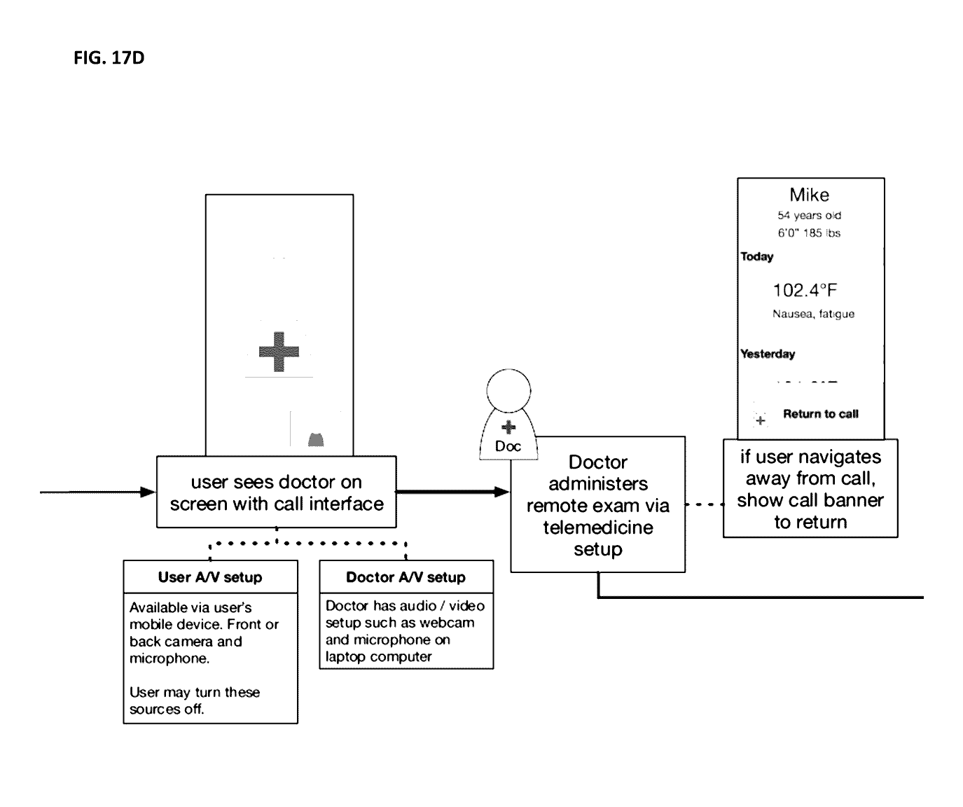

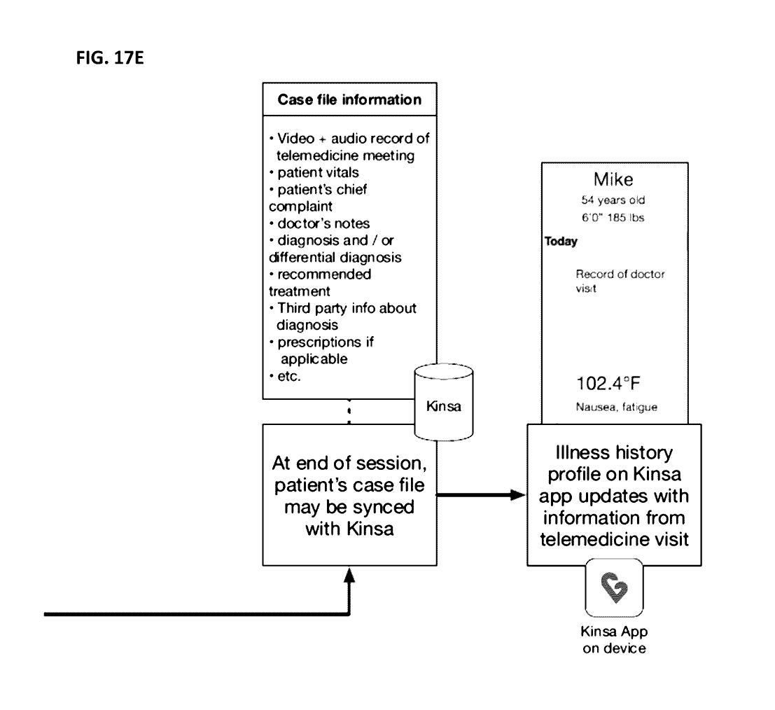

FIG. 17A through E shows an example implementation of routine 800 in which the telemedicine session is conducted between the user mobile device (computing device 105) and the provider's computer (provider computing device), which in accordance with the present example is a laptop computer.

As shown in FIG. 17A, the user launches the telemedicine application 160 on the mobile device (step S802) and then syncs health-related information 205 (e.g., medical measurements 215) from the one or more connected health devices 305 to the telemedicine application 160 via a wireless or wired sync method (step S804). As described herein, health-related information can be obtained from a number of connected health devices, one or more of which can be integrated within the mobile device. Additionally, or in combination with the foregoing, the sensors comprising the mobile device can be used, e.g., by the telemedicine application 150, to collect health-related information. The health-related information 205 is then stored (“data writes to application”) to the data repository 180 (step S806). The synced health-related information is analyzed (“processes combination of vitals”) to determine whether the health-related information indicates that the user is healthy or not (step S808). Turning to FIG. 17B, if the health-related information indicates that the user is healthy, then the telemedicine application displays a prompt providing positive reinforcement and optionally displays the user's health-related information (step S810). If the health-related information indicates that the user is unhealthy, however, the telemedicine application displays a prompt asking the user whether he or she wants to initiate a telemedicine feature in the application (step S812). If the user declines to initiate the telemedicine feature, the telemedicine application can navigate the user back to his or her illness profile (step S810).

If, however, the user initiates the telemedicine feature, then as shown in FIG. 17C, the telemedicine application displays an automated video of an animated person speaking to the user and introducing the telemedicine feature (step S814). Alternatively, or in combination with the foregoing, interaction with the telemedicine feature can be text based. With continued reference to FIG. 17C, if additional information from the user is required, the application can display the animated person asking the user for additional input, such as “are you experiencing any of these symptoms? [nausea, body aches, fatigue]”. After introducing the telemedicine application, the telemedicine application then displays the healthcare provider (“Dr. Jill Smith”) that was matched to the user based on the synced health-related information (step S816). The applications can optionally send the user's health-related information (e.g., temperature measurements, symptoms), which may comprise geographic or social based health-related information, to the matched healthcare provider so that the provider can review the information, which in accordance with some embodiments may be conducted prior to initiation of the telemedicine session.

With reference to FIG. 17D, once the telemedicine session has been initiated, the user can see the doctor on-screen with the call interface, and the doctor can see the user on-screen. In this example, the user is using a mobile computing device and the doctor is using a laptop computer to conduct the telemedicine session, both of which have audio and video capabilities, although the physician can make use of other computing devices, such as a desktop computer, smartphone, etc. During the telemedicine session, Dr. Smith can administer a remote exam of the user. Furthermore, the user can navigate away from the video component to view his or her illness history profile during the telemedicine session without disconnecting from the session. Once the user is done with the illness history profile, he or she can press the “Return to call” button to return to the video screen showing the doctor.

With reference to FIG. 17E, the telemedicine session can be terminated (step S820), at which point the user's case file of information from the telemedicine session (e.g., recording of the session, user's health-related information, doctor's notes, diagnoses, recommended treatment, etc.) can be synced to the telemedicine application (step S822) and stored to the data repository of the user's computing device (step 824), and the illness history profile of the user can be updated based on the synced and stored information.

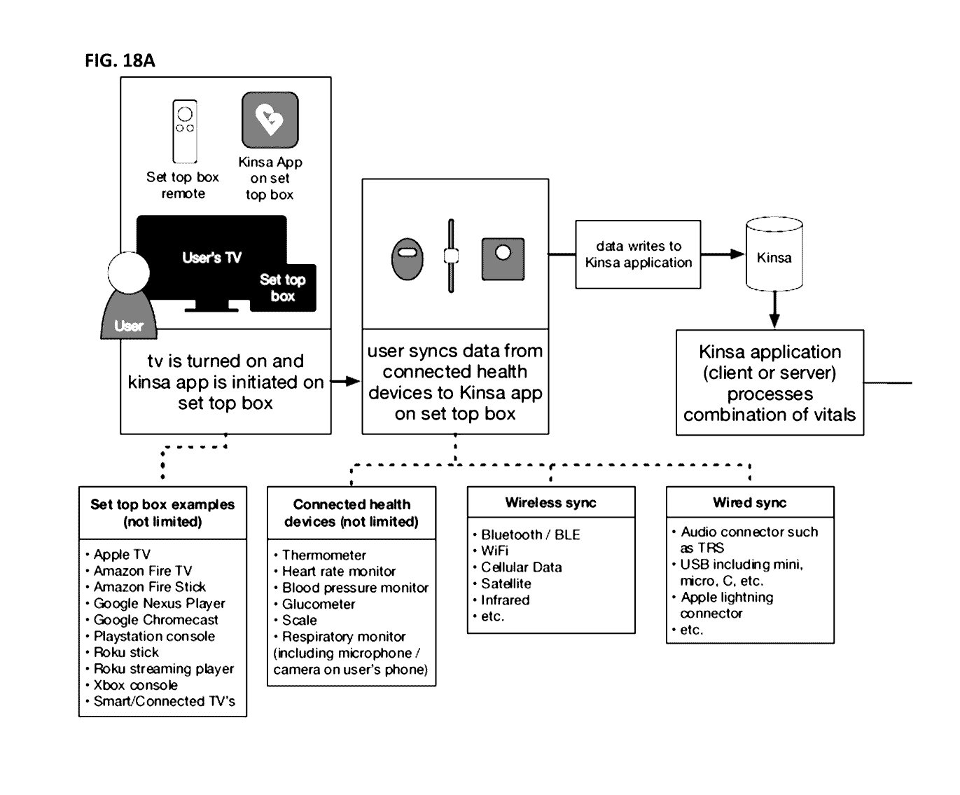

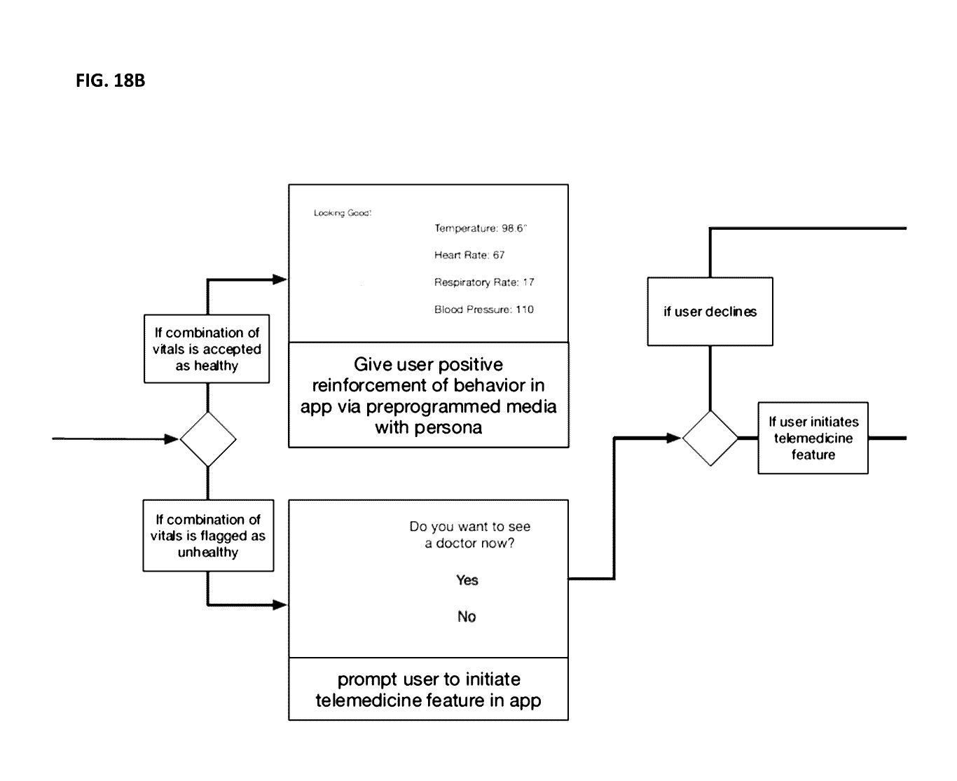

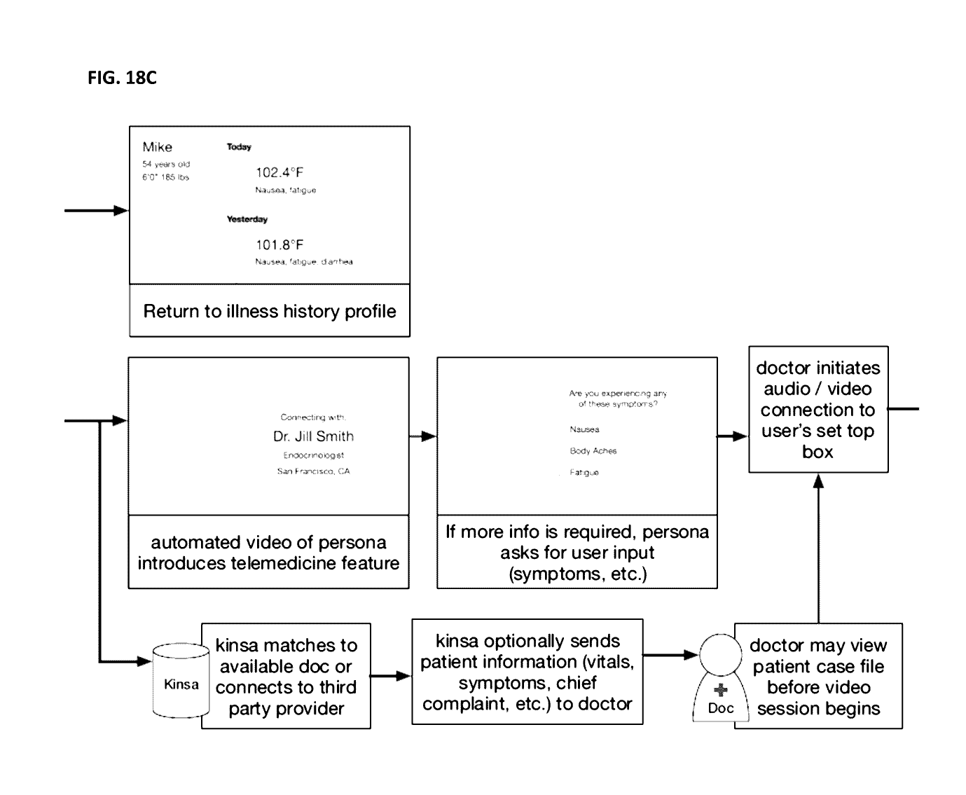

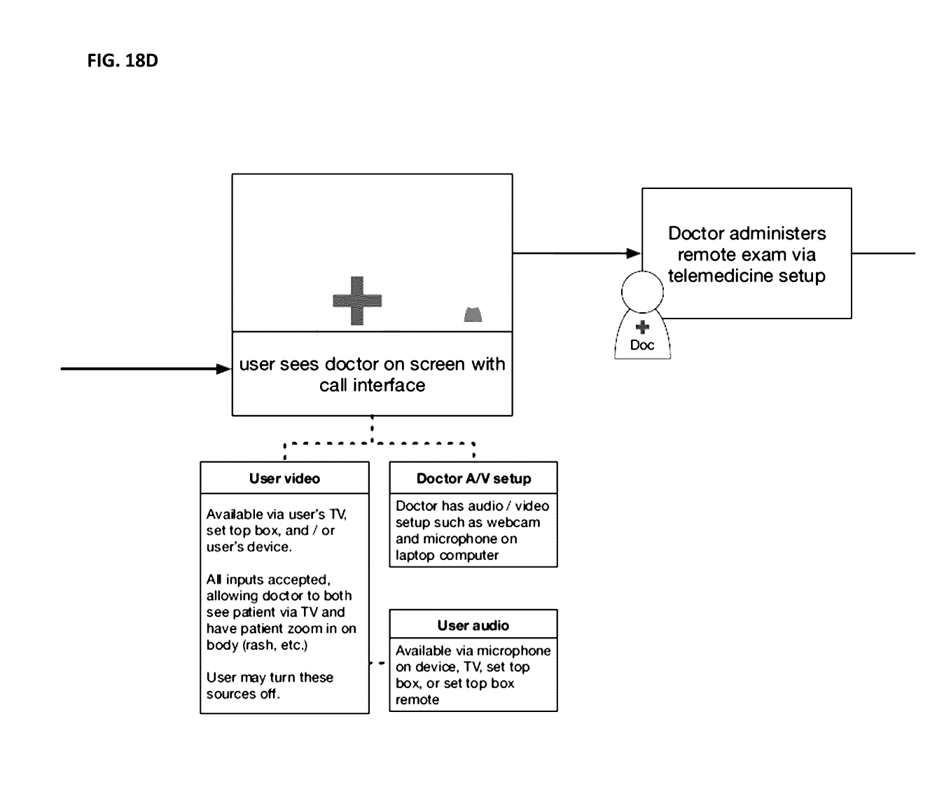

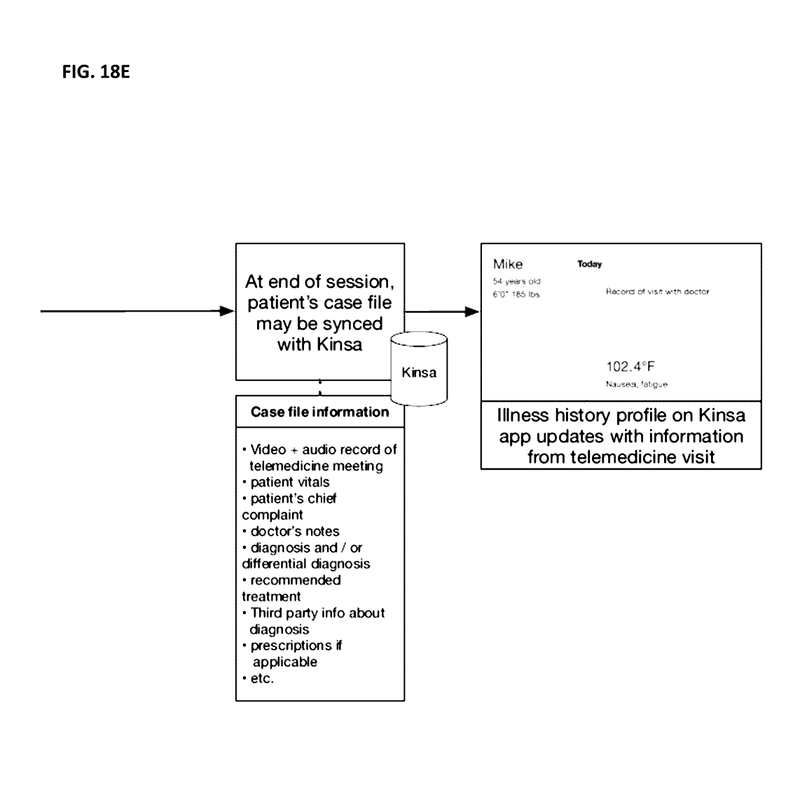

FIGS. 18A through E display another example implementation of routine 800, similar to that of FIGS. 17A through E. Specifically, in FIGS. 18A through E, the routine 800, and in particular the telemedicine session, is initiated using a computing device 105 such as a digital media player or set top box operatively connected to the user's television. In this example implementation, the computing device 105 can include but is not limited to, Apple TV, Amazon Fire TV, Amazon Fire Stick, Google Nexus Player, Google Chromecast, a PlayStation console, Roku stick, Roku streaming player, an Xbox console, and a Smart/Connected TV (FIG. 18A).

As shown in FIG. 18A, the user launches the telemedicine application 160 on set top box (step S802) and then syncs health-related information 205 (e.g., medical measurements 215) from the one or more connected health devices 305 to the telemedicine application 160 via a wireless or wired sync method (step S804). The health-related information 205 is then stored (“data writes to application”) to the data repository 180 (step S806). The synced health-related information is analyzed (“processes combination of vitals”) to determine whether the health-related information indicates that the user is healthy or not (step S808). Turning to FIG. 18B, if the health-related information indicates that the user is healthy, then the telemedicine application displays a prompt providing positive reinforcement and optionally displays the user's health-related information (step S810). If the health-related information indicates that the user is unhealthy, however, the telemedicine application displays a prompt asking the user whether he or she wants to initiate a telemedicine feature in the application (step S812). If the user declines to initiate the telemedicine feature, the telemedicine application can navigate the user back to his or her illness profile (step S810), as shown at FIG. 18C.

If, however, the user initiates the telemedicine feature, then as shown in FIG. 18C, the telemedicine application displays an automated video of an animated person speaking to the user and introducing the telemedicine feature (step S814). With continued reference to FIG. 18C, if additional information from the user is required, the application can display the animated person asking the user for additional input, such as “are you experiencing any of these symptoms?[nausea, body aches, fatigue]”. After introducing the telemedicine application, the telemedicine application then displays the healthcare provider (“Dr. Jill Smith”) that was matched to the user based on the synced health-related information (step S816). The application can optionally send the user's health-related information (e.g., temperature measurements, symptoms), which may comprise geographic or social based health-related information, to the matched healthcare provider so that the provider can review the information, which in accordance with some embodiments may be conducted prior to initiation of the telemedicine session.

With reference to FIG. 18D, once the telemedicine session has been initiated, the user can see the doctor on-screen with the call interface, and the doctor can see the user on-screen. In this example, the user is using a set top box via TV and the doctor is using a laptop computer to conduct the telemedicine session, both of which have audio and video capabilities. During the telemedicine session, Dr. Smith can administer a remote exam of the user. Furthermore, the user can navigate away from the video component to view his or her illness history profile during the telemedicine session without disconnecting from the session. Once the user is done with the illness history profile, he or she returns to the video screen showing the doctor.

With reference to FIG. 18E, the telemedicine session can be terminated (step S820), at which point the user's case file of information from the telemedicine session (e.g., recording of the session, user's health-related information, doctor's notes, diagnoses, recommended treatment, etc.) can be synced to the telemedicine application (step S822) and stored to the data repository of the user's computing device (step 824), and the illness history profile of the user can be updated based on the synced and stored information.

In accordance with a further aspect of the present application, systems and methods for operations of the telemedicine application via a computing device is described below. In accordance with one or more embodiments, the processor 110, executing one or more software modules 130, can configure computing device 105 to run telemedicine application 160. In one or more implementations, the telemedicine application 160 allows the user to navigate through several different screens in response to user actions (e.g., use of a connected health device 305, responding to a prompt generated by the application), actions by computing device 105 (e.g., generation of a prompt) and/or actions by a provider computing device (e.g., syncing of provider information).

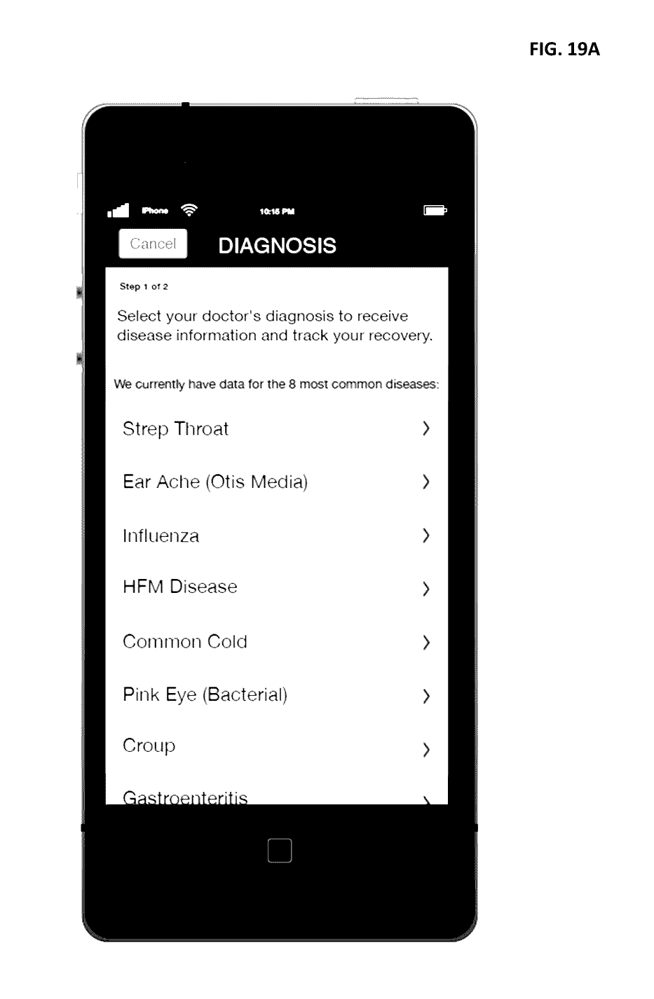

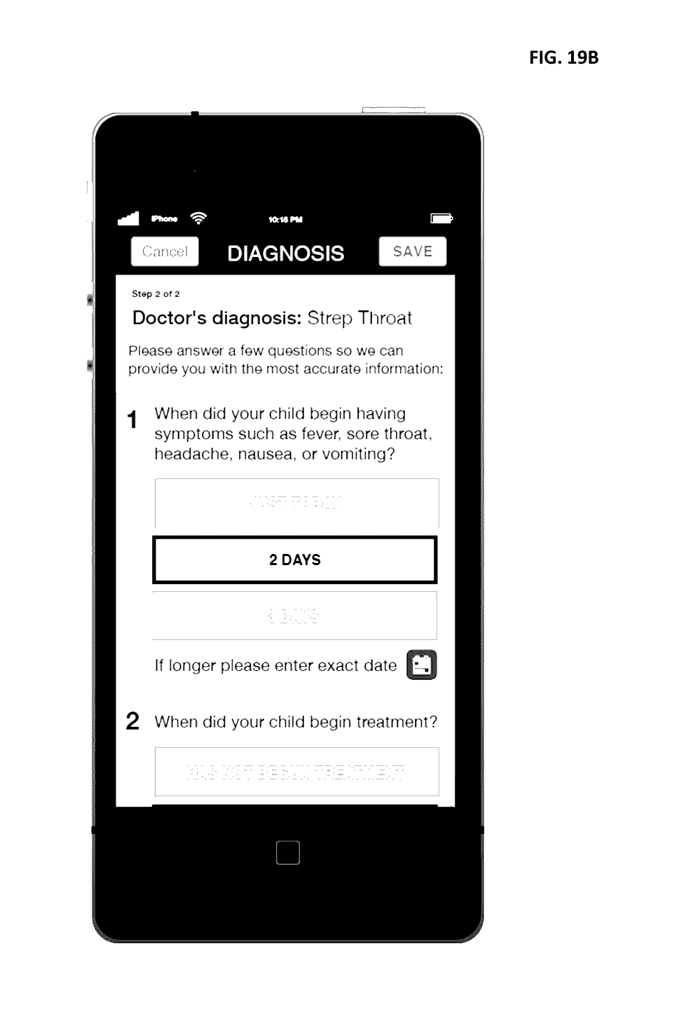

For example, following a telemedicine session with a healthcare provider, a user can navigate to a “Diagnosis” screen, where the user can select the provider's (e.g., doctor's) diagnosis of the patient to receive disease information and track the patient's recovery (FIG. 19A). The application can also add such information to a health timeline for the user, which is a data presentation format well known to those of ordinary skill in the art. As shown in FIG. 19B, after clicking on the doctor's diagnosis (here, strep throat), the user can be prompted with one or more questions to provide the user with addition information regarding the treatment and recovery of the patient. In this example, the prompt asks the user how long the patient (child) has been experiencing symptoms related to strep throat and when did the patient begin treatment.

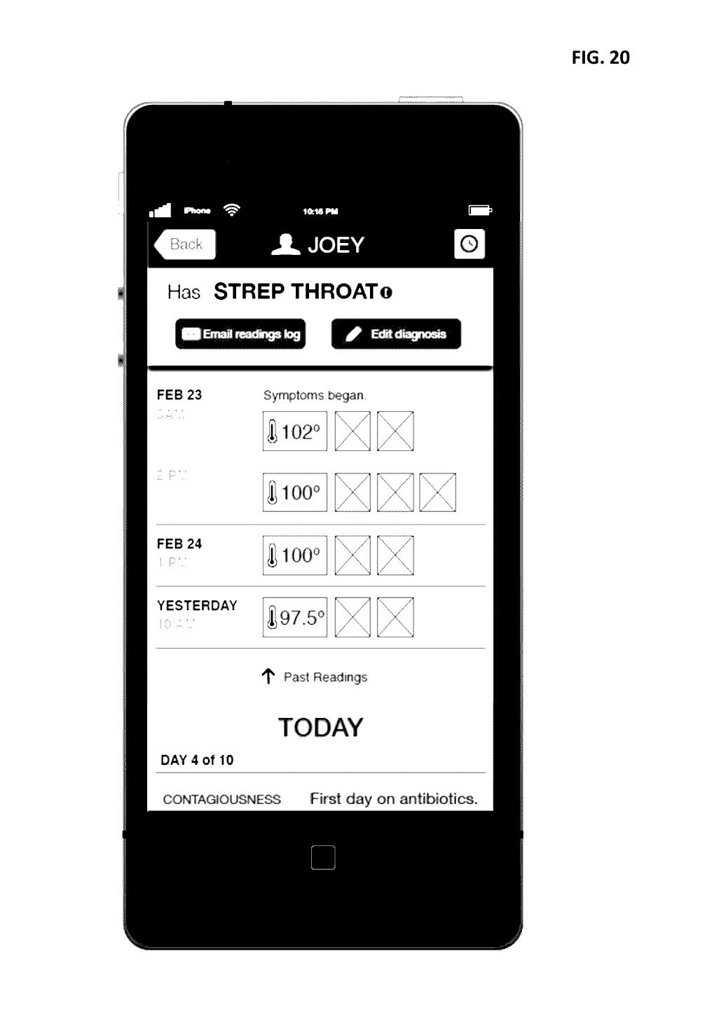

In a further example, as shown at FIG. 20, a user who has already selected the provider's diagnosis can navigate to a screen in which the telemedicine application displays the patient's past health-related information, such as medical measurements or contagiousness. More specifically, at FIG. 20, the screen displays the past temperature measurements of the patient (Joey).

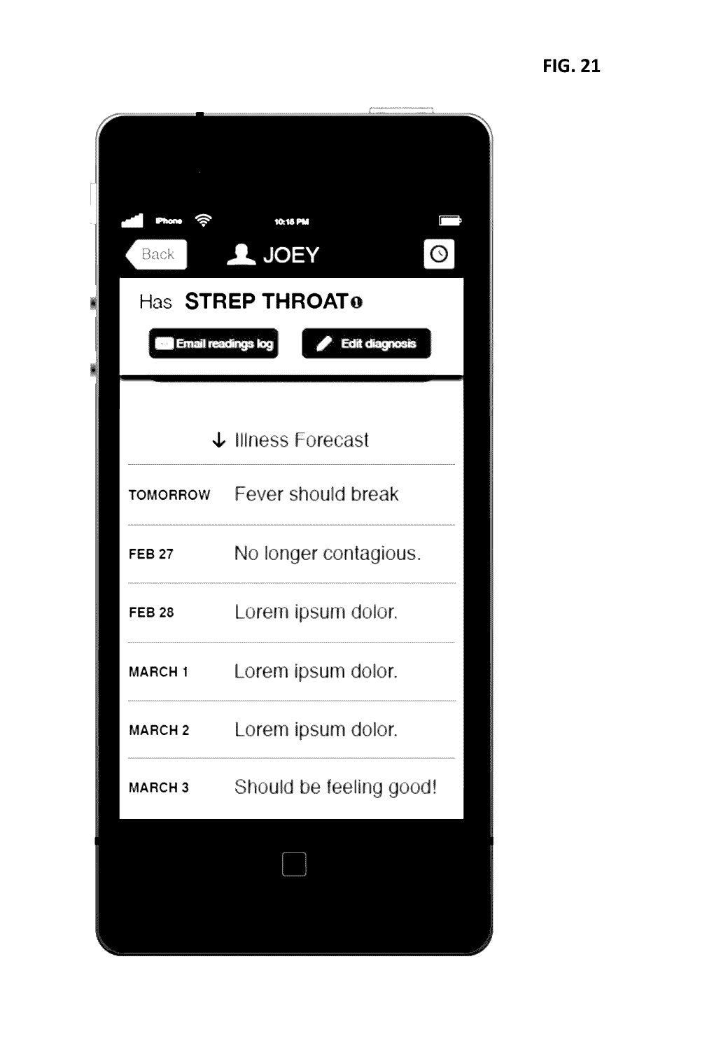

In another example, as shown at FIG. 21, a user who has already selected the provider's diagnosis can navigate to a screen in which the telemedicine application displays the patient's illness forecast. The term “illness forecast” as used herein refers generally to providing a user or patient with information as to the prognosis of a given illness. For example, illness forecast may comprise information including, but not limited to, contagiousness over one or more periods of time, general energy levels from a point in time, symptomology, as well as alerts, which comprise potentially dangerous co-occurring conditions that the user or patient should be particularly vigilant in identifying. As shown at FIG. 21, the illness forecast for the patient (Joey) shows that his fever should break tomorrow, and that he should no longer be contagious by the next day. Such illness forecast can be dynamically updated in response to new or changing information, e.g., in response to symptom changes or persistence over a period of time, which can prompt the user to take further action, e.g., re-initiate contact with the treating physician.

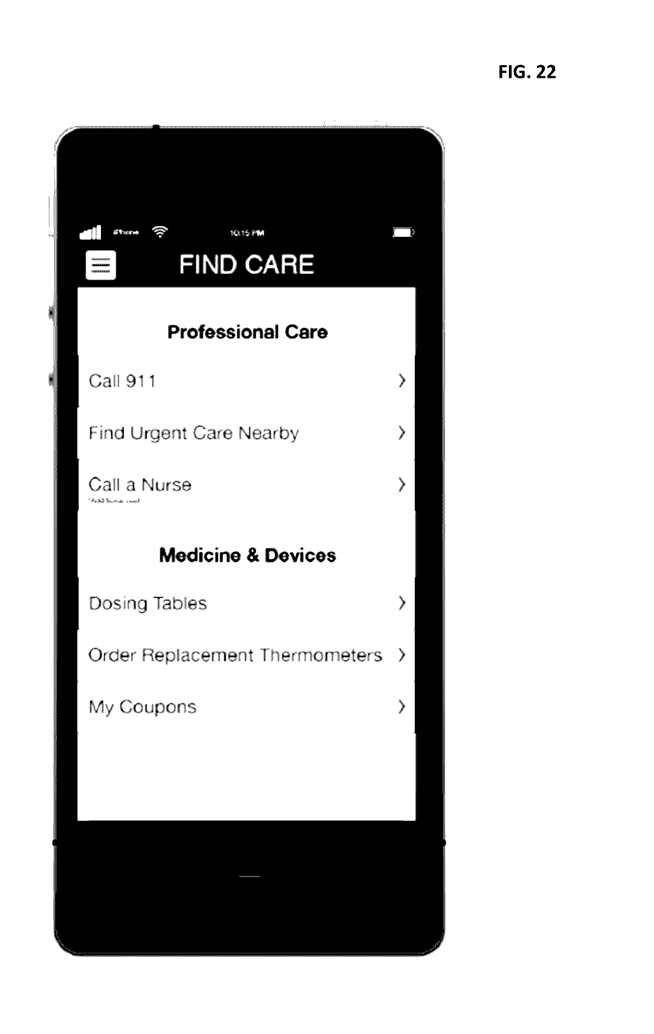

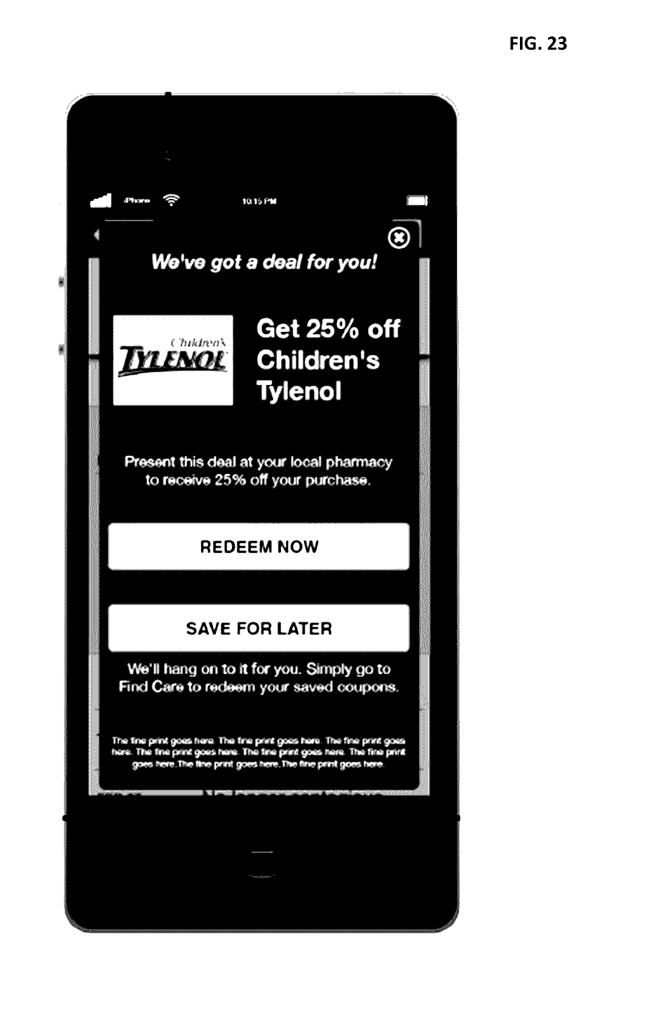

The user can navigate through numerous screens within the telemedicine application. In certain implementations, certain screens may be available for navigation to only after a particular user action, or action by computing device 105 or a provider computing device. Additional example screens within the telemedicine application are shown at FIGS. 22 and 23. In particular, FIG. 22 shows a “Find Care” screen in which the user can select from several options for receiving professional care including “call 911”, “find urgent care nearby”, and “call a nurse.” The user can also select from several options regarding medications and devices, for example dosing tables, medication reminders, an option for ordering replacement thermometers, coupons, etc. Alternatively, or in conjunction with the foregoing, the user may input medication and dosage reminders into the telemedicine application. The telemedicine application reminds the user by setting an alarm, placing an entry on their calendar, sending an email, text or push notification in advance of (if programmed by the user) or when he or she needs to take the next medicine dose. The telemedicine application according to certain embodiments also provide dosing guidance for common medications, including fever reducing medicines, and medicines associated with common related symptoms (like cough, runny nose, nausea, etc.). FIG. 23 shows an example screen of a coupon, which can be navigated to using the “Find Care” screen.

In accordance with a further aspect of the present application, a system for calling a healthcare provider via the telemedicine application is described below.

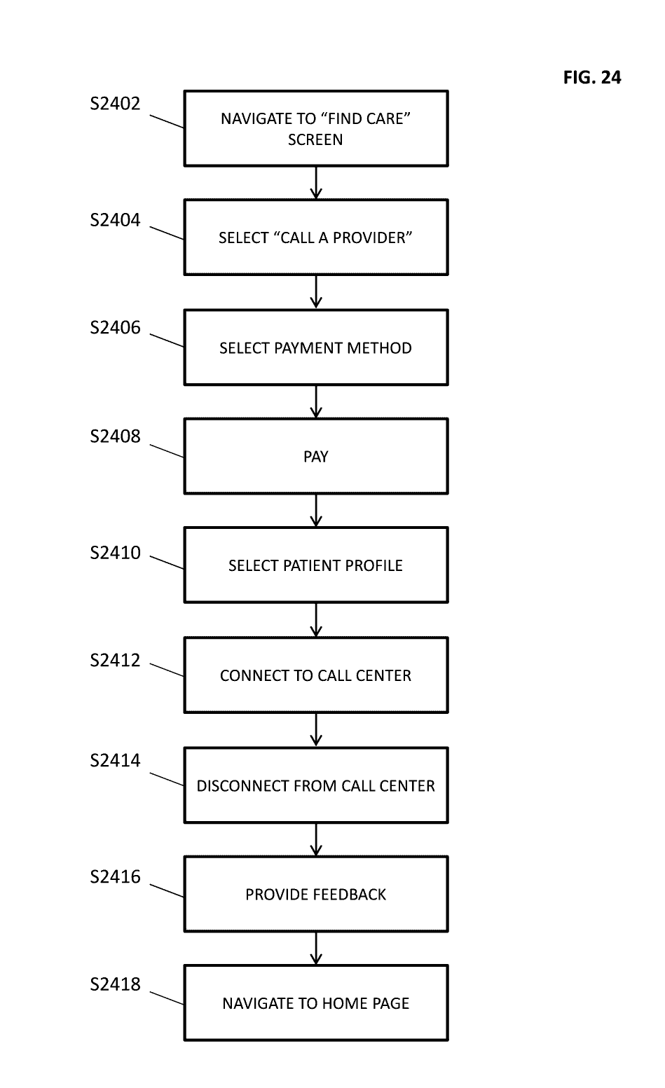

With reference to FIG. 24, the process for calling a healthcare provider via the telemedicine application (routine 2400) begins at step S2402, where processor 110 executing one or more software modules 130 (in particular, telemedicine application 160), configures computing device 105 to navigate to the “Find Care” screen, an example embodiment of which is illustrated by FIG. 22. In one or more embodiments, the user can navigate to the “Find Care” screen from a home screen of the telemedicine application 160. In at least one embodiment, the user can only navigate to the “Find Care” screen once the user has synced and stored health-related information to data repository 180.

At step S2404, the processor 110 executing one or more software modules 130 (in particular, telemedicine application 160), configures computing device 105 to select the “call a provider” option. For instance, the user can select “Call a Nurse” from the “Professional Care” menu of the “Find Care” screen. In one or more implementations, the provider can be any type of healthcare provider, such as a physician, physician's assistant, a nurse, or a nurse practitioner.

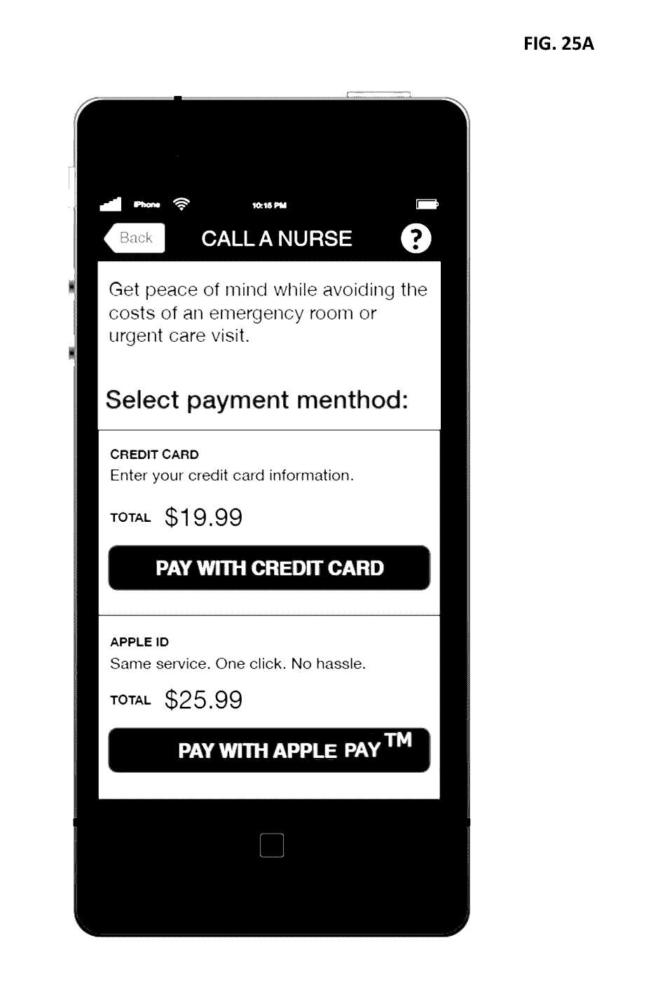

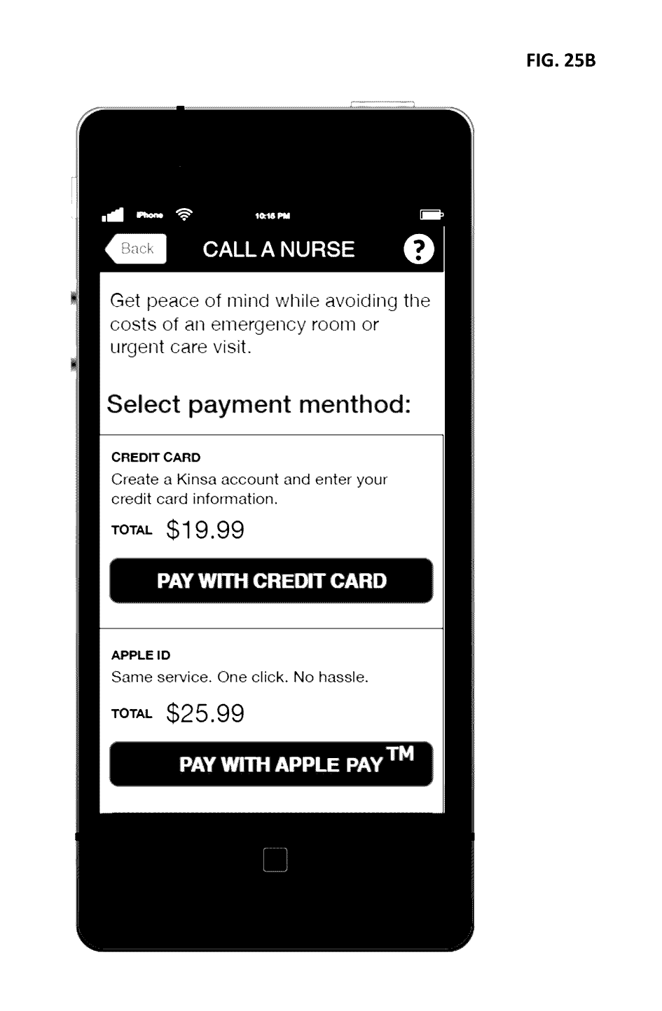

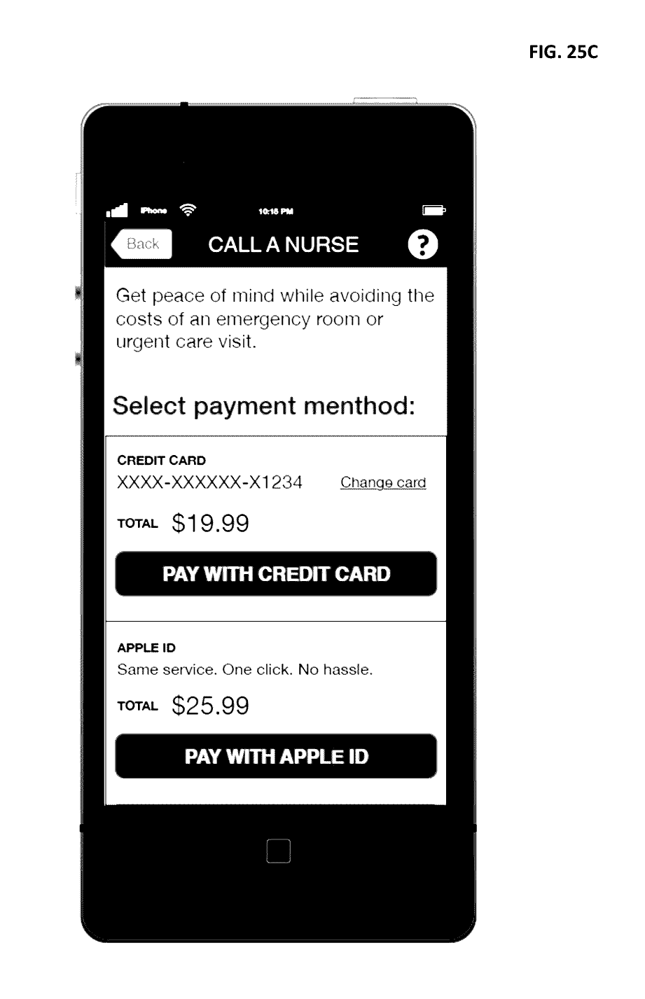

Next, at step S2406, the processor 110 executing one or more software modules 130 (in particular, telemedicine application 160), configures computing device 105 to select a payment method. In one or more embodiments, such as that shown by FIG. 22, the “call a provider” (e.g., “call a nurse”) function of the telemedicine application 160 requires an additional cost. As such, the user can be directed to a screen in which the user must select a payment method once the user has selected the “call a provider” option. In one or more embodiments, the “select a payment method” screen can provide several different options for payment. For example, in FIGS. 25A and B, the user has an option to pay by credit card or to pay using a mobile computing device-enabled payment method (e.g., Apple Pay). FIG. 25A shows an example screen in which the user has already logged into his or her account in the telemedicine application, and as such, the user is able to enter his or her credit card information. In contrast, FIG. 25B shows an example screen in which the user has not logged into his or her account in the telemedicine application, and thus the user is prompted to create a user account in order to enter the credit card information. FIG. 25C shows another example screen for the selection of payment, in which the user's credit card information has already been saved to the telemedicine application. It should be understood that in one or more implementations, other online payment methods may be available for selection.

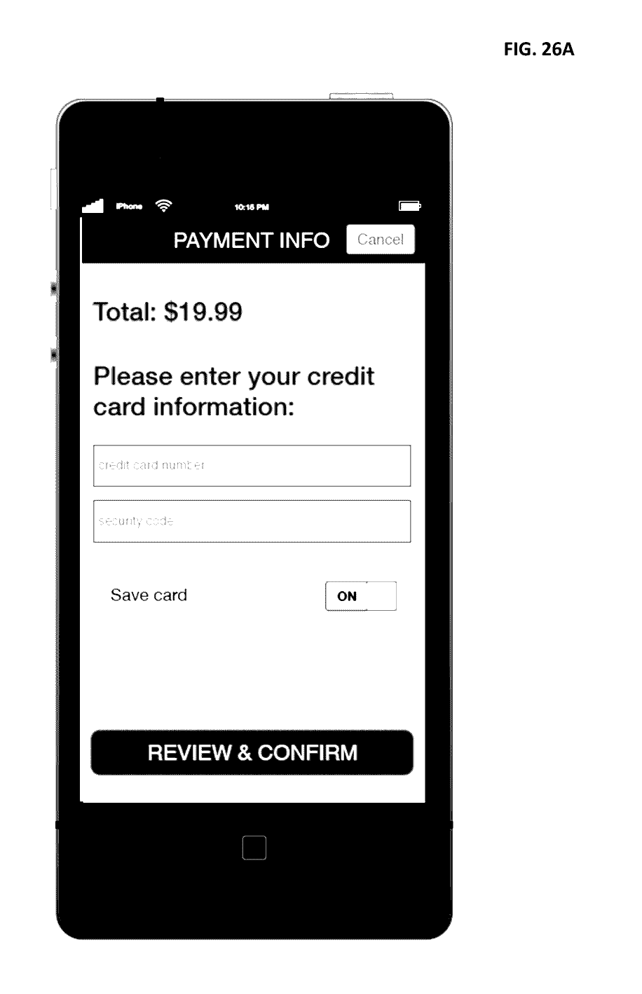

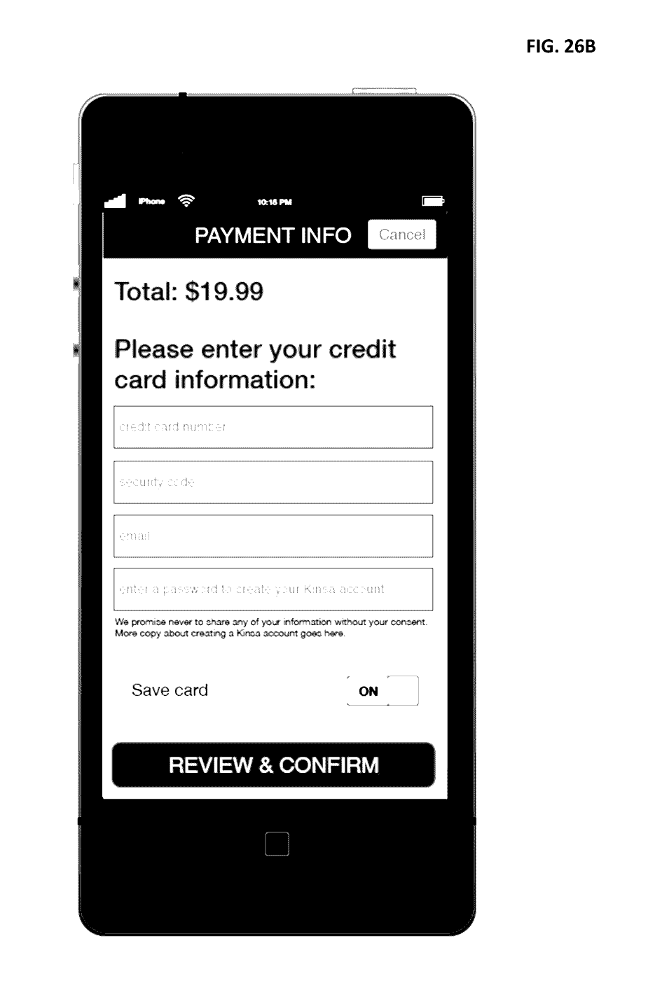

At step S2408, the processor 110 executing one or more software modules 130 (in particular, telemedicine application 160), configures computing device 105 to complete payment for the call to the provider. An example payment screen is shown at FIGS. 26A and B. In this example, the user has selected to pay by credit card, and at this screen the user must enter his or her credit card information. In one or more implementations, the user can have the option of saving the credit card information in the telemedicine application 160 for future use. FIG. 26A shows an example payment screen in which the user has logged in, and as such only needs to input the credit card information before completing payment. FIG. 26B, however, shows an example payment screen in which the user has not logged in, and thus the user must input both the user's credit card information, but also the user's email and a password in order to create a new account (or log into an existing account) and subsequently complete payment. It should be understood that in at least one implementation, the user is not required to log in in order to complete payment.

Also shown in FIGS. 26A and B, and in accordance with one or more embodiments, after the user inputs the credit card information (and, optionally, the user account information), the user can click “review and confirm” in order to complete payment. In certain implementations, the user can then be directed to another screen in which the user can review the purchase and credit card information prior to completing the purchase. In at least one implementation, the user can complete the purchase on the same screen in which the user enters his or her credit card information.

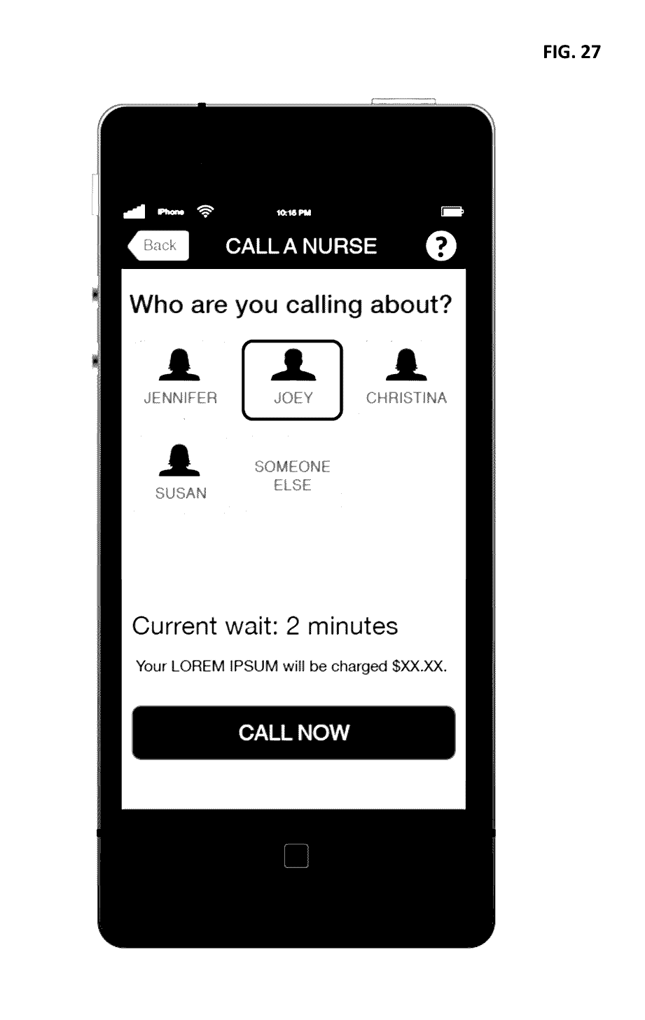

Returning to FIG. 24, at step S2410, the processor 110 executing one or more software modules 130 (in particular, telemedicine application 160), configures computing device 105 to select a patient profile prior to calling the provider. In one or more embodiments, a user can create one or more patient profiles for use with the telemedicine application 160. For example, a parent can create user profiles for his or her child or children, as well as his or her spouse. FIG. 27 shows an example screen for the selection of a patient profile. In this example, the user has at least 4 different patient profiles linked to the user. Additionally, the screen provides an option for selecting a different patient profile than the linked (saved) patient profiles (“someone else”). In this embodiment, selecting “someone else” would enable the user to find another patient profile linked to the user (if applicable) or alternatively create a new patient profile. Further, as shown in FIG. 27, the screen for selecting a patient profile can optionally show the current wait time to speak with a provider and/or how much the user will be charged for the call.

At step S2412, the processor 110 executing one or more software modules 130 (in particular, telemedicine application 160), configures computing device 105 to connect to the call center, which may be provided as part of provisioning telemedicine services to a user. As shown at FIG. 27, once the user has selected a patient profile (in this example, “Joey”) a user can click on the “call now” option to connect to the call center for connection to the provider. In the implementation shown in FIG. 27, the “call now” option is presented on the same screen as where the user selects the patient profile; however, in one or more implementations, the user can be navigated to another screen following the selection of the patient profile in order to connect to the call center. After connection to the call center, the user's call is connected to the provider, where the user and the provider can discuss the next steps for diagnosis, treatment, follow-up, and/or recovery of the patient.

At step S2414, the processor 110 executing one or more software modules 130 (in particular, telemedicine application 160), configures computing device 105 to disconnect from the call center. In at least one embodiment, the provider device (e.g., telephone, computing device) can also be configured to disconnect from the call. It should also be understood that in at least one embodiment, the steps of S2406 (selecting a payment method) and S2408 (completing payment for the call) can occur after disconnecting from the call to the provider.

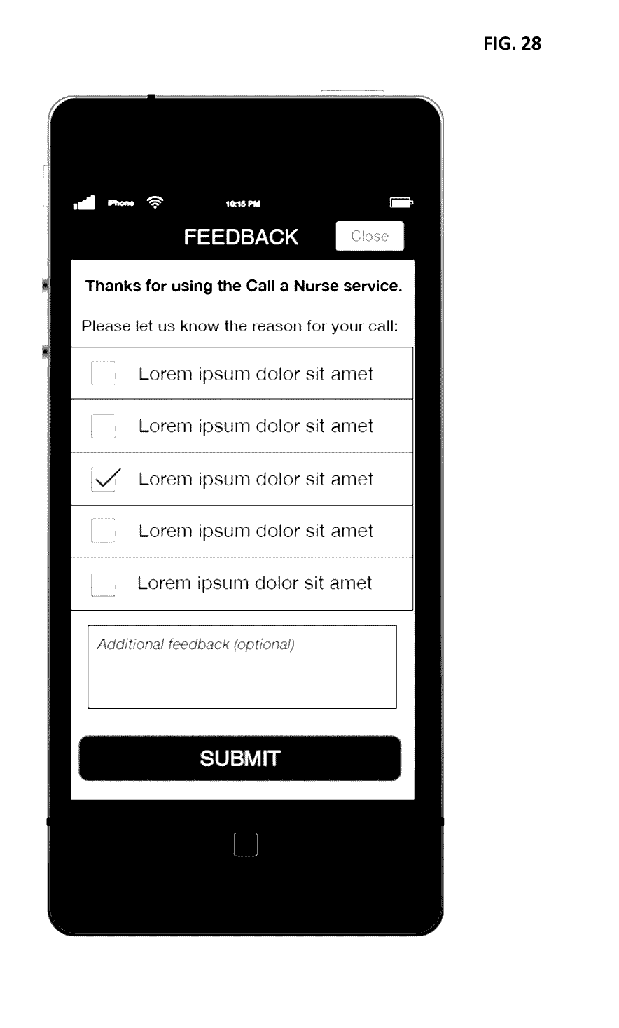

At step S2416, the processor 110 executing one or more software modules 130 (in particular, telemedicine application 160), configures computing device 105 to provide feedback to the telemedicine application 160 regarding the call to the provider. An example screen for providing feedback to the telemedicine application is shown at FIG. 28. In one or more embodiments, the user can select from prearranged options regarding the call to the provider, such as a prompts that ask the user to rate the provider on a scale (e.g., 1 to 5) or rate the advice given by the provider. Alternatively, or in conjunction with the foregoing, the user can provider their own text responses to feedback prompts. In at least one embodiment, the feedback screen can provide both prearranged options for responses to one or more feedback prompts and options for a user's own text responses to one or more feedback prompts, as shown at FIG. 28.

Finally, at step S2418, the processor 110 executing one or more software modules 130 (in particular, telemedicine application 160), configures computing device 105 to navigate the user back to the home screen of the telemedicine application. In one or more embodiments, the user automatically navigates back to the home screen following submission of the feedback. Alternatively, after feedback has been provided by the user, the user can receive a prompt asking the user whether the user would like to return to the home page, or whether the user would like to close the application, for example.

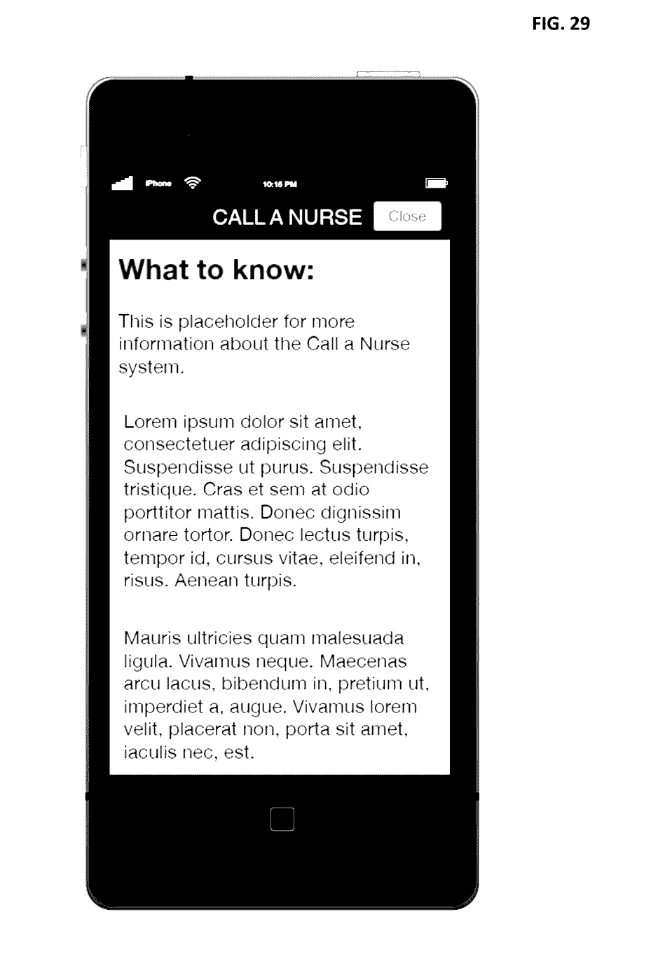

Additionally, in accordance with one or more embodiments, a user can navigate to a screen that provides additional information to the user about the “call a provider” process. An example screen for providing additional information about the “call a provider” process is shown at FIG. 29. In one or more implementations, the informational screen about the “call a provider” process can be navigated to by the user via the home screen of the telemedicine application 160.

In accordance with a further aspect of the present application, a system for a temperature sensing device or thermometer (connected health device) and the computing device 105 is described below.

### Providing a Thermometer to a User

In accordance with one or more implementations, a connected health device is provided to a user. The connected health device includes an interface to a computing device (such as a smartphone) and software for the computing device to record health care data about a patient. The user may be a patient or the patent's caregiver.

As can be appreciated by a person having ordinary skill in the art, the connected health device is a genus that includes many species such as a thermometer (as described in detail herein), infrared thermometer, electronic thermometer, digital thermometer, mercury thermometer, thermometer modified to additionally measure heart rate, blood pressure gauge, pulse oximeter (such as the kind that clip on to a patient's finger), heart rate measurement device, weight scale, BMI meter and/or other devices used to measure body or clinically relevant characteristics, or combinations of the aforementioned devices. As such, the thermometer described further below is just one example of a connected health device used in the system described herein. A unique aspect of the thermometer embodiment is that it provides highly social data (data on communicable illnesses, or alternatively noncommunicable illnesses that can spread fast from a common source (such as diarrheal disease from bad water)), whereas other devices do not provide similarly highly social data. For example, individuals may care that others in their building or local area have febrile illness (as indicated by a thermometer reading) since they may also get this illness, either from others or from a similar source. Similarly, connected health devices such as those described herein provide social data with regard to non-communicable diseases and disorders as research concludes that the peer group or social network of a patient has a significant influence on (or acts as a predictor of) the probability of acquiring a number of non-communicable conditions, such as heart disease, high blood pressure (which is indicated in part from a blood pressure gauge), obesity, diabetes, etc. despite the fact that such diseases are not communicable.

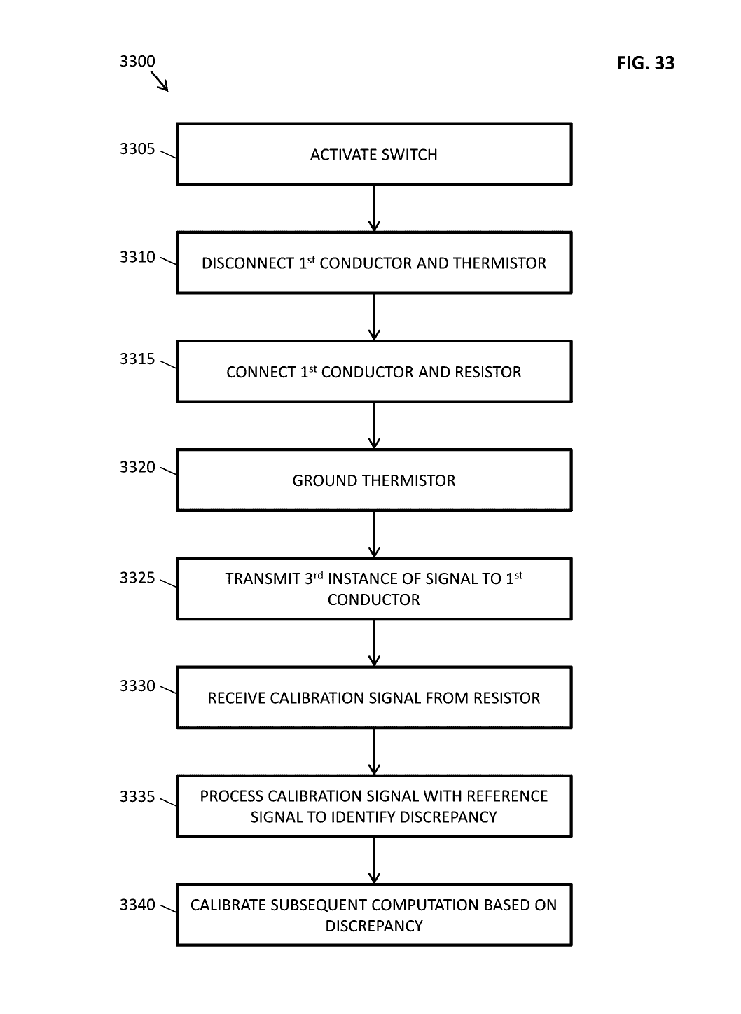

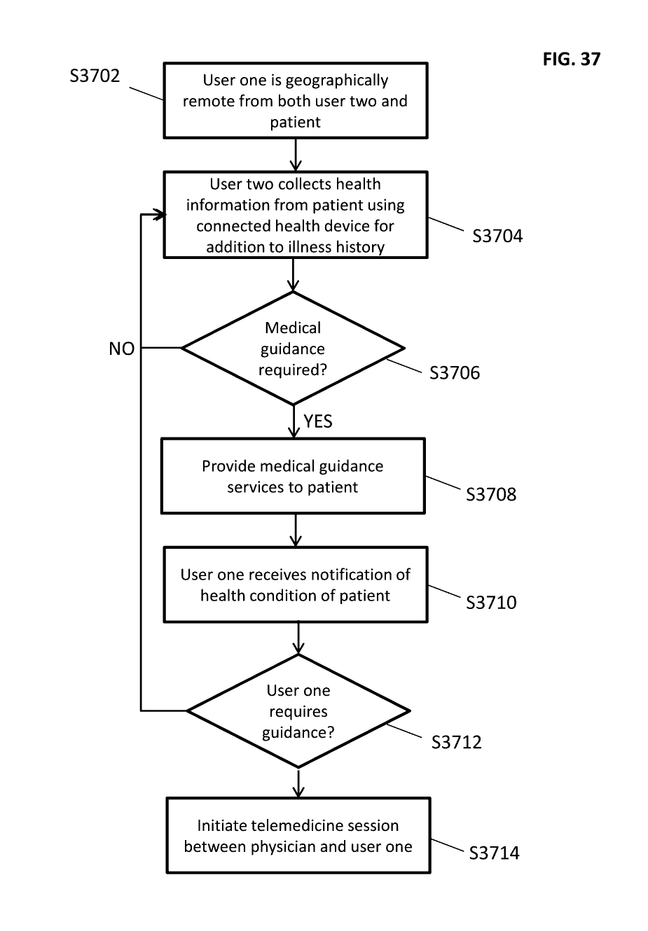

In one embodiment, the thermometer subsystem has the following product specifications:
0.2 inches (H)×0.6 inches (W)×5.2 inches.
iOS and Android compatible.
Includes case and optional extension cord (see FIG. 33 and FIG. 37).
Thin and highly flexible for comfort.
No battery.
No processor.
No LCD.

In accordance with at least one implementation, a low cost, smartphone-connected analog or digital thermometer is provided to a user. This device, such as those described herein, for example, collects and transmits health care data (including symptom data and location data) on fever, an important and early indicator of many communicable illnesses. It also collects other symptom data and related location data (e.g., frequently visited locations) through additional technology. Using this additional technology (e.g., audio-based communication technologies and protocols to facilitate extremely low hardware-mobile computing device connectivity), price points are achieved that are a fraction of current digital thermometers, thereby enabling mass adoption. In accordance with one or more embodiments, a thermometer subsystem is further described as follows.

In one embodiment, a temperature-sensing probe having a thermistor and a resistor is configured for input into the headphone jack of a computing device such as a smartphone (such as an IPHONE) or other mobile, network-connected device, e.g., a IPAD, GOOGLE GLASS, etc. Signals such as audio tones are transmitted to the computing device through the headphone jack to conductors of the probe, such as a connector that is coupled to the thermistor. The thermistor and resistor can also be configured for use with inputs of a computing device other than a headphone jack. For example, the temperature sensing probe may be communicatively coupled via an intermediary audio codec (including, but not limited to, one or more of an analog-to-digital converter and digital-to-analog converter) to a digital data input of the computing device, such as a USB or Lighting port, whereby the probe coverts audio tones to digital data for receipt and processing by the computing device. Alternatively, or in conjunction with the foregoing, the various signals that are returned from the probe are used to compute a measured temperature sensed at the probe. In certain implementations, the probe is configured as an oral thermometer, though it should be understood that the systems, methods, and apparatuses described herein can be similarly configured as other types of thermometers (including, but not limited to, under-arm thermometers, forehead thermometers, ear thermometers, temporal artery thermometers, continuous patch thermometers, rectal thermometers, etc.), as can be appreciated by those of ordinary skill in the art. In one embodiment, the thermometer is bundled with an accompanying software application on the smartphone. This software operates the thermometer and provides additional software features to the user. These additional features enable the user to get more value than simply a temperature readout, as described herein, and simultaneously, and as described herein, collect more data than simply temperature/fever data.

In addition to being configured as an oral thermometer, the temperature sensing probe or device, e.g., communicatively coupled thermometer or connected health device, may comprise an infrared ear, forehead or temporal thermometer, a mercury based thermometer (either oral or rectal), a flexible patch thermometer for continuous body temperature measurement, smartwatch based temperature sensors, etc. All such probes or devices may be in communication with external devices via wired, wireless or network integrated communication connections, as well as combinations thereof.

With regard to in ear infrared sensor thermometers, such devices typically comprise a heat sink, thermopile sensor and thermistor, which are in communication with circuitry specifically programmed to determine temperature on the basis of input from such components. For example, such temperature determination circuitry can take a number of measurements for storage in a moving time window, which the circuitry averages in the moving window to determine whether the average has stabilized, outputting an average temperature. Forehead infrared, by contrast, may utilize a Fresnel lens that is provided as part of a probe and intended to focus an incoming infrared temperature signal emitted from an area on the forehead of the patient to an infrared sensor connected with an electronic circuit. A lamp connected to the circuit juxtaposed in the probe with the sensor projects light parallel to a longitudinal axis of the Fresnel lens and the sensor to optically aiming the area on the forehead to quickly measure a patient's body temperature. Other modalities of temperature capture considered as falling within the scope of various embodiments of the invention, such a temporal and flexible patch thermometers, are understood and well known by those of ordinary skill in the art.

The thermometer is selected as the connected health device, since thermometers are one of the most ubiquitous connected health devices in the world, present in most households, and since thermometers are often the first device used by people in their homes to confirm common illnesses. The use of a thermometer can itself be indicative of a patient feeling ill, even if no fever is present. Additionally, thermometers are often used to monitor illnesses over the course of an illness episode or treatment course in the home. For these reasons, the smartphone-connected thermometer allows the provider of the system to begin communicating with people from the beginning of an illness episode, before they have seen or communicated with a doctor or nurse, and during the course of an illness, collecting data on fever, symptoms, illnesses and other related data.

In yet another feature, not shown here, the provider of the system bundles a symptom checker application with the software accompanying the smartphone-connected thermometer. Symptom checker functionality is included in some web or mobile software applications today, including from WebMD and PediatricSymptomMD. These features provide information to the user about the type of illness they may have based on their symptoms. In the context here, bundling this software allows the provider of the system to gather additional geo-located data about the illness or symptoms in question to enhance the mobile enabled health system described herein.

Collecting Health Care Data about a Patient

The thermometer, and the accompanying software application bundled with the thermometer, allows health care data to be collected about a patient. For privacy and security reasons, this health care data can be anonymized, which according to some embodiments can be accomplished via aggregation, to ensure de-identification of and prevent the unauthorized access to personally identifiable information (PII) using known data obfuscation and encryption means.

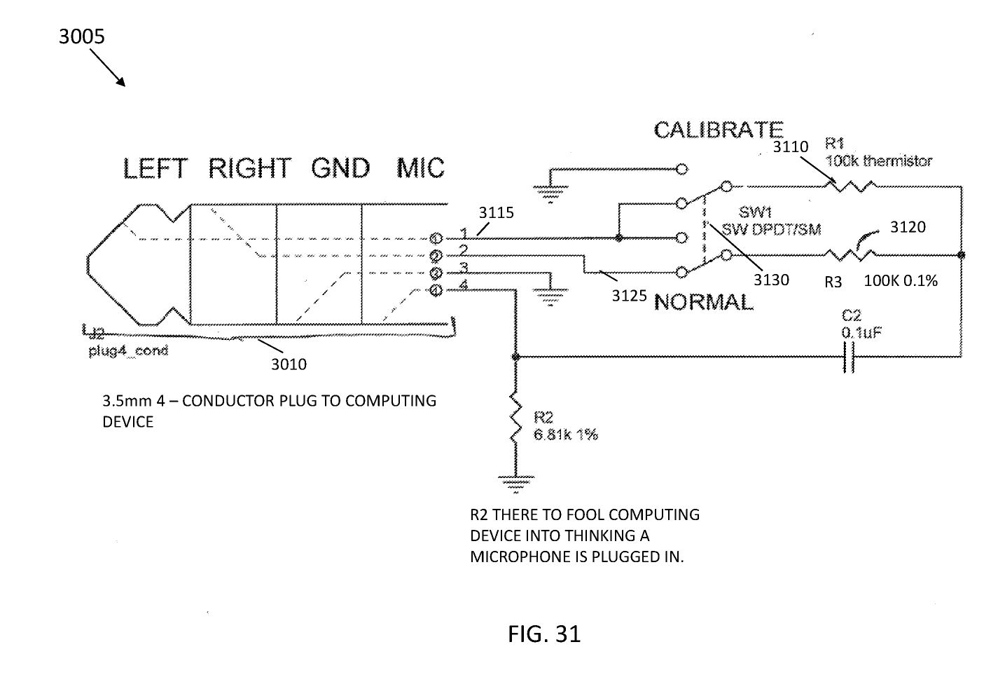

Referring now to FIG. 30A, an example temperature measurement subsystem 3000 is shown. In one implementation, temperature measurement subsystem 3000 includes a computing device 105, such as a smartphone or PDA. Temperature measurement subsystem 3000 also preferably includes a temperature-sensing probe 3005 (connected health device 305). Temperature-sensing probe 3005 is illustrated and described in greater detail with respect to FIG. 31. It should be understood, as illustrated in FIG. 30A, that temperature-sensing probe 3005 includes a projecting connector/plug 3010, such as a (three-contact) TRS or (four-contact) TRRS connector, as are known to those of ordinary skill in the art. In one or more implementations, temperature-sensing probe 3005 is constructed such that the connector 3010 is inserted into an input/output cavity 115 of computing device 105, such as a headphone jack (TRS/TRRS input), as shown in FIG. 30A and as is known to those of ordinary skill in the art. A further illustration of input cavity 115 is shown in FIG. 30B. In one or more implementations, the temperature-sensing probe 3005 can also connect to computing device 105 in a wireless fashion, such as via Bluetooth, as is described in further detail below.

Turning now to FIG. 31, a schematic diagram is provided showing a detailed internal view of temperature-sensing probe 3005. As referenced above, in certain implementations, temperature-sensing probe 3005 can include a projecting connector/plug 3010, such as a TRS or TRRS connector, as are known to those of ordinary skill in the art. Temperature-sensing probe 3005 also preferably includes a thermistor 3110 and a resistor 3120. Thermistor 3110 is operatively connected to a conductor 3115 that extends to a particular area or region of connector 3010. It should be understood that thermistor 3110 preferably changes resistance according to temperature, as is known to those of ordinary skill in the art. Thermistor 3110 can be a standard type thermistor used in digital oral thermometers, such as those that have a +/−0.1 C tolerance. Resistor 3120 is operatively connected to another conductor 3125 that extends to another area or region of connector 3010. FIG. 31 further depicts an example configuration of the areas of connector 3010 and the various connectors that are associated with each area. For example, it can be appreciated that conductor 3115 extends to the ‘LEFT’ area of connector 3010 (corresponding to the left stereo headphone channel) while conductor 3125 extends to the ‘RIGHT area of connector 3010 (corresponding to the right stereo headphone channel). As is described in greater detail herein, by transmitting and receiving signals through the various conductors 3115, 3125, computing device 105 can compute a measured temperature sensed at probe 3005.

In certain implementations, temperature-sensing probe 3005 also includes a switch 3130. Upon activation of the switch 3130, the conductor 3115 can be disconnected from thermistor 3110, and connected to resistor 3120. Additionally, in certain implementations, activation of the switch 3130 serves to ground thermistor 3110, in a manner known to those of ordinary skill in the art.

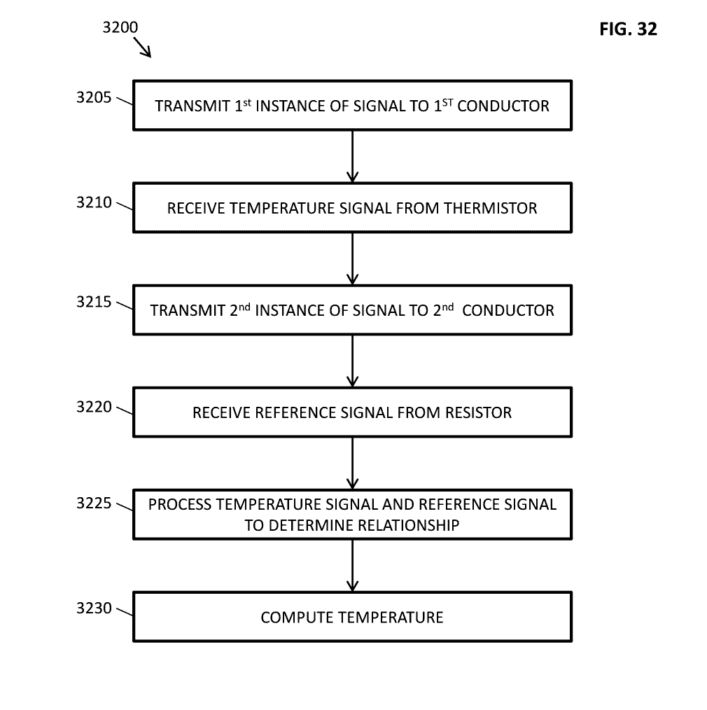

The operation of the temperature measurement subsystem 3000 and the various elements and components described above will be further appreciated with reference to the methods described below, in conjunction with FIGS. 32 and 33.

Turning now to FIG. 32, a flow diagram is described showing a routine 3200 that illustrates a broad aspect of a method for measuring temperature in accordance with at least one embodiment disclosed herein. It should be appreciated that several of the logical operations described herein are implemented (1) as a sequence of computer implemented acts or program modules running on computing device 105 and/or (2) as interconnected machine logic circuits or circuit modules within computing device 105. The implementation is a matter of choice dependent on the requirements of the device (e.g., size, energy, consumption, performance, etc.). Accordingly, the logical operations described herein are referred to variously as operations, steps, structural devices, acts, or modules. As referenced above, various of these operations, steps, structural devices, acts, and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 3205 with processor 110 executing one or more of software modules 130, which can include temperature determination application 164 and/or calibration application 168, configures computing device 105 to transmit a first instance of a first signal to conductor 3115. It should be understood that in certain implementations, the referenced first signal (and various other signals referenced herein) can be an audio tone (such as a 1 kHz tone). It should be further understood that the signal can be output through a specific output of headphone jack 115, such as the left headphone output, as is known to those of ordinary skill in the art. In doing so, the tone can be received by conductor 3115 at connector 3010 (which also corresponds to the left headphone, and is thus aligned with the appropriate output region of headphone jack 115 when inserted therein).

At step 3210, processor 110 executing one or more of software modules 130, which can include temperature determination application 164 and/or calibration application 168, configures computing device 105 to receive a temperature signal from the thermistor 3110. In one or more implementations, the temperature signal corresponds to the first instance of the first signal (that is, the signal transmitted at step 3205) as output or returned from the thermistor 3110. In doing so, the amplitude of the signal being returned from thermistor 3110 can be measured, as is known to those of ordinary skill in the art. The amplitude of the signal transmitted at step 3205 and the signal received at step 3210 can be compared in order to determine the resistance of thermistor 3110, in a manner known to those of ordinary skill in the art. Accordingly, it can be appreciated that the larger the resistance of thermistor 3110, the smaller this signal can be, based on a simple resistive divider circuit, as is known to those of ordinary skill in the art.

At step 3215, processor 110 executing one or more of software modules 130, which can include temperature determination application 164 and/or calibration application 168, optionally configures computing device 105 to transmit a second instance of the first signal to conductor 3125.

Then, at step 3220, processor 110 executing one or more of software modules 130, which can include temperature determination application 164 and/or calibration application 168, configures computing device 105 to receive a reference signal from the resistor 3120. Preferably, the reference signal corresponds to the second instance of the first signal (that is, the signal transmitted at step 3205) as output from the resistor 3120.

At step 3225, processor 110 executing one or more of software modules 130, which can include temperature determination application 164 and/or calibration application 168, configures computing device 105 to process the temperature signal and the reference signal to determine a relationship between the temperature signal (received at step 3210) and the reference signal (received at step 3220). It can be appreciated that use of this ratiometric method cancels out any effects and tolerances of other conductors (e.g., C2 and R2 in FIG. 31), as well as the input circuitry of computing device 105.

Then, at step 3230, processor 110 executing one or more of software modules 130, which can include temperature determination application 164 and/or calibration application 168, configures computing device 105 to compute a measured temperature based on the relationship determined at step 3225.

Turning now to FIG. 33, a flow diagram is described showing a routine 3300 that illustrates a broad aspect of a method for calibrating a temperature measurement subsystem in accordance with at least one embodiment disclosed herein. The process begins at step 3305 where processor 110 executing one or more of software modules 130, which can include temperature determination application 164 and/or calibration application 168, configures computing device 105 to activate switch 3130. Upon activation of switch 3130, conductor 3115 is disconnected from thermistor 3110 (step 3310) and connected to resistor 3120 (step 3315), as referenced above. Activation of switch 3130 can also ground thermistor 3110 (step 3320).

Then, at step 3325, processor 110 executing one or more of software modules 130, which can include temperature determination application 164 and/or calibration application 168, configures computing device 105 to transmit a third instance of the first signal to conductor 3115.

At step 3330, processor 110 executing one or more of software modules 130, which can include temperature determination application 164 and/or calibration application 168, configures computing device 105 to receive a calibration signal from resistor 3120. According to one embodiment, the calibration signal corresponds to the third instance of the first signal as output/returned from the resistor 3120.

Then, at step 3335, processor 110 executing one or more of software modules 130, which can include temperature determination application 164 and/or calibration application 168, configures computing device 105 to process the calibration signal (received at step 3330) with the temperature signal (received at step 3210). In doing so, one or more discrepancies between the calibration signal and the temperature signal can be identified.

It can be appreciated that the referenced calibration method can be necessary in light of the fact that there is no way to ensure that the left and right headphone outputs of computing device 105 are exactly the same. As such, switch 3130 can switch between the normal and calibration mode. In calibration mode, the left headphone output (corresponding to conductor 3115) is connected to resistor 3120, and thermistor 3110 is connected to ground. This in effect simulates swapping the left and right headphone output connections, allowing computing device 105 to determine exactly what the differences are between the left and right headphone outputs. It should be noted that in calibration mode, thermistor 3110 is connected to ground (instead of to the right headphone output) in order to enable computing device 105 to definitively determine when the calibration mode has been activated (there will be no input when the computing device drives the right headphone signal).

At step 3340, processor 110 executing one or more of software modules 130, which can include temperature determination application 164 and/or calibration application 168, configures computing device 105 to calibrate a subsequent computation based on the discrepancy identified at step 3335.

It should be understood, that while routines 3200 and 3300 were described above in reference to a wired connection between the thermometer (connected health device) and computing device 105 via headphone jack 115, in one or more implementations, routines 3200 and 3300 can be performed via a wireless connection between the connected health device and computing device 105. Wireless implementations, in accordance with one or more implementations, are described in greater detail below.

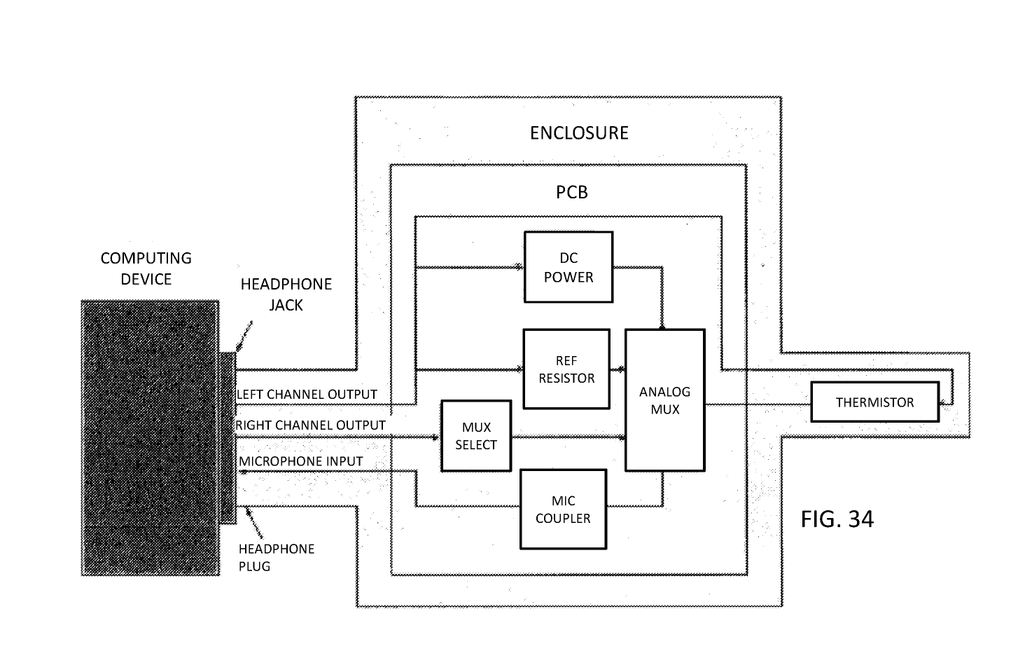

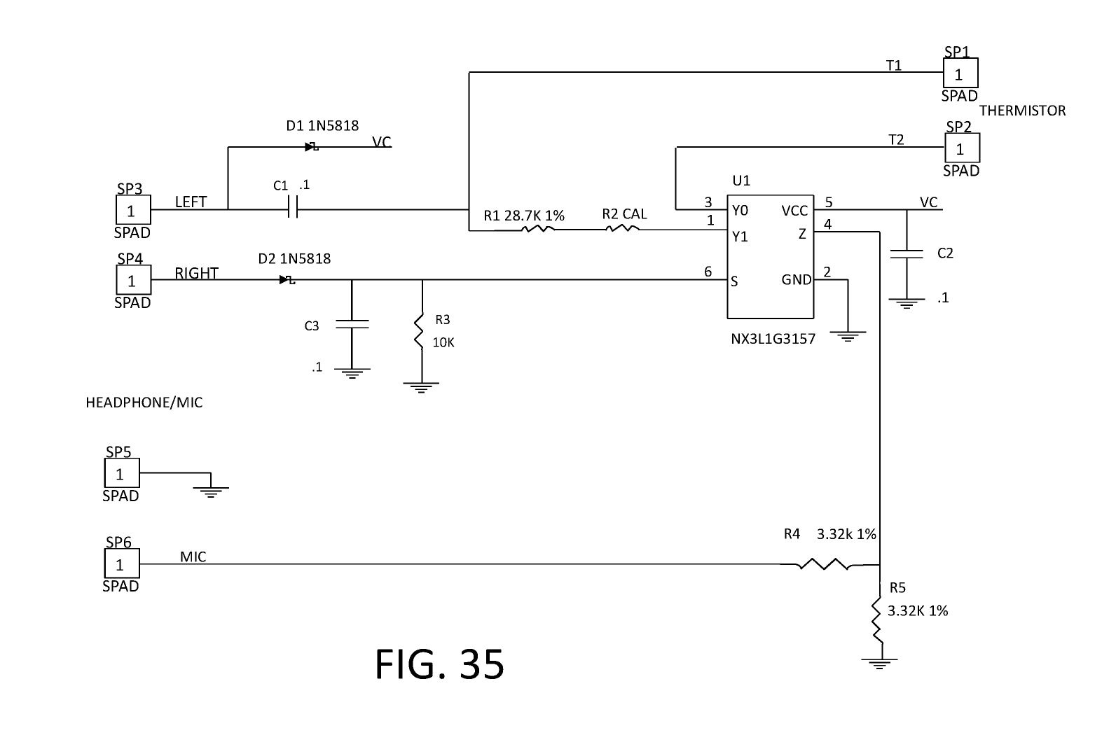

FIG. 34 depicts another implementation of temperature-sensing probe 3005, including an enclosure, headphone plug, thermistor, PCB—sections (e.g., as shown in FIG. 35), DC power (the DC power section (D1, C2) generates approximately 1.6 volts from the audio tone on the left channel output for the operation of the analog mux), reference resistor (the reference resistor section (R1, R2) matches the value of the thermistor at 37 C), mux select (the mux select section (D2, C3, R3) generates the mux select from the audio tone on the right channel output), analog mux (the analog mux section (U1) connects the thermistor or the reference resistor from the left channel output to the mic coupler), and/or mic coupler (the mic coupler section (R4, R5) presents the proper resistance (6.8K) to the smartphone microphone input. The mic coupler section also attenuates the left channel output by the correct amount and connects to the smartphone microphone input).

Moreover, in certain implementations, the methods described herein can be configured as follows:
If the temperature determination application detects the correct resistance on the microphone input, then it outputs a tone on the left channel output.
The temperature determination application measures the amplitude on the microphone input and saves it as the thermistor measurement value.
The temperature determination application outputs a tone on the right channel output.
The temperature determination application measures the amplitude on the microphone input and saves it as the reference resistance measurement value.
The smartphone app (computing device application) calculates the thermistor resistance using the ratio of the thermistor measurement value and the reference resistance measurement value.
The temperature determination application calculates the thermistor temperature by using the calculated thermistor resistance and a thermistor RT table or thermistor RT equation.
   Sending Health Care Data to a Data Repository and Aggregating Collected Health Care Data with Existing Health Care Data

Also described herein, an in accordance with one or more implementations, are various technologies that enable the collection of location data on symptoms and illness. Components of such technologies include the application of mobile, software, and proprietary technologies to existing health care products and devices, and methods and systems that enable the aggregation of collected data with existing historical health care data and/or location data, social network data, and/or data on movement/behaviors of populations. Various implementations of the described technologies provide substantial advantages in biodefense and health surveillance settings, including early warning, planning, and identification of emerging illness, symptoms, and/or pathogens.

After the temperature determination application has saved health-related information (such as a measured temperature), the health-related information can be sent from the smartphone (or other computing device) to a data repository using known transmission means. In at least one embodiment, the data repository includes server computers operable to store data in a database using known means.

Moreover, in certain implementations, health-related information (such as temperature measurements) determined/identified by way of the various methods and systems described herein, can be further collected, analyzed, and leveraged to enable the tracking and prediction of various health-related phenomena, among other advantages. In certain implementations, medically accurate, real-time, and/or location data (such as data pertaining to various symptoms and/or illness) can be received/generated at various remote sites/devices, such as smartphones (such as those equipped with the various temperature-sensing technologies described herein) and provided to a data repository. It can be appreciated that, in various implementations, any number of mobile computing devices, applications, peripherals/proprietary technologies, and/or pre-existing health care products/devices can interface with one another to enable the identification and/or collection of health care data. Such data can also be aggregated and/or correlated with existing historical health care data (including location-based data, and/or social network data) in order to further enhance and improve the veracity of the collected health care data (ensuring a high signal-to-noise ratio (SNR)) and further enabling analysis of health care data in view of such location data and/or social network data. In doing so, a health surveillance and biodefense tracking system, among other features and advantages, can be deployed, enabling, for example, early warnings, planning, and identification of emerging illness, symptoms, and/or pathogens.

The technologies described herein provide numerous advantages over traditional provider-initiated reporting and more recent computational efforts. By collecting medically accurate data from patients in their natural locations (e.g., homes, workplaces, etc.), even before they enter the health care system (e.g., visit a doctor or hospital), the technologies described herein not only overcome the time lag of the current provider-initiated reporting system and ensure high reporting levels, but also facilitate high SNR and enable near-real-time detection of disease outbreaks and bioterrorism events, substantially earlier and more accurately than would be possible under other health care data aggregation approaches. Additionally, the collected and analyzed health care data can be further processed to enable a predictive capability with respect to outbreak monitoring by combining health care data collected with health care data from providers, from geography (e.g., location data), from social networks (i.e. social network data), and/or from behavior/movement (e.g., behavior/movement data).

Examples of health-related information that can be collected through the use of the application software bundled with the connected health device or computing device, as described herein, or through other means or channels, and then aggregated, correlated, and/or analyzed through the mobile enabled health system described herein include, but are not limited to:
1. Illnesses;
2. Symptom data;
   a. General symptoms (e.g. fever);
   b. Specific symptoms indicative of specific illnesses (e.g., barking cough for a strong signal of croup presence);
   c. Other major symptoms;
3. Time of incidence of the above illnesses and/or symptoms;
4. Places a patient frequents;
5. Other people a patient is commonly in physical proximity to;
6. Age of patient;
7. Behavior of users within the temperature determination application;
   a. Frequency of use of the temperature determination application and specific features/functions;
   b. When users create new places or groups; and
   c. When users invite others.
   d. Notes: The above data can be indicative of a user's vigilance for a patient's health (noting that the patient and the user of the temperature determination application may be the same or different people). Vigilance can be considered along three dimensions: (1) treatment vigilance (how vigilant patients are when sick), (2) prevention vigilance, and (3) parenting vigilance (or caregiver vigilance).
      There may also be other behavioral implications, including:
8. Others in a user's social network;
9. Utilization of coupons for health care products (indicative of illnesses/symptoms); and
10. Which treatments a patient is taking.

As referenced above, it can be appreciated by one of ordinary skill in the art that the various technologies described herein can be implemented using presently available mobile technologies (e.g., smartphones) together with commonly available health care products/devices.

### Sharing Health-Related Information

In accordance with one or more implementations, health-related information can be shared with patients, users, and/or the general public via one or more applications. For instance, in one or more embodiments, a real-time map of human health is created. The map of human health includes information about where, when, and what types of illnesses are spreading, and associated relationship data (e.g., to which groups, schools, and locations (geo-nodes) these illnesses are associated).

For example, the temperature determination application transmits data on fever and location while the accompanying software features bundled with a smartphone-connected (or other connected computing device) thermometer transmits additional geo-located health-related information (e.g., symptoms, specific illnesses and relationship data, as described herein) to the data repository. Once this data on fever and location is transmitted to data repository, the data is aggregated with data from other users to develop an understanding of the level of fever, symptoms, illness, where these are occurring, their incidence, their prevalence, and the rate at which they are spreading or could spread given the number of people exposed or expected to be exposed. The application determines and/or accounts for relative proximities and relationships between ill persons, and such data is further correlated, for example, with historical health-related information and other external data sources described herein. Information, including alerts and context (e.g. the level of fever or associated symptoms, where it is, whether it is at your child's school), is then transmitted back to (i.e. shared with) the user for consumption at a mobile computing device (such as via the temperature determination application). This information can also be shared with other users, some of which may not be ill, so they can get an understanding of the health situation in their area, for example, to avoid getting ill in the first place.

A health weather map application executes at a the data repository and enables the processing, sharing, and aggregation of any/all health care data collected, such as health care data pertaining to human fever, illness, and/or symptoms. Such health care data is collected, for example, as described herein, and is further combined with other data sources as described herein. Contextualized health care data from the health weather map application is displayed on a smartphone mobile application and/or a via a web browser. In doing so, public health officials and others track and anticipate/predict the spread of disease. Moreover, other health-related parties and entities (e.g., private sector organizations such as pharmacies) are enabled to target appropriate products (such as TAMIFLU®) and interventions, and are provided with context to support doctors with diagnoses, based on the collected/analyzed data. Additionally, in certain implementations, social networking features enable the visual depiction of health trends directly relevant to individuals, families, and communities, while also facilitating better use of health resources, thereby enabling better outcomes.

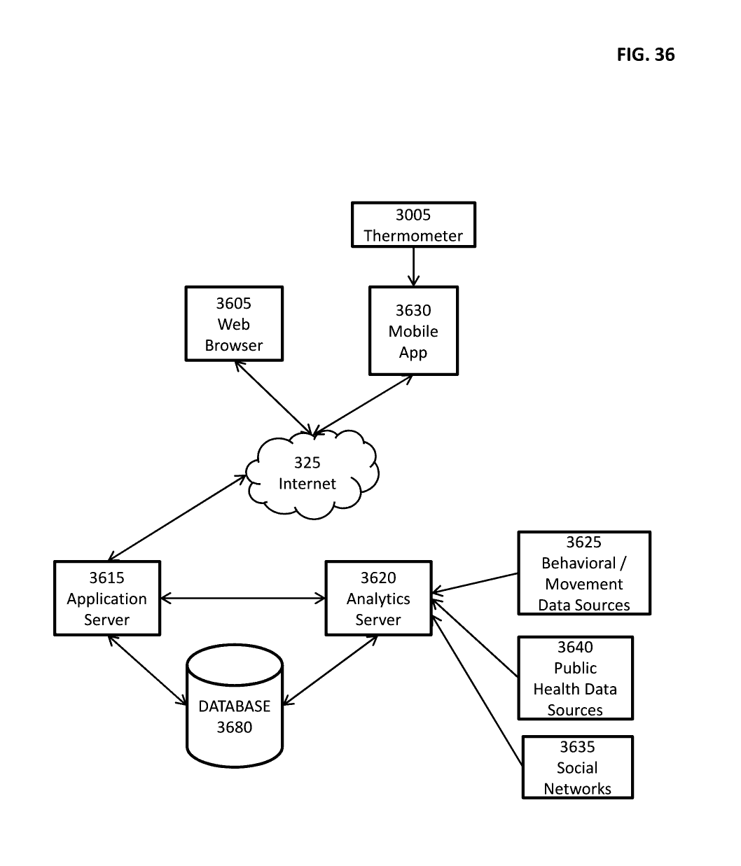

Turning now to FIG. 36, a view of the architecture of an example system for sharing health-related information is shown. A thermometer 3005 (connected health device 305) connects to a mobile application 3630 (such as the temperature determination application 164, telemedicine application or combinations thereof) running on a computing device (not shown) such as a smartphone. In one or more implementations, the thermometer 3005, the smartphone (not shown), and the mobile application 3630 together form the temperature measurement subsystem. The thermometer 3005 is inserted into the mouth of a patient (not shown) by the patient or another user (not shown) and together with the mobile application 3630 computes the measured temperature of the patient. The measured temperature is one kind of health care data that can be collected by the temperature measurement subsystem.

When a user of mobile application 3630 completes certain actions, events are triggered, data is created (behavior/movement data sources 3625) and health-related information (including behavior/movement data) is transmitted from the smartphone (not shown) to the data repository 180 (not shown), the data repository in turn having application server 3615, analytics server 3620, and database 3680. Example of such triggering events include, but are not limited to, the following:
1. If a user completes a temperature reading, then temperature data, date/time data, geo-location data are transmitted to data repository 180.
2. If a user selects symptoms and saves them to a profile, then symptom data, date/time data, and geo-location data are transmitted to data repository 180.
3. If a user indicates whether or not he/she has seen a doctor, then a new illness episode is transmitted to data repository 180.
4. If a user selects a diagnosis, then illness data, date/time data, and geo-location data are transmitted to data repository 180.
5. If a user answers diagnosis-specific questions, geo-located data and the responses to the questions (which are additionally associated to an illness episode) are transmitted to data repository 180.
6. If a user joins a group, then user-to-group association data is transmitted to data repository 180.
7. If a user creates a group, the group name and optionally the geo-location of the group are transmitted to data repository 180.
   In short, nearly any user action while using the application generates data that can be transmitted to data repository 180.

Example of behavior/movement data sources include data on movements of populations, such as data from mobile phones that track movements (e.g. Foursquare, Google Latitude, Glympse, Life360, MapTrack) and attendance information (e.g. from schools).

In addition to data generated by users of mobile application 3630 and related applications running on the smartphone, data repository 180 receives data from external data sources, such as public health data sources 3640 and social networks 3635. An example of public health data sources 3640 is CDC public health care data. An example of social networks 3635 data is data obtained from the mining of various social networking data (e.g., Twitter) for disease-related terms. Another example of social networks 3635 data is Google data accessible via various APIs including, but not limited to, information regarding past search queries from users.

At the data repository 180, collected data is aggregated and analyzed resulting in contextualized health care data (i.e. health care data with context). Selected contextual health care data can then be shared via Internet 325 to computing devices (not shown) running web browser 3605 and/or mobile app 3630. Two types of data are most ideally suited for sharing, namely:

(1) A static representation of the data (which focuses on the location data) is called the “health map” and can be global, national, regional, or local. A local “health map” is ideally suited for viewing on a smartphone. It should be recognized, however, that such representation need not take the form of a literal map in which data is plotted against specific geographic features, but rather may be any representation that conveys the distribution of heath information.

(2) A dynamic representation of the data (which focuses on the date/time data) is called the “health weather” and has three components:
(a) past (based on historic data);
(b) present (based on real-time data); and
(c) future (based on predicted data).
   Again, such representation need not literally be a weather map juxtaposed against health information, but rather any dynamic representation of health data, which may comprise a dynamic visualization of health data.

The flow diagram of FIG. 37 illustrates one embodiment of a method that utilizes the above-described architecture (or other architectures) for the sharing of health-related information between accounts, users and devices. According to the embodiment of FIG. 37, the process is initiated when two users (user one and user two) are geographically remote from each other and one of the two users is with the patient, e.g., user two, S3702. Alternatively, the two users may be geographically co-located with the patient such that a copy of the collected health related information is pushed or otherwise made available to the computing device of the other user, e.g., user one.

User two collects health related information from the patient using a connected health device, which the connected health device may push to a user account located on a remote server, S3704. Such data may also be recorded on the computing device, and in accordance with certain embodiments the computing device pushes the collected health information to a user account located on a remote server. Pushing such data to a user account located on a remote server allows the information to be added to a health information timeline for the user, forming the foundation of an electronic medical record for the user. Advantageously, by leveraging acute health conditions as a driver for the collection of health related information, users are seamlessly incentivized to both overcome the “cold start problem” associated with an empty electronic medical record, but also the problem of encouraging users to maintain complete and up-to-date health information.

Using the systems and methods described herein, a determination is made as to the need to receive medical guidance, S3706. As discussed and described herein, a telemedicine application, which may reside on a computing device of the user, is operative to receive health related information from connected health devices (and other sources) and provide medical guidance on the basis of such information, S3708, which may comprise connecting to a physician to provide telemedicine services via a number of communication modalities, e.g., text, video, voice, data. User two has access to collected health related information, which may comprise access to the health information timeline of the patient. As the server receives the information, hardware and software processes on the computing device of user one opens a communication channel to the server to synchronize local information with fresh information at the server, S3710. Synchronization according to one embodiment comprises transmission of a notification from the server to the computing device as to a health condition of the patient, which the server may supplement with additional information, e.g., a coupon for medication that will ameliorate the symptoms of the patient.

User one receives the notification from the server and can make a determination to receive medical guidance, S3712, which can comprise presenting additional information through the telemedicine application on the user's computing device or initiation of a telemedicine session with a physician as described herein according to various embodiments of the invention. Where the user opts to receive additional medical guidance, the system presents the user with such information, which according to the example flow of FIG. 37 comprises initiating a telemedicine session between the physician and the user, S3714, e.g., to allow the user to submit additional questions to the physician or obtain clarification with regard to various points.

One example use-case of the above-described methodology would be a scenario in which one parent is at home with a sick child and another parent is away at work. The parent at home uses a connected health device to collect health related information from the child, which upon processing indicates that the child is experiencing an adverse medical condition, such as a fever. The parent at work receives a notification via the telemedicine application installed on his or her mobile device (computing device) that the child has a fever along with associated medical guidance, which can include illness progression forecast for the child. Such notification can be received via text, email, push notification, call, etc. and can include promotions, such as a coupon (taking the form of a barcode, QR code, AKA passbook, etc.) for medication. The parent at work may also have access to the physician providing telemedicine services and examine diagnosis, treatment plan and other information regarding the child's illness and prognosis.

### Taking Action for Better Outcomes

Accordingly, through the collection, aggregation, and/or analysis of symptom, fever, and illness data provided by users, including at intervals prior to patients entering the health care system, the technologies describe herein yield significant advantages and efficiencies in settings such as public health and bio surveillance.

Moreover, in one or more implementations, features are incorporated/integrated, whereby relevant and actionable information is generated and provided to a user (e.g., pertaining to what to do when a patient first falls ill as well as information on illnesses or symptoms that are circulating in their local area), as can be generated based on the collected data.

Additionally, in certain implementations, various features and functionalities enable the collection of more nuanced symptom data in order to help identify nodes of disease transmission and potentially self-reported confirmatory diagnoses. For example, using the temperature determination application 164, a user can interact with a “wizard” checklist based on a nurse call center triage protocol. Doing so enables the user to determine appropriate next steps and provides real-time access to symptoms beyond fever. It can be appreciated that many patients reach the peak of their concern when they first confirm that they are ill, and strategic positioning of features during this time can mitigate against widespread falsification of data collected. Additionally, platform integration with other health care data sources and location-based apps can act as a secondary buffer against noise.

In certain implementations, data (e.g., projections, etc.) generated by the various technologies described herein can be evaluated/validated against results from provider-initiated reporting using the number of reported cases and timeliness of cases reported as the primary evaluation criteria (e.g., to identify the beginning/peak of flu season).

### Wireless Implementations

In accordance one or more implementations, a further aspect of the methods and systems of the present application is shown and described. In particular, wireless implementations of the one or more aspects of the present application are described with reference to, for example, a Bluetooth Low Energy (BLE) protocol for an implementation comprising a wireless thermometer. For instance, a single computing device can be paired with one or more thermometers and a single thermometer can be paired with one or more phones. In one or more implementations, however, only a single live phone-to-device connection at a time is supported on both ends.

In accordance with one or more implementations, a protocol is provided for bound pairing of a computing device (e.g., a phone) with a connected health device (e.g., thermometer) to enable AES encryption between the two devices. Under iOS, for example, binding occurs when a characteristic is marked as ‘requires authentication.’ Characteristics can be marked so in the device GATT database in order to cause a paired binding between the computing device and the connected health device. The following descriptions refer to a thermometer as the connected health device, however it should be understood that the connected health device can be any number of health devices capable of being paired with a computing device, including but not limited to heart rate monitors, blood pressure monitors, glucometers, scales, and respiratory monitors.

In one or more implementations, the connected health device (e.g., thermometer) can reside in four states when it comes to wireless, such as BLUETOOTH (“BLE”), pairing: Unpaired; Pairing; Paired with one phone; and Paired with multiple phones. Once a connected health device is powered up, if it has no pairings established (e.g., normal out-of-the-box behavior) it can automatically prompt for pairing mode and can remain there indefinitely (or until turned off). In case the connected health device is already paired with one device (e.g., computing device) the user can explicitly place the connected health device into pairing mode. There are several ways to put a thermometer into pair mode: Power up an unpaired device (out-of-the-box); Send device a Pair (PA) opcode command (see below) from an already-paired computing device (which can disconnect from the current device and put device into prompt for pairing mode); Put the device into pair mode by pressing a button sequence (long-press on a ‘pair’ button, which may be a physical or virtual button on the device) on the body of the device; and Reset device back to factory state (using the RD opcode or a long-press of two or more buttons on the body of the device). After the full reset the device may have no connections and no more devices in its whitelist and should automatically go into pair mode. In one or more implementations, if no pairing or connection is made in 30 seconds the device can stop prompting.

The thermometer can maintain a ‘whitelist’ of devices with which it has been previously paired and bonded. For example, in one or more implementations, the whitelist can support several (e.g., 6 or more) computing devices. Computing devices that are on the whitelist may connect to the connected health device without undergoing a separate pairing process or requiring the user to acknowledge a pairing dialog box on the phone. The pairing data shall be stored in the BLE flash memory and can outlast battery replacement.

Connections with the thermometer can be bonded. GATT characteristics can be marked as ‘requiring authentication’ so the computing device presents the user with a pairing alert box, which may be an optional presentation. The BLE modules can transparently generate encryption keys to maintain a bonded/encrypted channel between the device and the phone.

In at least one implementation, unpairing a computing device from a connected health device involves both sides removing each other from their corresponding whitelists. For instance, this can be done when a user's computing device has been reset, the user has switched to a new device, and/or when the user wants to remove a device to make room for another one.

On the thermometer side there can be two ways to remove a device from the whitelist: Explicit removal of a device via Unpair (UP) control command from an already paired device; and erasing all whitelist devices via the Reset Device (RD) command.

Unpairing on the connected health device side may not remove the pairing from the computing device (or vice versa). To completely detach a computing device from a connected health device, the user can unpair on both sides. On an iOS computing device, the user can unpair from a thermometer via the Bluetooth Settings screen, by tapping on the (i) button and ‘Forgetting’ the device, for example. On an Android device a similar ‘unpair’ action may be performed from the Bluetooth Settings control panel.

Manufacturing Broadcast Data

In at least one implementation, when the user runs the application and scans for a new device, a list of devices implementing the thermometer service of the present application can be presented to the user. Under normal circumstances the only information available for showing to the user can be the device name. However, if the following information is provided in the Manufacturing Broadcast Data, the application can provide the user with a more UX-friendly image of the device. The data can be included in the service broadcast packet as Manufacturing Data (as defined in the Bluetooth GATT specification). The values can include: 2 bytes: device make identifier code; and 2 bytes: device model identifier code. Additionally, the serial number of the device can also be included in the packet in UTF-8 string format. This allows the device chooser to disambiguate between multiple devices of the same type in a given location.

Multiple Thermometer Support

In one or more implementations, each computing device can be paired with one or more thermometers. Each thermometer can contain a unique serial number that may be obtained via the standard BLE Device Information Serial Number characteristic (0x2A25) within the standard Manufacturer Data Service (0x180A). The application can be responsible for receiving the serial number on connection with the device and using that as a key for storing the data in its data store and on the server. The computing device can be explicitly connected and communicating with one thermometer at a time.

Multiple Computing Device Support

In accordance with at least one implementation, a thermometer can keep more than one computing device in its whitelist. Once a device (e.g., thermometer) is connected to a computing device it can stop prompting its services or accept connections. When the connection is closed the device can go back into service prompt mode and wait for connections.

Activity and Connection Timeout

In one or more implementations, the thermometer can maintain an activity and connection timeout period, such as 30 seconds or less. If no interaction between the two devices is detected in that time, the thermometer can automatically drop the connection and power down. In this mode the device can go into a deep-sleep/power-saving mode. Starting the device again can include the user pressing a button to awaken the system. The computing device can prevent the activity timeout by maintaining its own timer and sending a NO (no-op) command to the device. The device can reset its connection timeout when it receives that command. Any other command received from the computing device or any event from the device during this period may also reset the timer. In at least one implementation, while the computing device application is in foreground, it can issue the NO command to keep the thermometer from going to sleep. If the computing device application is put in background by the user, the computing device can stop sending the periodic NO commands, and the device can then automatically disconnect and power down. When the user returns, the user can turn the device back on by pressing a button. This can alert the computing device to the presence of a nearby device which can alert the user to bring the app to the foreground.

In at least one implementation, the “NO” command can be used by the application when user is engaged in interactive editing of device settings to prevent the device from going to sleep in the middle of a user-session. To conserve battery life, its use at other times can be minimized.

In accordance with other embodiments, which may include functionality beyond or in conjunction with the above-described functionality, an “autoscan” feature allows the telemedicine application to continuously scan for a connected health device. If the connection between the computing device and connected health device drops, the computing device automatically attempts to reconnect to the connected health device without requiring manual intervention from the user. Accordingly, the telemedicine application supports BLE ‘background mode’ in these embodiments such that the telemedicine application knows to not go into autoscan mode when entering a background state and the connection to the connected heath device is dropped, as well as to start scanning again if there is no connection when brought back into foreground.

Value Types

In one or more implementations, the data returned for the BLE standard services can be in the format specified in the Bluetooth LE spec., such as the UTF-8 string format.

Auto-Launch Feature

In accordance with one or more implementations, when a user takes a thermometer reading and does not have a computing device turned on with the application running, the auto-launch feature can send a notification to the phone's lock screen. If the user unlocks the computing device, the app can launch automatically, connect to the device, and obtain the reading in one go. This can be accomplished, for example, by having the thermometer act temporarily as an iBeacon, for which the application can register an interest. In at least one implementations, when the user takes a temperature reading and there is no connection to a computing device, the thermometer can go into iBeacon BLE broadcast mode, such as for a 30 second period. During this period, a computing device that has been properly configured can detect the iBeacon, and generate a local notification to the user to run the application. Once the device is connected or if the timer expires, the iBeacon prompting can stop. If the reading has not been sent to the computing device during this period, its value is stored in the device memory for later retrieval.

Cached Data and Error Values

In one or more implementations, the connected health device (e.g., thermometer) can implement a FIFO buffer to cache both measurements and error messages. The data can be saved in non-volatile storage to outlast battery changes. When the user takes a data measurement, the current reading can be written to a connected device (e.g., computing device) as an event and also saved in a buffer as the ‘current reading.’ For instance, for a temperature reading, the information can include a timestamp, the temperature value and the unit of measure (if applicable). In one or more implementations, the application can receive the data immediately if it is connected and running in the foreground or retrieve previous cached values through the Cache Count (CC) and Read Cache (RC) commands.

Cached values can be deleted individually through, for example, the Erase Last Temp (EL) command or completely through either the Cache Erase (CE) or Reset Device (RD) commands. In one or more implementations, the connected health device (e.g., thermometer) can support multiple entries, e.g., at least fifty (“50”), in the data cache. In one or more implementations, the cache operates as a first-in-first-out (“FIFO”) queue. If the number of cached readings reach the maximum count the firmware can loop back and overwrite the oldest entry. The device can retain a similar cache for error records, which can also operate as a FIFO queue with a number of (e.g., at least 16) entries. Error values may be obtained by the app using the Error Count (EC) and Read Errors (RE) commands. They may be erased via the Error Erase (EE) command.

Timestamps

In one or more implementations, individual and queued records can come with a timestamp value, indicating the time the temperature was recorded. The timestamp format can be in 12-byte UTF-8 string. The pre-defined origin date can be Jan. 1, 2014 at 00:00:00. The date format string can be in the YYMMDDHHMMSS format. In such cases, YY=2-digit year number format. 12=2012; MM=2-digit zero-padded month number format, where 01=January and 12=December; DD=2-digit zero-padded day number format where 01=first day of the month; HH=2-digit zero-padded hour of the day in 24-hour format, e.g. 08=8 AM, 15=3 PM. Range can be between 00 (midnight) to 23 (11 pm); MM=2-digit zero-padded minute in the range 00-59 and SS=2-digit zero-padded second in the range 00-59. For example, 160311130235=Mar. 11, 2016, 1:02:35 pm, and 151230000010=Dec. 30, 2015, 12:00:10 am.

The date offset value may be reset back to the origin date when the battery is replaced, which may cause issues with data cached on the device with a timestamp but not yet synced up to the computing device application. In such case, the computing device app detects date values less than previous entries and handles the data accordingly. The real-time-clock value can be read and set via opcode commands.

Serial Number

In one or more implementations, a given device is provided a unique serial number stamped, e.g., during the manufacturing process. In order to facilitate the production process, an opcode can be provided to allow a one-time write operation of the standard Device Information Service (DIS) values, including the serial number, in non-volatile storage. This is a one-time operation. Attempts to overwrite DIS data can be rejected if data already exists. To reset the DIS data (e.g., due to a manufacturing or software error) a physical, difficult to access reset pin may be provided.

Services

The connected health device (e.g., thermometer) can implement the following services in its GATT database: Standard BLE Device Information Service (UUID: 0x180A); Standard BLE Battery Service (UUID: 0x180F); Kinsa Temperature Service (UUID: 2893B28B-C868-423A-9DC2-E9C2FCB4EBB5); and Kinsa Auto-Launch Service (UUID: 3893B28B-C868-423A-9DC2-E9C2FCB4EBB5).

Under the Device Information Service (DIS) the following characteristics can be implemented:

| | | | |
|---|---|---|---|
| System ID | 0x2A23 | UTF-8 | Provided by Kinsa. |
| Model number string | 0x2A24 | UTF-8 | Provided by Kinsa. |
| Serial number string | 0x2A25 | UTF-8 | Unique sequential value |
| | | | for each device. Format |
| | | | specification provided |
| | | | by Kinsa. |
| Firmware revision string | 0x2A26 | UTF-8 | Provided by Kinsa. |
| Hardware revision string | 0x2A27 | UTF-8 | Provided by Kinsa. |
| Manufacturer name | 0x2A29 | UTF-8 | Provided by Kinsa. |
| string | | | |
| Regulatory Certification | 0x2A2A | UTF-8 | Provided by Kinsa. |
| Data List | | | |
| PnP ID | 0x2A50 | UTF-8 | Provided by Kinsa. |

In at least one implementations, the DIS data may be written only once through the Factory Write (FW) opcode. Any subsequent attempts to overwrite can be ignored. These values are all standard BLE profiles and are all set as read-only.

Under the Battery Service the following characteristic can be implemented:

| | | | |
|---|---|---|---|
| Battery Level | 0x2A19 | UINT8 | 0-100 (% value) |

In one or more implementations, the battery level value can be set up for notification.

According to certain embodiments, the battery level is updated only when the telemedicine application or other application on the computing device sends over a “BA” opcode to ask the connected health device to update its own battery level. This may be done only once per connection session. Characteristic Attributes: Read/Notify (the value will only be written by the device).

In accordance with an example embodiment, the Kinsa Temperature Service is a custom BLE service with the following characteristics:

| | | | |
|---|---|---|---|
| Request Opcode | 28930000-C868-423A-9DC2- | UTF-8 (2 bytes) | See below |
| | E9C2FCB4EBB5 | | |
| Request Response | 28930001-C868-423A-9DC2- | UTF-8 (variable) | Depends on |
| | E9C2FCB4EBB5 | | Request Opcode |
| Device Event | 28930002-C868-423A-9DC2- | UTF-8 (variable) | See below |
| | E9C2FCB4EBB5 | | |
| Pair Status | 28930003-C868-423A- | | 0 = Not Paired |
| | 9DC2-E9C2FCB4EBB5 | | 1 = Paired |

BLE Characteristic Attributes can include the following: Request Opcode: read/write by the computing device. Authentication can be required to force a pairing dialog; Request Response: read/write/notify (for a device to write a response). Also, authentication can be required to force a pairing dialog; Device event: read/notify for a device to write to this characteristic). Also: Authentication can be required to force a pairing dialog.

The Request Opcode can be a command sent from the computing device to the thermometer. The response can be sent back from the thermometer in the Request Response characteristic. The Request Response data can be larger than a single 20-byte characteristic value for certain request types. In that case the response can have a header with the count of responses to follow followed by a stream of remaining data in 20-byte chunks.

The values returned can be variant and depend, for example, on the opcode (see below). Values can be returned as UTF-8 strings. For those opcodes requiring a count the first packet can have a count immediately followed by the response data (up to a total of 20-bytes). The subsequent packets can be written in 20-byte chunks until all data has been transmitted. The Request Response characteristic can be defined in the GATT database for both notification and write-with-response to guarantee delivery.

The Device Event can be a value set for notification and be modified from the device side when there is an alert for the phone. The value can be a 2-byte opcode followed by zero or more bytes of data, and transmitted as UTF-8 strings. In the current design data sent from the device will not exceed a single 20-byte characteristic so the data can be packed into the same characteristic.

The Pair Status value allows the application, which according to one embodiment is the telemedicine application executing on the computing device, to see if the computing device is properly paired with the connected health device. If the value is 0, the device is not paired and the application should take measures to either re-attempt pairing or notify the user. A value of 1 indicates that as computing device believes that it has a valid paring with the connected health device. The pairing may still be invalid from the phone side, however, so it is possible for pairing to have partially succeeded, but the data remains inaccessible. To test for such a condition, the telemedicine application can request that the connected health device send a PT opcode (preset test data), set a timer, and if either a write error is received or if the result is not returned in time, then the user can be signaled accordingly.

In accordance with an example embodiment, the Kinsa Auto-Launch Service is a custom BLE service that allows the device to act as an iBeacon device. It supports the following characteristics:

| | | | |
|---|---|---|---|
| Broadcast Time | 38930001-C868-423A-9DC2- | UINT8 | Number of seconds to transmit |
| | E9C2FCB4EBB5 | | beacon (default = 30) |
| Beacon UUID | 38930002-C868-423A-9DC2- | 128-bit | iBeacon UUID value device |
| | E9C2FCB4EBB5 | hex | should transmit |
| Beacon Major | 38930003-C868-423A-9DC2- | UINT16 | iBeacon major value device |
| | E9C2FCB4EBB5 | | should transmit |
| Beacon Minor | 38930004-C868-423A-9DC2- | UINT16 | iBeacon minor value device |
| | E9C2FCB4EBB5 | | should transmit |

BLE Characteristic Attributes: Broadcast Time: read/write (only computing device my write to this). Also: requires authentication so it forces a pairing dialog; Beacon UUID/major/minor: read/write (only computing device may write to these). Also: requires authentication so it forces a pairing dialog. If the device takes a measurement value and there is no active connection to a computing device and Auto-Launch Enable is set to 1, then the device can broadcast the Beacon service for the number of seconds specified in the Broadcast Time characteristic (default=30 s).

While these custom BLE profiles described above can provide additional information, the standard BLE Health Thermometer profile can alternative be used. Because the BLE Health Thermometer profile and service are a well defined, standard portion of the BLE specification that is understood by those of ordinary skill in the art, the details of its implementation are not duplicated herein.

On the computing device, the user can be notified of the presence of a nearby temperature reading device and prompt the use to launch the application to obtain the value. If the user does not take action, the Broadcast Timer can expire and the device will stop iBeacon prompting and push the taken value into its memory queue for later retrieval.

Request Opcodes

This table lists opcode values that can be sent from the computing device to the thermometer:

| | | |
|---|---|---|
| Pair | PA | Drops connection and puts device into pair mode. |
| Unpair | UP | Removes currently connected device from whitelist and drops |
| | | connection. |
| Get Whitelist | WL | Return Bluetooth ID of phones whitelisted to interact with this |
| | | device |
| Cache Count | CC | Get number of items stored in the temperature data cache. |
| Read Cache | RC | Requests retrieval of all cached temperature data. Data will be |
| | | sent in a stream of values (see below). |
| Preset Test Data | PT | Like RC, except the data returned will be pre-defined values |
| | | used to test device integrity. |
| Cache Erase | CE | Erase all cached data (including errors) |
| Erase Last Temp | EL | Erase the last temperature value. |
| Reset Device | RD | Reset to factory default settings. Erases all cached data and |
| | | pairing whitelist. |
| Error Count | EC | Get number of error codes cached on device. |
| Read Errors | RE | Retrieve list of error codes cached on device. |
| Erase Errors | EE | Erases all cached error codes. |
| Preset Error Values | PE | Like RE except the data returned will be pre-defined error |
| | | values used to test device integrity. |
| Read Device Setting | RS + 2-byte value | Returns on-device settings given 2-byte value key code: |
| | key code | PV: protocol version |
| | | UN: current display unit (C or F) |
| | | MU: mute status |
| | | BL: backlight |
| | | ST: screen timeout |
| | | CT: connection timeout |
| | | TS: Current timestamp (12-digit value) |
| | | AL: Auto-Launch mode enable (Boolean) |
| Write Device Setting | WS + 2-byte | Sets on-device settings such as: |
| | value key code + | UN: current display unit (C or F) |
| | appropriate value | MU: mute status (0 = not-mute or 1 = mute) |
| | (see below) | BL: backlight (0 = off or 1 = on) |
| | | ST: screen timeout (3-digit number) |
| | | CT: connection timeout (3-digit number) |
| | | TS: base timestamp (12-digit value) |
| | | AL: Auto-Launch mode enable (0 = disable or |
| | | 1 = enabled) |
| Diagnostics Run | DR | Tells device to run internal diagnostics. |
| Get Calibration | GC | Returns one or more calibration data values. |
| NOOP | NO | Sent to reset connection timeout timer. |
| Factory Write | FW | One-time write Device Information data including copyright and |
| | | serial number to non-volatile storage during production stage. |
| Factory Erase Data | ED | Over-rides the one-time write of Device Information data in the |
| | | FW command and erases all DIS data back to original state. |
| | | This may be only for use during product development and may |
| | | only be available in DEBUG builds of the firmware. In |
| | | production versions the opcode should be ignored. |
| Battery Update | BA | Updates the battery characteristic that can be set for notification. |
| | | According to certain embodiments, the battery value is only |
| | | updated once when the device is powered up. |

Temperature Record Format (e.g., 18 Bytes Fixed)
1. Temperature: 5 digit string format in Celsius or Fahrenheit. The value can be a floating value with single-digit precision (i.e. “098.4”).
2. Unit: 1 digit string indicating “C” or “F” reflecting what the temperature unit setting was when the temperature was originally taken.
3. Timestamp: 12 digit number in UTF-8 string format. The format can be in YYMMDDHHMMSS format (see previous section on Timestamp).

Error Record Format (15 Bytes Fixed).
1. Error type: 1 digit error type value. Values may be “W” (warning), “E” (error), or “S” (severe).
2. Error code: 2 digit error code value in string format.
3. Timestamp: 12 digit number in UTF-8 string format. The format can be in YYMMDDHHMMSS format (see previous section on Timestamp).

Error Codes

In one or more implementations, the thermometer can support the following error values.

| Error Code | Description | Note |
|---|---|---|
| W01 | No value available | Sent when a requested value is |
| | | not available (it may not be set) |
| E01 | Invalid opcode command | Returned when opcode is not |
| | | recognized |
| E02 | Error parsing command packet | Invalid data sent along with |
| | | opcode |
| E03 | Insufficient amount of data sent | Expected more data in command |
| | | request |
| E04 | Too much data sent | Too much data seen for a given |
| | | opcode |
| E05 | Invalid value | Sent when a set value is incorrect |
| | | or improper format |
| E06 | Out of range | Sent when a set value is correct |
| | | but out of acceptable bounds |
| E10 | Operating temperature out of | Outside operating temperature is |
| | ambient range. | outside the bounds supported by |
| | | device |
| E11 | Measured temperature too low for | Temperature below 10° C. or 50° F. |
| | forehead mode. | |
| E12 | Measured temperature too low for | Temperature below 10° C. or 50° F. |
| | ear mode. | |
| E13 | Measured temperature too low for | Temperature below 0° C. or 32° F. |
| | object mode | |
| E14 | Measured temperature too high | Temperature above 50° C. or 122° F. |
| | for forehead mode | |
| E15 | Measured temperature too high | Temperature above 50° C. or 122° F. |
| | for ear mode | |
| E16 | Measured temperature too high | Temperature above 100° C. or |
| | for object mode | 212° F. |
| E20 | Battery value too low. | Battery <2.6 V. Values may be |
| | | incorrect. |

Calibration Record Format (11 Bytes)
1. Temperature unit: 1 byte “C” or “F” value.
2. Expected temperature value: 5-digit string format in indicated unit. Expected temperature value.
3. Measured temperature value: 5-digit string format in indicated unit. Actual value registered by sensor.

Factory Write Record Format (Variable Length)

The Factory Write (FW) command can transmit the Device Information Service (DIS) data to the device. The information can be written to non-volatile memory and can be returned in response queries against the Device Information Service characteristics.

The data to be transmitted can be in a long stream, starting with a 3-digit 0-padded total packet size (exclusive of the packet length field itself). The packets themselves are then parsed as follows: 2-digit data type: indicating which Device Information Service value follows; 2-digit data length; Actual bytes of value to follow.

The DIS can define the following data types (and 2-digit type codes): System ID (Code: ID); Model number string (Code: MN); Serial number string (Code: SN)—Preferred; Firmware revision string (Code: FW); Hardware revision string (Code: HW); Manufacturer name string (Code: NM); Regulatory Certification Data List (Code: RC); PnP ID (Code: PN). A typical Factory Write Format can be formatted as follows, with the look like this, with the Serial Number specified: 026NM10Kinsa Inc.SN0855822129. In the previous example: 026: 3-digit decimal string. Length of data to follow (exclusive of the length field itself); NM: Code for Manufacturer Name string; 10: 2-digit 0-padded decimal string. Length of Manufacturer name string to follow; Kinsa Inc.: Actual string value for manufacturer name; SN: Code for Serial number string; 08: 2-digit 0-padded decimal string. Length of Serial Number string to follow; 55822129: UTF-8 string value for serial number.

Device Event

The following table lists example event opcodes and values that may originate from the thermometer. The characteristic can be written from the device and be set for both notification and write-with-response.

| | | |
|---|---|---|
| Temperature | TT | A single temperature has been taken. The value that |
| taken | | follows in the characteristic is a single Temperature |
| | | Record format (see above). Note: the value will also |
| | | be cached on the thermometer. To avoid duplicates |
| | | the computing device could send an EL erase |
| | | cache command to zero out the last item |
| | | from the cache. |
| Error Event | EV | An error has occurred. What follows will be a single |
| | | Error Record Format (see above) follows. |
| Device | ZP | Sent when the user requests that the device be |
| Resetting | | zapped (reset to factory state) using the button |
| (Zap!) | | controls on the device. No other data will follow. |

### Command Examples

In the request/result examples, command opcodes can be written to the Request Opcode characteristic. The responses (including error values) can be returned in the Request Response characteristic.
Pair (PA) Write: PA; Expect: Nothing. The request drops the connection and puts the device into pairing mode.
Unpair (UP) Write: UP; Expect: Nothing. The currently connected device is removed from the whitelist and the connection is dropped. Re-establishing the connection should bring up the pairing dialog.
Cache Count (CC) Write: CC; Expect: 01 (or any 2-digit UTF-8 string decimal value). Number of items in cache.
Read Cache (RC) Write: RC; Expect: 02098.4F151008042358 102.6F151008042210

Notes: The first record contains a 2-digit zero-padded record count (i.e. 02), followed by a single record. The subsequent values can be a single record per transaction. The first record can be 20 bytes and the remaining record 18 bytes.

The write sequence will be, for example, 1^{st} write: 02098.4F151008042358 (20 bytes) 2^{nd} write: 102.6F151008042210 (18 bytes)

Data can be interpreted as follows: 1^{st} write: 02=Number of temperature records to follow (2 bytes) 098.4=1^{st} temperature value (5 bytes) F=1 unit of measure for this reading (1 byte) YYMMDDHHMMSS=1^{st} timestamp (12 bytes)

2^{nd} record: 102.6=2^{nd} temperature value (5 bytes) F=2^{nd} unit of measure for this reading (1 byte) YYMMDDHHMMSS=2^{nd} timestamp (12 bytes)
Preset Test Data (PT) Write: PT; Expect: A pre-defined set of temperature records formatted like above.
Cache Erase (CE) Write: CE; Expect: OK or ER. If error, the actual data can be retrieved via RE opcode.
Erase Last Temp (EL) Write: EL; Expect: OK or ER. If error, the actual data can be retrieved via RE opcode. If there is no last record present (i.e. there were no cached record) an OK can be sent.
Reset Device (RD) Write: RD; Expect: OK. If thermometer could not be reset an ER value can be returned. Details on the error can be retrieved via the Read Errors opcode. Erases all cached data and pairing values and disconnects device.
Error Count (EC) Write: EC; Expect: 01 (or any 2-digit UTF-8 string decimal value). Number of items in error cache.
Read Errors (RE) Write: RE; Expect: 02E01151002091034 S30151001080923

Notes: The first record can contain an error count followed by a single error record. Subsequent writes can contain individual error records and can continue until for the number of errors in the first record.

1^{st} write: 02E01151002091034 2^{nd} write: S30151001080923

Data can be interpreted as follows:

1 write: 02=Number of error records to follow (2 bytes) E=1 severity type (1 byte)

01=1^{st} error code (2 bytes) 151002091034=1^{st} timestamp: Oct. 2, 2015 09:10:34 (12 bytes)

2^{nd} write: S=2^{nd} severity type (1 byte) 30=2^{nd} error code (2 bytes) 151001080923=2^{nd} timestamp: Oct. 1, 2015 08:09:23 (12 bytes)
Erase Errors (EE) Write: EE; Expect: OK or ER.
Preset Error Data (PE) Write: PE; Expect: A pre-defined set of error records formatted like above. (actual pre-set values are shown later).
Read Setting (RS) Reply format:—OK: 2-digit status. OK if success, ER if invalid. If error, no other data returned after this. Error value may be retrieved via RE opcode.
##: 2-digit value key code.
(variable): value specific to this value key code.

Write: RSPV (get protocol version)

Expect: OKPV001 (Kinsa protocol version supported by device—3-digit number)

Write: RSUN (get temperature unit)

Expect: OKUNF (Fahrenheit)

Write: RSMU (get mute button status)

Expect: OKMU1 (muted)

Write: RSBL (get backlight status)

Expect: OKBL0 (backlight off)

Write: RSST (get screen timeout)

Expect: OKST010 (10 seconds)

Write: RSCT (get connection timeout)

Expect: OKCT030 (30 seconds)

Write: RSTS (get current timestamp)

Expect: OKTS150612143423 (timestamp: 150612143423)

Write: RSAL

Expect: OKAL0 (auto-launch is off)

Note: Possible key code values.

| Key Code | Desc | Possible Values |
|---|---|---|
| PV | Protocol Version | NNN (3-digit decimal string) |
| | | starting with 001. |
| UN | Unit | C (Celsius), F (Fahrenheit) |
| MU | Mute | 0 (not mute), 1 (mute) |
| BL | Backlight | 0 (off), 1 (on) |
| ST | Screen timeout (sec) | NNN (3-digit decimal string). |
| | | Default: 010. If 000 no screen |
| | | timeout. Therefore the backlight |
| | | stays on until device is powered |
| | | down. |
| CT | Connection timeout (sec) | NNN (3-digit decimal string). |
| | | Default: 030. If 000 no |
| | | connection timeout. |
| TS | Current Timestamp Value | YYMMDDHHMMSS (12-digit |
| | | UTF-8 string). |
| AL | Auto-Launch enabled | 0 (disabled), 1 (enabled) |

Write Setting (WS):
Write: WSUNC (change unit setting to Celsius); Expect: OK
Write: WSMU1 (turn Mute ON); Expect: OK
Write: WSBL0 (turn backlight OFF); Expect: OK
Write: WSST005 (change screen timeout to 5 seconds); Expect: OK
Write: WSCT060 (change connection timeout to 60 seconds); Expect: OK
Write: WSCT000 (disable connection timeout); Expect: OK
Write: WSTS150101102322 (write current time in absolute YYMMDDHHMMSS time format); Expect: OK
Write: WSAL1 (enable auto-launch feature); Expect: OK

Diagnostics Run Diagnostics (DR)
Write: DR; Expect: OK or ER.

Get Calibration Data (GC)
Write: GC; Expect: 03F075.5075.7098.4098.2104.5104.5
Data can be interpreted as follows:
   03=Number of calibration records to follow (2 bytes)
   F=Unit of calibration (“C” or “F”)—(1 byte)
   075.5=1^{st} record: Expected value in above unit (5 bytes)
   075.7=1^{st} record: Measured value (5 bytes)
   098.4=2^{nd} record: Expected value in above unit (5 bytes)
   098.2=2^{nd} record: Measured value in above unit (5 bytes)
   104.5=3^{rd} record: Expected value in above unit (5 bytes)
   104.5=3^{rd} record: Measured value in above unit (5 bytes)

NOOP (NO)
Write: NO; Expect: Nothing

Write Serial Number (SN) Write:
SN0123456789; Expect: Nothing. If first time, the serial number is saved. If serial number already exists, serial number may not be over-written.

Device Event Examples

Temperature Taken (TT):
Expect: TT+single temperature record (20 bytes total)
Example: TT098.4F150304152322
   Data can be interpreted as follows:
   TT=Event type (2 bytes); 098.4=temperature value (5 bytes); F=unit of measure for this reading (1 byte); 150304152322=current timestamp (12 bytes)

Error Event (EV):
Expect: EV+single error record (17 bytes)
Example: EVS02150304152322
   Data can be interpreted as follows:
      EV=Event type (2 bytes)
      S=Severity type (1 byte)
      01=Error code (2 bytes)
      150304152322=current timestamp (12 bytes)

Device Resetting (ZP):
Expect: Nothing (device is assumed to have reset back to factory mode and will likely disconnect next).

Preset Data and Errors

In one or more implementations, when the device is asked to send preset data (Opcode: PT) the following values are expected to be sent along. Packet format is temperature+unit+timestamp
Number of records (0-padded 2-digit decimal string): 08
Record 1: 098.4F150405123456
Record 2: 037.1C161025094515
Record 3: 032.4C171110120001
Record 4: 102.3F180801231105
Record 5: 040.0C190411051000
Record 6: 097.1F200321101558
Record 7: 039.6C211226031510
Record 8: 029.7C220115170555

In one or more implementations, when device is asked to send preset error codes (Opcode: PE) the following values are expected to be sent along. Packet format is severity type+3-digit code+12-digit timestamp (in YYMMDDHHMMSS format)
Number of error records (0-padded 2-digit decimal string): 05
Error 1: W01151010121558
Error 2: E01160825190015
Error 3: S30171112231005
Error 4: W01180414063358
Error 5: E01191201203040

### Illness Progression Forecast

In accordance with a further aspect of the systems and methods of the present application, an illness progression forecast, or simply illness forecast, is described herein. As described above, the term “illness forecast” as used herein refers generally to providing a user or patient with information as to the prognosis of a given illness. For example, illness forecast may comprise information including, but not limited to, contagiousness over one or more periods of time, general energy levels from a point in time, symptomology, as well as alerts, which comprise potentially dangerous downstream or co-occurring conditions that the user or patient should be particularly vigilant in identifying. Illness forecast as used herein, which refers to personal health, should be understood in contrast with forecasting area health, also referred to herein as health weather, which refers to the aggregate health of various groups of individuals.

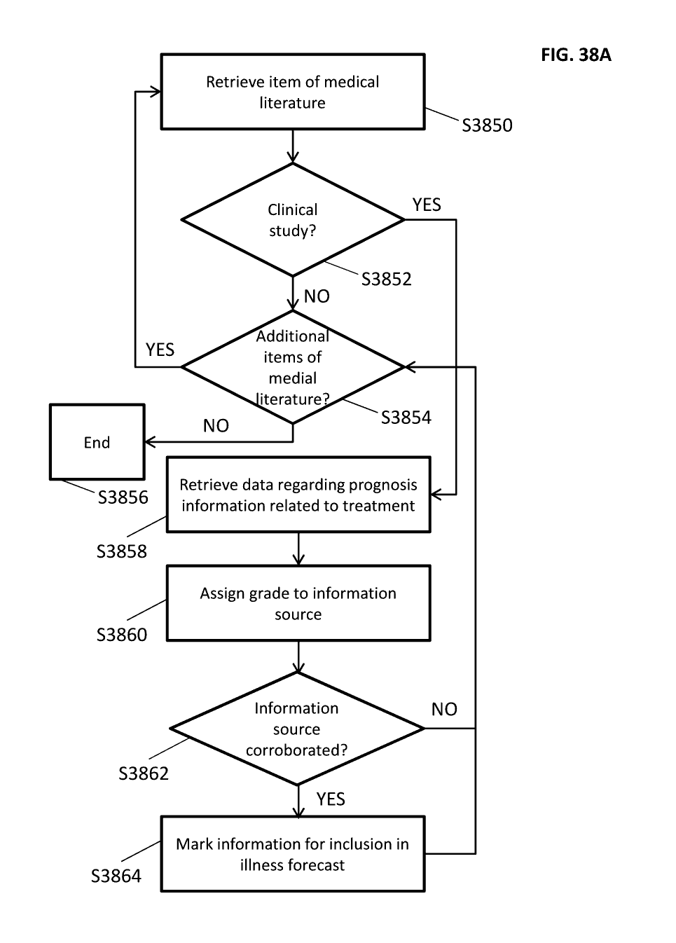

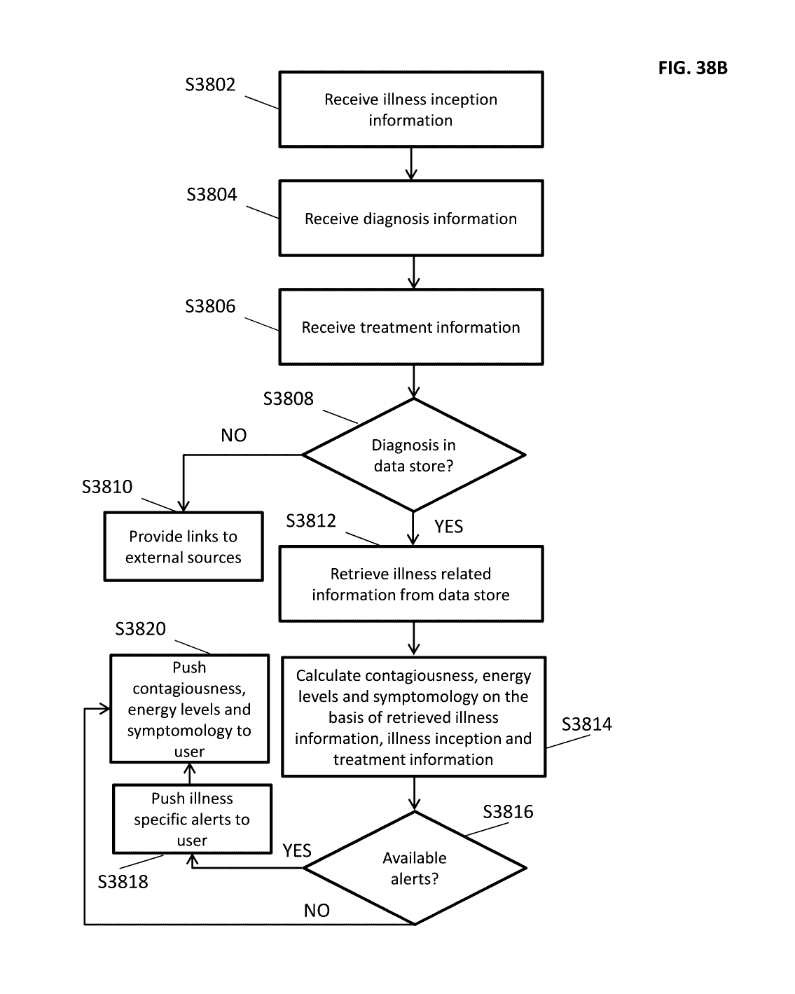

The basis for performing illness forecasting as describe herein is the construction of a data set for one or more illnesses against which incoming illness inception, diagnosis and treatment information can be evaluated. FIG. 38A is a flow diagram illustrating a method for creating an illness forecast data set according to one embodiment of the present invention. The process of FIG. 38A begins with the retrieval of a given item of medical literature, step S3850, on which a check is performed to determine if the given item of medical literature relates to a clinical study, step S3852. According to various embodiments of the invention, identified clinical studies comprise both prospective RCTs and observational studies regarding various specific illnesses including, but not limited to, croup, strep, influenza, etc. Where the given item of medical literature does not relate to a clinical study, step S3852, a subsequent check is carried out to determine if there are additional items of medical literature for review, step S3854. Where additional items of medical literature require review, program flow returns to step S3850 with the retrieval of the additional item, otherwise processing completes, S3856.

Where the check at step S3852 indicates that the item of medical literature relates to a clinical study, various items of information are extracted from the item of medical literature for possible persistent storage, step S3858. In addition to extracting the illness to which the item of medical literature is directed, other data is extracted from the reference, such as symptomology, contagiousness, recovery time frame, energy levels, co-occurring conditions or other related prognosis information as it relates to treatment or lack thereof. The study referenced in the item of medical literature under consideration is assigned a grade, step S3860, which is based on combination of various factors including, but not limited to, size (and related statistical significance measures), methodology employed and the occurrence/quality of peer reviews. The grade is compared against other previously grated items of medical literature concerning the same illness, step S3862, and where the item of medical literature under consideration has a high grade and is corroborated with other items of medical literature, the information is marked for inclusion in an illness forecast, step S3864. Regardless of whether the information source is corroborated, program flow returns to step S3854 with a check for additional items of medical literature requiring analysis.

When attempting to obtain an illness forecast in accordance one or more implementations, a user can enter his or her heath care provider's (e.g., doctor's) diagnosis, and based on the diagnosis and the user's responses to some contextual questions, which causes the telemedicine application 160 of the present application to provide guidance to the user, such as how his or her illness is likely to progress. Such information can further include whether and for how long a user is likely to be contagious, and when a user is likely to regain energy levels, among other things. Moreover, forecast information regarding the progression of an illness in a given user can be used as an input to analysis and forecasting of area health, health weather, and understanding of the spread of contagious illness including, but not limited to the flu, and other outputs and outcomes.

FIG. 38B illustrates one embodiment of a methodology for providing a patient with his or her illness forecast. The process of FIG. 38 begins with the receipt of illness inception information, step S3802. The illness inception information can be retrieved over the network from the data store, can be provide by the user via the computing device and/or connected health device, or various combinations thereof. Generally speaking, the illness inception information comprises data information indicating the date that the patient first became symptomatic, which the system can store as an offset against the current data to determine the number of days that have elapsed since the patient became ill. The process continues with the receipt of diagnosis information, step S3804, and treatment information, step S3806. In this manner, the illness forecasting process is not a diagnosis tool, but rather serves to provide a forecast to the user as to the progression of a given illness as measures by, for example, the above-described metrics of contagiousness, energy levels and symptomology. It should be noted that the system may collect other miscellaneous information from the patient with regard to specific, individual symptoms that he or she may be experiencing, as well as additional demographic data. This additional miscellaneous information may help to hone or otherwise make the illness forecast more specific in terms of contagiousness level, projected symptomology or energy levels over time, or the identification of potentially dangerous downstream (occurring later in time) or co-occurring conditions that the user or patient should be particularly vigilant in identifying.

The diagnosis information, step S3804, serves as input to a lookup in a data store, step S3808, which maintains illness progression metrics for a number of common illnesses including, but not limited to, influenza, common cold, otis media (ear infection), pink eye, croup, strep throat, fifth's disease, and other illnesses. Where the lookup indicates no match for the received diagnosis, meaning that the data store does not maintain any illness progression information for the particular illness with which the patient has been diagnosed, processing processed to step S3810 where the system provides the user with external links to certified or otherwise reputable information sources regarding the illness. Where the lookup indicates that the data store maintains information regarding the received diagnosis, step S3808, e.g., has access to illness progression metrics, which may comprise other information regarding an illness and co-occurring illnesses or conditions, the system retrieves such illness related information from the data store, step S3812.

A calculation evaluates the inception and treatment information in view of the retrieved illness information, which is based on the diagnosis that the patient provides, to determine specific illness progression metrics for the patient, step S3814, which include, but are not limited to, the amount of time remaining that the patient is contagious, general energy levels that the patient should experiencing going forward, e.g., when the patient should expect to begin regaining normal energy levels and general symptomology. A check is performed, step S3816, to determine if there are any alerts contained within or otherwise associated with the illness progression metrics for the specific diagnosis that the patient provides. According to one embodiment, an alert comprises a potentially dangerous co-occurring condition that the user or patient should be particularly vigilant in identifying.

The resultant information regarding contagiousness, energy levels and symptomology are pushed to the computing device, which may comprise the display of such information created on a local processor, remote processor or combinations thereof, step 3820. The pushing of such information may alternatively, or in conjunction with the foregoing, take place on the connected health device. Similarly, such information may be pushed back into a network data store for remote access by clients, such as over connections to desktop clients running web browser applications. Where there are alerts available as part of the illness progression metrics, step S3816, the patient receives such alerts via the computing device, connected health device or via the cloud, step S3818. Such alerts, if occurring in the future, can optionally be integrated into an electronic calendar, which the user can access on his or her mobile computing device or via other such electronic means.

As described above, the system, e.g., telemedicine application 160, can collect specific individual symptoms that the patient is experiencing, which it associates with the associated diagnosis that the patient provides. A subsequent step (not pictured) comprises periodically soliciting feedback from the patient, e.g., twenty four hours, an additional forty-eight hours after that and then another subsequent forty-eight hours, regarding the specific progression of his or her symptoms. Such feedback can serve as updates to the illness related information that the data store maintains, step S3808, allowing for the refinement of such baseline information over time to more closely model actual experiences when used in calculating contagiousness, energy levels and symptomology.

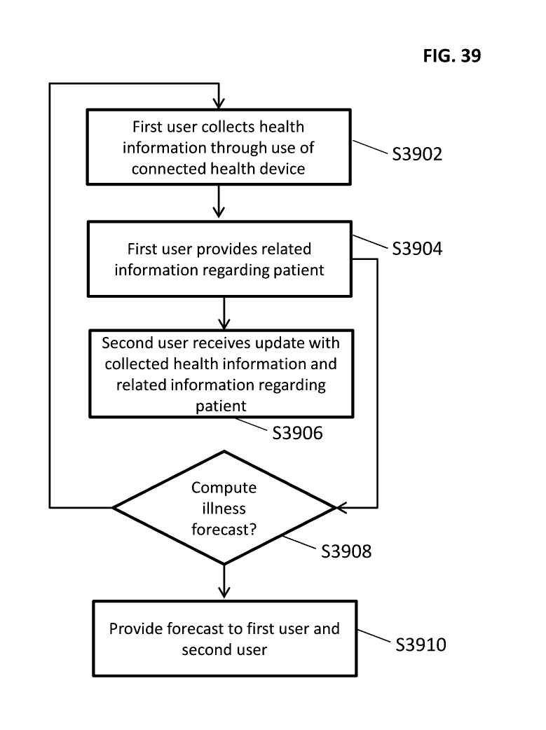

In addition to collecting information regarding an illness forecast, as well as processing to create the same, such collected information or the resulting illness forecast can be shared with other users, patients, physicians, etc. FIG. 39 is a flow diagram illustrating a method for multi-user access to individual data or the resulting illness forecasting according to one embodiment of the present invention. In accordance with the embodiment of FIG. 39, a first user, who for example may be a caretaker of a patient, who may be a minor under his or her supervision, collects health information through the use of a connected health device, step S3902. The first user also has an opportunity to provide related information, step S3904, for example, information regarding symptoms that the patient is experiencing, as well as other information such as notes, photographs, etc. Storage for the collected health information and the related information can take place at the connected health device, a computing device in communication with the connected health device, on one or more network accessible servers, as well as various combinations thereof. A second user, who according to one embodiment is geographically remote from the first user, receives an update with the collected health information and related information regarding the patient, step S3906, which may on another connected health device, a mobile computing device or through access to an account that is operative to maintain such information and accessible to the first user and the second user.

Such update may arrive by way of a push notification, email, text message, or be actively pulled from a data source by a request from a user computing device. Similarly, in accordance with certain embodiments, when the first user provide health information or related information regarding the patient, the connected health device or computing device in communication with the connected health device triggers a notification that is pushed out to the second user, which may comprise the first user and the second user having access to an account for the patient, as well as any other identified users. Accordingly, when computing an illness forecast for a patient, step S3908, such forecast can be sent to the first user and the second user, step S3910, as well as any other user identified for the receipt of such information.

### Connect to Care

In one or more implementations, the telemedicine application 160 provides users with an option to schedule with and communicate with healthcare providers, such as physicians, nurses, or other care providers directly through the application, e.g., telemedicine provider. Information associated with third parties can be leveraged to provide such services. Users can be connected with medical professionals directly through the application, such as via phone, SMS, video conference or by offering scheduling for an in-person consultation. Through this service, users can be provided with healthcare services and information on user's symptoms, chief complaints, and diagnosis can be simultaneously collected and/or aggregated. Such information can be used as an input to analysis and forecasting of area health, health weather, an understanding of the spread of contagious illness including but not limited to the flu, and other outputs and outcomes.

### Groups

In at least one implementation, through a “groups” feature in the telemedicine application 160, information can be collected on which ill individuals are associated with which groups. Using this information, a determination can be made whether a location/social group is a node of disease transmission and how that node is contributing to or resulting in the spread of illness can be monitored. In many countries and geographies, schools tend to be a node of disease transmission. Understanding the level of illness at a school (or other type of node) can be helpful to determining how, when, and how fast disease is spreading, and to inform actions by a proprietor of the present application or a third parties (e.g., public health agencies or companies with cold and flu treatments) to slow or stop it. This information is also useful for analysis and forecasting of area health, health weather, an understanding of the spread of contagious illness including but not limited to the flu, and other outputs and outcomes.

Additional Use of the Data Collected and/or Aggregated

In one or more implementations, the information collected and/or aggregated via the telemedicine application 160 is also helpful to determine the speed at which illness is spreading, the types or categories of illnesses or pathogens, nodes of disease transmission, for contact tracing purposes or for purposes of quarantine or isolation, and as an early detection mechanism upon which third parties (like public health agencies, other governmental or non profit groups or companies) can respond to further diagnose or determine the severity of the situation, particular pathogen in question or the response needed.

The present application is further shown and described in connection with the following example implementation(s).

### Other Embodiments

At this juncture, it should be noted that although much of the foregoing description has been directed to systems, methods, and apparatuses for monitoring and tracking health, initiating telemedicine sessions, measuring temperature and/or calibrating a temperature measurement subsystem, the systems and methods disclosed herein can be similarly deployed and/or implemented in scenarios, situations, and settings far beyond the referenced scenarios.

It is to be understood that like numerals in the drawings can represent like elements through the several figures, and that not all components and/or steps described and illustrated with reference to the figures are required for all embodiments or implementations. It should also be understood that the embodiments, implementations, and/or implementations of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform methods of the present invention need not reside on a single computer or processor, but can be distributed in a modular fashion amongst a number of different computers or processors to implement various aspects of the systems and methods disclosed herein.

Thus, illustrative embodiments and implementations of the present systems and methods provide a computer-implemented method, computer system, and computer program product for monitoring and tracking health, initiating telemedicine sessions, measuring temperature and/or calibrating a temperature measurement subsystem. The flowchart and block diagrams in the figures illustrate the architecture, functionality, and operation of possible implementations of systems, methods, and computer program products according to various embodiments and implementations. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For example, the components of the data repository 180 (including the analytics server 3620, application server 3615, and database 3680 as shown at FIG. 36) can be implemented on one or more physical computers, one or more virtual computers, central or distributed computers, or any combination thereof.

For example, in another embodiment, one or more systems are adapted to work with animals instead of humans, veterinarians instead of human doctors, in the context of illnesses affecting non-humans.

The phraseology and terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The use of “including,” “comprising,” or “having,” “containing,” “involving,” and variations thereof herein, is meant to encompass the items listed thereafter and equivalents thereof as well as additional items.

It is to be understood that the above description is intended to be illustrative, and not restrictive. Various modifications and/or changes can be made to the subject matter described herein without following the example embodiments and applications illustrated and described, and without departing from the true spirit and scope of the present invention, which is set forth in the following claims.

Furthermore, the terms and phrases used herein are not intended to be limiting, but rather are to provide an understandable description of the systems and methods. Additionally, the systems can be provided by one or more entity, but for simplicity “the provider of the system” is referred to herein.

1. A health monitoring and tracking system, the system comprising:
one or more temperature sensing devices, a given one of the temperature sensing devices communicatively connectable to at least one of a plurality of respective computing devices and configured to calculate temperature information independently of or in connection with at least one of the respective computing devices;
at least one data repository that stores:
a) health-related information received from at least one respective computing device, wherein the health-related information represents at least:
i) calculated temperature information associated with at least one of the temperature sensing devices; and
ii) information representing at least one of: at least one medical condition, at least one disease, at least one health-related symptom, geographic location associated with at least one respective computing device, at least one date, identification of at least one individual user, and identification of at least one of the plurality of respective computing devices; and
b) provider information representing at least one party that is enabled to target products and interventions associated with at least some of the health-related information;
at least one processor that is configured to execute instructions stored on non-transitory processor readable media which, when executed by the at least one processor, configure the at least one processor to:
receive, from one of the respective computing devices, health-related information in response to a user action in the one of the respective computing devices;
trigger generation and transmission of at least one prompt to the respective computing device based on the received the health-related information comprising an indication that a patient that uses a given temperature sensing device is experiencing an elevated temperature indicating a fever, the at least one prompt for:
a symptom;
an indication whether a medical professional has been seen;
a request to contact a provider; and/or
a diagnosis;
receive, from the one of the respective computing devices, a response to the prompt; and
match the response to the prompt with at least some of the provider information to provide at least one option for:
scheduling a meeting with a provider;
communicating with a provider;
receiving information associated with the response.

2. The system of claim 1, wherein the at least one processor is further configured to execute instructions stored on non-transitory processor readable media, which configure the at least one processor to:
receive a response to the at least one option;
schedule the meeting;
establish a communication with the provider; and/or
send the information associated with the received at least some of the health-related information to the provider.

3. The system of claim 1, wherein the information associated with the received at least some of the health-related information includes insights that represent at least one of contagiousness, an illness that is circulating, and at least one symptom that is circulating.

4. The system of claim 1, wherein at least some of the provider information represents an entity selected from the group consisting of a pharmacy, a healthcare provider and a provider of a service or product related to cold or flu-like illness, fever symptoms, or hygiene.

5. (canceled)

6. The system of claim 1, wherein the provider is a healthcare provider.

7. (canceled)

8. (canceled)

9. (canceled)

10. (canceled)

11. A health monitoring and tracking method, the method comprising: accessing, by at least one processor, at least one data repository that stores:
a) health-related information received from at least one respective computing device, wherein the health-related information represents at least:
i) calculated temperature information associated with at least one of a plurality of temperature sensing devices, each of the temperature sensing devices communicatively connectable to at least one of a plurality of respective computing devices and configured to calculate temperature information independently of or in connection with at least one of the respective computing devices; and
ii) information representing at least one of: at least one medical condition, at least one disease, at least one health-related symptom, geographic location associated with at least one respective computing device, at least one date, identification of at least one individual user, and identification of at least one of the plurality of respective computing devices; and
b) provider information representing at least one party that is enabled to target products and interventions associated with at least some of the health-related information;
receiving by at least one processor that is configured to execute instructions stored on non-transitory processor readable media, from one of the respective computing devices, health-related information in response to a user action in the one of the respective computing devices;
triggering the generation, by the at least one processor, of at least one prompt based on the received health-related information comprising and indication that a patient that uses a given temperature sensing device is experiencing an elevated temperature indicating a fever, the at least one prompt for:
a symptom;
an indication whether a medical professional has been seen;
a request to contact a provider; and/or
a diagnosis;
transmitting, by the at least one processor to the one of the respective computing devices, the at least one prompt;
receiving, by the at least one processor from the one of the respective computing devices, a response to the at least one prompt;
matching, by the at least one processor, at least some of the provider information with the response to the at least one prompt; and
providing, by the at least one processor in response to the step of matching, at least one option for:
scheduling a meeting with a provider;
communicating with a provider; and
sending, by the at least one processor, information associated with the response.

12. The method of claim 11, further comprising:
receiving, by the at least one processor, a response to the at least one option; and
at least one of:
scheduling, by the at least one processor, the meeting,
establishing, by the at least one processor, a communication session with the provider; and
sending, by the at least one processor, the information associated with the received at least some of the health-related information.

13. The method of claim 11, wherein the information associated with the received at least some of the health-related information includes insights that represent at least one of contagiousness, an illness that is circulating, and at least one symptom that is circulating.

14. The method of claim 11, wherein at least some of the provider information represents an entity selected from the group consisting of a pharmacy, a healthcare provider and a provider of a service or product related to cold or flu-like illness, fever symptoms, or hygiene.

15. (canceled)

16. The method of claim 11, wherein the provider is a healthcare provider.

17. (canceled)

18. (canceled)
